(19) United States
(12) Patent Application Publication
(10) Pub. No.: US 2002/0076825 A1
(43) Pub. Date: Jun. 20, 2002

(54) Integrated biochip system for sample preparation and analysis

(76) Inventors: Jing Cheng, Beijing (CN); Xiaobo Wang, San Diego, CA (US); Lei Wu, San Diego, CA (US); Weiping Yang, San Diego, CA (US); Junquan Xu, Beijing (CN)

Correspondence Address: DAVID R PRESTON & ASSOCIATES, 12625 HIGH BLUFF DRIVE, SUITE 205, SAN DIEGO, CA, 92130, US

(21) Appl. No.: 09/973,629

(22) Filed: Oct. 9, 2001

Related U.S. Application Data
(60) Provisional application No. 60/239,299, filed on Oct. 10, 2000.

(51) Int. Cl. G01N 1/00

(52) U.S. Cl. 436/174

(57) ABSTRACT

The invention includes a composition that is an integrated biochip system for processing and analyzing samples using sequential tasks that take place on one or more chips. The system preferably comprises one or more active chips, and can be automated. The invention also includes methods of using an integrated biochip for processing and analyzing samples. The methods include the application of a sample to the system and performing at least two sequential tasks on at least one chip surface. The method includes the use of physical forces, such as dielectrophoretic and electromagnetic forces to process and analyze samples, and includes the use of microparticles that can be coupled to sample components to be manipulated by dielectrophoretic and electromagnetic forces.

This application claims priority to U.S. Provisional Application No. 60/239,299 (attorney docket number ART-00105.P.1) filed Oct. 10, 2000, entitled “An Integrated Biochip System for Sample Preparation and Analysis” naming Cheng, et al. as inventors, and incorporated herein by reference in its entirety.

### TECHNICAL FIELD

The present invention relates generally to the field of sample analysis, in particular to the processing and analysis of samples on chips. More particularly, the invention relates to the processing and analysis of samples using an integrated system of chips, including one or more chips on which sample components, e.g. biological cells and biomolecules, can be manipulated or processed using applied physical forces.

### BACKGROUND

The manipulation of particles, especially biological material such as cells and molecules, can be used to advantage in a variety of biomedical applications. The ability to manipulate individual cancer cells, for example, can allow a researcher to study the interaction of either a single cancer cell or a collection of cancer cells with selected drugs in a carefully controlled environment. Various kinds of forces can be used to manipulate particles, including optical, ultrasonic, mechanical, and hydrodynamic. For example, flow cytometry has been successfully used to sort and characterize cells. Another example is the centrifuge, which has been widely used in laboratories for processing biological samples.

A current trend in the biological and biomedical sciences is the automation and miniaturization of bioanalytical devices. The development of so-called biochip-based microfluidic technologies has been of particular interest. A biochip includes a solid substrate having a surface on which biological, biochemical, and chemical reactions and processes can take place. The substrate may be thin in one dimension and may have a cross-section defined by the other dimensions in the shape of, for example, a rectangle, a circle, an ellipse, or other shapes. A biochip may also include other structures, such as, for example, channels, wells, and electrode elements, which may be incorporated into or fabricated on the substrate for facilitating biological/biochemical/chemical reactions or processes on the substrate. An important goal for researchers has been to develop fully automated and integrated devices that can perform a series of biological and biochemical reactions and procedures. Ideally, such an integrated device should be capable of processing crude, original biological sample (e.g., blood or urine) by separating and isolating certain particles or bio-particles from the rest of the sample (e.g., cancer cells in blood, or fetal nucleated cells in maternal blood, or certain types of bacteria in urine). The isolated particles can then be further processed to obtain cellular components (e.g., target cells are lysed to release biomolecules, such as DNA, mRNA and protein molecules). The cellular components of interest can then be isolated and processed and analyzed (e.g., DNA molecules are separated and target sequences are amplified through polymerase-chain-reactions, PCR). Finally, a detection procedure may be performed to detect, measure and/or quantify certain reaction products (e.g., a hybridization may be performed on the PCR-amplified DNA segments with fluorescent detection then being used to detect the hybridization result). Clearly, the ability of a biochip to manipulate and process various types of particles, including cells and cellular components from a particle mixture, would be of great significance.

Limited progress has been made to date in the manipulation of particles or bioparticles on a chip. Electronic hybridization technologies have been developed in which charged DNA molecules are manipulated and transported on an electronic chip (e.g., “Rapid Determination of Single Base Mismatch Mutations in DNA Hybrids by Direct Electric Field Control”, Sosnowski, R., et al., Proc. Nat. Acad. Sci., Volume 94, pages 1119-1123, 1997; “Electric Field Directed Nucleic Acid Hybridization on Microchips”, Edman, C., Nucl. Acids Res., 25: pages 4907-4914, 1998, the disclosures of which are incorporated herein by reference in their entireties). Also, electrokinetic pumping and separation technologies have been developed in which biomolecules or other particles can be transported, manipulated, and separated through the use of electroosmosis and electrophoresis based kinetic effects (e.g., “Micromachining a miniaturized capillary electrophoresis-based chemical analysis system on a chip”, Harrison, D.J. et al, Science, Volume 261, pages: 895-896, 1993; “High-speed separation of antisense oligonucleotides on a micromachined capillary electrophoresis device”, Effenhauser, C.S. et al., Anal. Chem. Volume 66, pages: 2949-2953, 1994, the disclosures of which are incorporated herein by reference in their entireties). However, each of these devices suffers from limitations. Accordingly, there is a need for improved particle manipulation devices.

### DESCRIPTION OF THE FIGURES

FIG. 1A is a schematic representation of a three-dimensional perspective view of a chamber that comprises a multiforce chip used in the system of the present invention. The chamber has inlet and outlet ports and a multiple force chip forming the bottom of the chamber. Not shown is a glass plate on the top (not shown). The chamber is connected to three neighboring chambers (not shown) for analyzing and detecting DNA, protein and mRNA, and small molecules. The multiple force chip comprises an acoustic layer, a magnetic layer, a particle switch layer, a DEP electrode layer and a top layer.

FIG. 1B is a schematic representation of a three-dimensional perspective view of the top layer of a multiple force chip. In this case the top layer can be, for example, a coating of BSA (Bovine Serum Albumin) or other coating that may minimize non-specific adhesion or binding of cells or other components of samples to the chip. The top layer can also be a thin layer of SiO₂ or other insulating materials.

FIG. 1C is a schematic representation of a three-dimensional perspective view of the DEP electrodes on the DEP electrode layer of a multiple force chip. The rectangular-shaped DEP electrodes can be connected to external signal sources (not shown).

FIG. 1D is a schematic representation of a three-dimensional perspective view of particle switch electrodes on the particle switch layer of a multiple force chip.

FIG. 1E is a schematic representation of a three-dimensional perspective view of the electromagnetic elements on the magnetic layer of a multiple force chip.

FIG. 1F is a schematic representation of a three-dimensional perspective view of the acoustic elements on the acoustic layer of a multiple force chip.

FIG. 2A is a schematic representation of a cross-sectional view of a sample being introduced into the chamber. The sample comprises target cells to be analyzed, non-target cells, and magnetic beads to which specific binding members have been coupled. The specific binding members allow the target cells to bind to the magnetic beads.

FIG. 2B is a schematic representation of a cross-sectional view of the sample that has been introduced into the chamber. The introduced sample comprises target cells, non-target cells, and magnetic beads.

FIG. 3 is a schematic representation of a cross-sectional view of the sample in the chamber being mixed using acoustic forces to facilitate the binding of the magnetic beads to the target cells (energized acoustic layer depicted with thick bold lines).

FIG. 4 is a schematic representation of a cross-sectional view of the sample in the chamber when the magnetic beads are bound to the target cells following acoustic mixing and just prior to magnetic capture.

FIG. 5A is a schematic representation of a three-dimensional perspective view of the target cells of the sample in the chamber bound to magnetic beads with electromagnetic units being energized (energized magnetic layer depicted with thick bold lines). The energized electromagnetic units generate a magnetic field distribution that causes the target cell-magnetic bead complexes to be collected towards these energized units.

FIG. 5B is a schematic representation of a three-dimension perspective view of the chamber with the magnetic bead-cell complexes or magnetic beads being trapped at the energized magnetic elements (energized magnetic layer depicted with thick bold lines). To illustrate that the magnetic bead complexes are collected at the energized magnetic elements, individual magnetic elements are schematically shown, although they would not be seen from the top of the chamber.

FIG. 5C is a schematic representation of a three-dimensional perspective view of the chamber with the nontarget cells being washed out of the chamber by fluid flow. Target cells bound to magnetic beads remain trapped at the energized magnetic elements.

FIG. 6 is a schematic representation of a three-dimensional perspective view of the chamber with the target cells being de-coupled from the magnetic beads. The magnetic elements remain energized so that the magnetic beads remain trapped at the ends of the magnetic elements.

FIG. 7A is a schematic representation of a cross-sectional view of the chamber with the DEP electrode array energized by application of an AC electric signal (energized electrode layer depicted by thick bold lines).

FIG. 7B is a schematic representation of a cross-sectional view of the chamber with the target cells being retained by dielectrophoretic forces produced by the non-uniform electric fields generated by the DEP electrode array. The magnetic beads are washed out of the chamber because the dielectrophoretic forces acting on these beads are small or negative.

FIG. 8 is a schematic representation of a cross-sectional view of the chamber with four different types of beads in a solution being introduced into the chamber. The four types of the beads, type 1, type 2, type 3, and type 4 are used for capturing target mRNAs, target proteins, target DNAs, and target small molecules, respectively.

FIG. 9A is a schematic representation of a cross-sectional view of the chamber with the target cells being lysed or disrupted to release their components.

FIG. 9B is a schematic representation of a cross-sectional view of the chamber showing the released components of the lysed target cells.

FIG. 10 is a schematic representation of a cross-sectional view of the chamber with the acoustic elements being energized so that an acoustic mixing is provided to facilitate the binding of the molecules of interest to their respective beads (energized acoustic layer depicted by thick bold lines).

FIG. 11 is a schematic representation of a cross-sectional view of the chamber with the molecules of interest being bound to their respective beads. Target protein molecules, DNA molecules, mRNA molecules and small molecules have been bound type 2, type 3, type 1 and type 4 beads, respectively.

FIG. 12A is a schematic representation of a cross-sectional view of the chamber with the molecule-bead complexes being collected to the bottom surface of the chamber under dielectrophoretic forces produced by energized DEP electrodes (energized DEP electrode layer shown by thick bold lines).

FIG. 12B is a schematic representation of a cross-sectional view of the chamber with the molecule-bead complexes being collected to the central region of the bottom surface of the chamber under traveling-wave dielectrophoretic forces produced by energized DEP electrodes.

FIG. 13A is a schematic representation of the top view of the chamber with the electrodes on the particle switch layer being energized.

FIG. 13B is a schematic representation of the top view of the chamber looking through to the particle switch layer, illustrating the four types of molecule-bead complexes being switched and separated to the ends of three branches within a particle switch when the electrodes in the particle switch are energized with phase-shifted electric signals.

FIG. 13C is a schematic representation of the top view of the chamber illustrating the four types of molecule-bead complexes switched and separated to three ends of the chamber.

FIG. 14A is a schematic representation of a three-dimensional perspective view of a DNA-analysis chamber showing the DNA probe layer.

FIG. 14B is a schematic representation of a three-dimensional perspective view of a DNA-analysis chamber showing the traveling-wave dielectrophoresis (TW-DEP) electrode layer. The detailed electrical connections of such TW-DEP electrodes to a signal source that can produce at least 3 phase-shifted signals having the same frequency are not shown.

FIG. 14C is a schematic representation of a three-dimensional perspective view of a DNA-analysis chamber showing the magnetic sensor layer. The letter “S” represents “sensor”.

FIG. 14D is a schematic representation of a three-dimensional perspective view of a DNA-analysis chamber showing that the traveling-wave dielectrophoresis layer being energized, and the energized traveling-wave dielectrophoresis electrodes moving the DNA-bead complexes into the chamber (energized electrode layer depicted with thick bold lines). The DNA-analysis chamber comprises a chip having a DNA probe layer (top layer), a traveling-wave DEP layer, and a magnetic sensor layer

FIG. 14E is a schematic representation of a three-dimensional perspective view of a DNA-analysis chamber showing that the DNA-bead complexes are dispersed into the chamber and target DNA molecules hybridized to the beads are also hybridized to the DNA probes on the chip.

FIG. 14F is a schematic representation of a three-dimensional perspective view of a DNA-analysis chamber showing that the single-stranded portions of the target DNA molecules on the DNA-bead complexes are hybridized to the DNA probes on the chip that are localized to magnetic sensors. The presence and the number of the magnetic beads are detected with the magnetic sensors (energized magnetic sensor layer depicted with thick bold lines). To illustrate that magnetic sensors are responsive to the presence of the magnetic beads, individual magnetic sensors are schematically shown, although these sensor elements cannot be seen from the top of the chamber.

FIG. 15A is a schematic representation of a three-dimensional perspective view of the protein/mRNA-analysis chamber that comprises a chip showing the nucleic acid probe/antibody probe layer (top layer) of the chip.

FIG. 15B is a schematic representation of a three-dimensional perspective view of the protein/mRNA-analysis chamber showing the traveling-wave dielectrophoresis electrode layer of the chip. The detailed electrical connections of such TW-DEP electrodes to a signal source that can produce at least 3 phase-shifted signals having a same frequency are not shown.

FIG. 15C is a schematic representation of a three-dimensional perspective view of the protein/mRNA-analysis chamber showing that the protein-bead complexes and mRNA-bead complexes are dispersed into the chamber using traveling-wave dielectrophoresis (energized electrode layer depicted with thick bold lines).

FIG. 15D is a schematic representation of a three-dimensional perspective view of the protein/mRNA-analysis chamber showing that the protein molecules and mRNA molecules are decoupled or dissociated from the beads and have begun to bind specific binding partners on the chip surface.

FIG. 15E is a schematic representation of a three-dimensional perspective view of a protein/mRNA-analysis chamber showing that the protein molecules and mRNA molecules are bound to the antibody-probes and nucleic acid probes respectively. Detectably-labeled binding partners are being introduced to the protein/mRNA-analysis chamber from a port. The beads have been removed from the chamber or the detection regions of the chamber by traveling-wave dielectrophoresis forces by energizing TW-DEP electrodes (not shown) or by fluid flow forces during the process of introduction of the detectably-labeled (fluorescence-labeled) binding molecules (not shown).

FIG. 15F is a schematic representation of a three-dimensional perspective view of a protein/mRNA-analysis chamber showing that the fluorescence-labeled binding molecules are bound to the protein molecules and to the mRNA molecules that have bound to the probes on the chip.

FIGS. 16A and B are schematic representations of a three-dimensional perspective view of a small-molecule analysis chamber comprising a chip at the bottom. The chip has a fluidic channel layer (A), and a traveling-wave DEP layer (B). The detailed electrical connections of the traveling-wave DEP electrodes to a signal source that can generate at least 3 phase-shifted signals having the same frequency are not shown.

FIG. 16C is a schematic representation of a three-dimensional perspective view of the small-molecule analysis chamber showing that the small-molecule-bead complexes are moved to the central regions of the channel using traveling-wave dielectrophoresis (active electrode layer depicted with thick bold lines).

FIG. 16D is a schematic representation of a three-dimensional perspective view of the small-molecule analysis chamber showing that the small molecules are de-coupled or dissociated from the beads. The beads have been moved out of the chamber by traveling-wave dielectrophoresis (not shown). The molecules are then labeled with florescence molecules (not shown).

FIG. 16E is a schematic representation of a three-dimensional perspective view of small-molecule analysis chamber showing that the small molecules are directed through the channel under electrophoresis or electro-osmosis effects.

FIG. 16F is a schematic representation of a three-dimensional perspective view of small-molecule analysis chamber showing that the small molecules are directed through the channel and are detected by an off-chip fluorescence detector.

FIG. 17 depicts a single chip integrated biochip system, in which the chip is part of a chamber, and the cover of the chamber has inlet ports for the application of a sample and the addition of reagents, and outlet ports for the outflow of waste. Three separate areas of the chip are used for sample processing (areas A and B) and analysis (C), and each area of the chip has different functional areas.

FIG. 18 depicts a single chip integrated biochip system, in which the chip is part of a chamber, and the cover of the chamber has inlet ports for the application of a sample and the addition of reagents, and outlet ports for the outflow of waste. The chip comprises a particle switch that can direct sample components to different areas of the chip for further processing and analysis tasks.

FIG. 19A is a top view of a multiple force chip capable of producing dielectrophoretic forces from an upper layer having interdigitated electrodes and electromagnetic forces from a lower layer having electromagnetic elements.

FIG. 19B is a top view through the chamber comprising the multiple force chip showing a diluted blood sample introduced into the chamber.

FIG. 19C is a top view through the chamber comprising the multiple force chip showing white blood cell collected at the edges of the interdigitated microelectrode array by positive dielectrophoretic forces.

FIG. 19D is a top view through the chamber comprising the multiple force chip just after the addition of a lysis buffer that contains magnetic beads with oligo-(dT)₂₅ modified surfaces.

FIG. 19E is a top view through the chamber comprising the multiple force chip showing the capture of the magnetic beads at the poles of activated magnetic elements.

FIG. 19F is an image of an agarose gel showing an RT-PCR product generating from mRNA recovered from the captured magnetic beads.

### SUMMARY

The present invention recognizes that analytical techniques that can be useful in medical diagnosis, forensics, genetic testing, prognostics, and pharmacogenomics, and research often require extensive preparation of complex biological samples. Preparation of biological samples such as blood samples can require multiple steps such as centrifugation, filtering, and pipeting, and steps that involve lysis procedures, incubations, enzymatic treatments, gel purification of nucleic acids or proteins, etc. Such steps are time-consuming, labor intensive, and difficult to standardize. The present invention recognizes that an automated integrated system that can perform both sample preparation and sample analysis can standardize and streamline testing procedures from sample to result, representing, in effect, a “lab on a chip” that requires minimal manual intervention. In addition, such systems can be designed to analyze multiple sample components at once, reducing the need for multiple samples to be taken from a single source, greatly accelerating the process of diagnosis, assessment, or investigation.

The present invention also recognizes that the ability to manipulate particles, such as cells and microparticles bound to sample components using applied physical forces, can be utilized to automate, streamline sample processing and analysis. These methods of manipulating sample components for sample processing (or sample preparation) and analysis can be utilized for a variety of purposes, such as the detection of particular molecules, compounds, or nucleic acid sequences in samples, for use in the diagnosis or prognosis of disease states, conditions, or infection with etiological agents, in the identification of subjects, in the genetic screening of subjects, and other applications.

A first aspect of the invention is an integrated biochip system that comprises a single chip, wherein the chip can perform at least two sequential tasks, and at least one of the tasks functions in the processing of a sample. Preferably, at least one task is performed by the application of physical forces that are in part generated by micro-scale structures that are built into or onto a chip. Preferably, at least one task is performed by the manipulation of binding partners that are coupled to a sample moiety. An integrated biochip system is preferably automated.

A second aspect of the invention is an integrated biochip system that comprises two or more chips and can perform at least two sequential tasks using two or more chips of the integrated system, wherein at least one of the chips of the system can perform at least one task in the preparation of a sample. Preferably, an integrated biochip system comprising two or more chips is automated, and at least two of the chips of the system can be in fluid communication with one another. Translocation of sample components from at least one chip of the integrated biochip system to at least one other chip of the integrated biochip system is preferably by a mechanism other than fluid flow, most preferably through the application of physical forces.

Preferably, at least one task is performed by the application of physical forces that are in part generated by micro-scale structures that are built into or onto a chip, at least one task can be performed by the manipulation of binding partners that are coupled to a sample moiety.

A third aspect of the invention is a method of using a system of integrated chips for processing and analyzing samples. The method includes the application of a sample to the system and performing at least two sequential tasks in the processing and, optionally, analysis, of a sample. At least one processing task can be performed by the integrated system using applied physical forces that are in part generated by microscale structures on the surface of a chip of the system. Preferably but optionally the processing step can include the manipulation of sample moieties coupled to microparticles.

### DETAILED DESCRIPTION OF THE INVENTION

Definitions

Unless defined otherwise, all technical and scientific terms used herein have the same meaning as commonly understood by one of ordinary skill in the art to which this invention belongs. Generally, the nomenclature used herein and the manufacture or laboratory procedures described below are well known and commonly employed in the art. Conventional methods are used for these procedures, such as those provided in the art and various general references. Terms of orientation such as “up” and “down” or “upper” or “lower” and the like refer to orientation of parts during use of a device. Where a term is provided in the singular, the inventors also contemplate the plural of that term. The nomenclature used herein is well known and commonly employed in the art. Where there are discrepancies in terms and definitions used in references that are incorporated by reference, the terms used in this application shall have the definitions given herein. As employed throughout the disclosure, the following terms, unless otherwise indicated, shall be understood to have the following meanings:

An “integrated chip system”, “integrated biochip system”, a “system of integrated chips”, a “system of integrated biochips” or “system” is at least one chip that can perform at least two sequential tasks in the processing and analysis of a sample, in which at least one task performed by the integrated biochip system is a processing task.

A “task” is a function in the processing or analysis of a sample. A task can comprise more than one step. For example, a separation task can comprise mixing and binding steps that facilitate the separation.

A “function” performed by a chip of a system of the present invention can be a task, such as a processing or analysis task, or can be another function that occurs between tasks or as part of a task and facilitates the performance of the task. One example of a non-task function is a mixing function, such as a mixing function that is performed by acoustic forces on a chip that facilitates dispersion and/or binding of sample components. Another example of a non-task function is a translocation of moieties from one chip to another chip, or from one area of a chip to another area of a chip, such as by electrophoresis, dielectrophoresis, traveling wave dielectrophoresis, or traveling wave magnetophoresis.

A “processing task” is a procedure in the processing of a sample. (Processing of a sample is also referred to as sample preparation.) Generally a processing task serves to separate components of a sample, translocate components of a sample, focus, capture, isolate, concentrate, or enrich components of a sample, at least partially purify components of a sample, or disrupt or structurally alter components of a sample (for example, by lysis, denaturation, chemical modification, or binding of components to reagents). A processing step can act on one type of sample component to release, expose, modify, or generate another type of sample component that can be used in a further processing or analysis task. For example, a cell can be lysed in a processing step to release nucleic acids that can be separated in a further processing task and detected in a subsequent analysis task. Binding or coupling can be a step in a processing task, where binding or coupling, particularly the coupling of a sample component to a binding partner such as a microparticle, facilitates the separation, translocation, capture, isolation, focusing, concentration, enrichment, structural alteration, or at least partial purification of at least one component of a sample. Mixing can also be a step in a processing task, where mixing facilitates the binding, separation, translocation, concentration, structural alteration, or at least partial purification of at least one component of a sample.

An “analysis task” is a task that determines a result of a sample processing and analysis procedure, and can be an assay, such as a binding assay, a biochemical assay, a cellular assay, a genetic assay, a detection assay, etc. Generally an analytical task determines the presence, amount, or activity of a sample component. Binding or coupling can be a step of an analysis task, where binding or coupling facilitates the detection or assay of at least one component of a sample. Mixing can also be a step of an analysis task, where mixing facilitates the binding, detection, or assay of at least one component of a sample.

“Sequential” means following a particular order, where following a particular order of tasks, for example, is necessary to achieve the desired final result. In an integrated biochip system of the present invention, tasks are performed sequentially to obtain a final result. When two tasks are performed sequentially, a second task uses one or more products of the first task, where “product” can mean a sample component that was separated, at least partially purified, or concentrated in the first step, or a sample component that was the result of a denaturing or lysing step, was subjected to a biochemical reaction or assay, became bound to a reagent, etc., in a previous task. As used herein, “first” and “second” do not refer to their absolute order in the integrated system, but rather to their relative order, where a process performed on the second chip occurs after a process performed on the first chip.

A “chip” is a surface on which at least one manipulation or process, such as a translocation, separation, capture, isolation, focusing, enrichment, concentration, physical disruption, mixing, binding, or assay can be performed. A chip can be a solid or semisolid substrate, porous or non-porous on which certain processes, such as physical, chemical, biological, biophysical or biochemical processes, etc., can be carried out. A chip that performs more than one function can have combinations of one or more different functional elements such specific binding members, substrates, reagents, or different types of micro-scale structures that provide sources of different physical forces used in the processes carried out on the chip. Chips can be multiple force chips, in which different functional elements can be provided on the same surface, or in different structurally linked substrates or layers (where a layer is a surface that supports substrates, micro-scale structures, or moieties to be manipulated) that are vertically oriented with respect to one another. For descriptions of multiple force chips, see U.S. application Ser. No. 09/679,024 having attorney docket number 471842000400, entitled “Apparatuses Containing Multiple Active Force Generating Elements and Uses Thereof” filed Oct. 4, 2000, herein incorporated by reference in its entirety.

Micro-scale structures such as but not limited to channels and wells, electrode elements, electromagnetic elements, and piezoelectric transducers are incorporated into, fabricated on, or otherwise attached to the substrate for facilitating physical, biophysical, biological, biochemical, or chemical reactions or processes on the chip. The chip may be thin in one dimension and may have various shapes in other dimensions, for example, a rectangle, a circle, an ellipse, or other irregular shapes. The size of the major surface of chips of the present invention can vary considerably, e.g., from about 1 mm² to about 0.25 m². Preferably, the size of the chips is from about 4 mm² to about 25 cm² with a characteristic dimension from about 1 mm to about 5 cm. The chip surfaces may be flat, or not flat. The chips with non-flat surfaces may include channels or wells fabricated on the surfaces.

“Micro-scale structures” are structures integral to or attached on a chip or chamber that have characteristic dimensions of scale for use in microfluidic applications ranging from about 0.1 micron to about 20 mm. Example of micro-scale structures are wells, channels, scaffolds, electrodes, electromagnetic units, piezoelectric transducers, metal wires or films, Peltier elements, microfabricated pumps or valves, microfabricated capillaries or tips, or optical elements. A variety of micro-scale structures are disclosed in U.S. patent application Ser. No. 09/679,024, having attorney docket number 471842000400, entitled “Apparatuses Containing Multiple Active Force Generating Elements and Uses Thereof” filed Oct. 4, 2000, herein incorporated by reference in its entirety. Micro-scale structures that can, when energy, such as an electrical signal, is applied, generate physical forces useful in the present invention, can be referred to as “physical force-generating elements” “physical force elements”, “active force elements”, or “active elements”.

“Substrate” refers to the surface of a chip where a moiety to be manipulated can be held and manipulated. A substrate can be hydrophobic or hydrophilic, or a combination thereof, and can comprise materials such as silicon, rubber, glass, one or more ceramics, plastics, polymers, or copolymers. The substrate can be solid or semisolid, can comprises one or more channels or wells, and can support micro-scale structures and functional elements such as specific binding members, substrates, reagents, or catalysts.

An “electrode” is a structure of highly electrically conductive material. A highly conductive material is a material with a conductivity greater than that of surrounding structures or materials. Suitable highly electrically conductive materials include metals, such as gold, chromium, platinum, aluminum, and the like, and can also include nonmetals, such as carbon and conductive polymers. An electrode can be any shape, such as rectangular, circular, castellated, etc. Electrodes can also comprise doped semiconductors, where a semi-conducting material is mixed with small amounts of other conductive materials.

A “chamber” is a structure that that is capable of containing a fluid sample and preferably comprises at least a portion of a chip.

A “port” is an opening in a chamber through which a fluid sample can enter or exit the chamber. A port can be of any dimensions, but preferably is of a shape and size that allows a sample to be translocated through the port by physical forces, or dispensed through the port by means of a pipette, syringe, or conduit, or other means of applying a sample.

A “conduit” is a means for fluid to be transported from a container to a chamber of the present invention. Preferably a conduit engages a port in a chamber. A conduit can comprise any material that permits the passage of a fluid through it. Preferably a conduit is tubing, such as, for example, rubber, Teflon (polytetrafluoroethylene), or tygon tubing. A conduit can be of any dimensions, but preferably ranges from 10 microns to 5 millimeters in internal diameter.

A “well” is a structure in a chip, with a lower surface surrounded on at least two sides by one or more walls that extend from the lower surface of the well or channel. The walls can extend upward from the lower surface of a well or channel at any angle or in any way. The walls can be of an irregular conformation, that is, they may extend upward in a sigmoidal or otherwise curved or multi-angled fashion. The lower surface of the well or channel can be at the same level as the upper surface of a chip or higher than the upper surface of a chip, or lower than the upper surface of a chip, such that the well is a depression in the surface of a chip. The sides or walls of a well or channel can comprise materials other than those that make up the lower surface of a chip. In this way the lower surface of a chip can comprise a thin material through which electrical (including electromagnetic) forces can be transmitted, and the walls of one or more wells and/or one or more channels can optionally comprise other insulating materials that can prevent the transmission of electrical forces. The walls of a well or a channel of a chip can comprise any suitable material, including silicon, glass, rubber, and/or one or more polymers, plastics, ceramics, or metals.

A “channel” is a structure in a chip with a lower surface and at least two walls that extend upward from the lower surface of the channel, and in which the length of two opposite walls is greater than the distance between the two opposite walls. A channel therefore allows for flow of a fluid along its internal length. A channel can be covered (a “tunnel”) or open.

An “active chip” is a chip that comprises micro-scale structures that are built into or onto a chip that when energized by an external power source can generate at least one physical force that can perform a processing step or task or an analysis step or task, such as, but not limited to, mixing, translocation, focusing, separation, concentration, capture, isolation, or enrichment. An active chip uses applied physical forces to promote, enhance, or facilitate desired biochemical reactions or processing steps or tasks or analysis steps or tasks. On an active chip, “applied physical forces” are physical forces that, when energy is provided by a power source that is external to an active chip, are generated by microscale structures built into or onto a chip.

A “passive chip” is a chip that does not utilize externally applied physical forces to manipulate or control molecules and particles for chemical, biochemical, or biological reactions. Instead, the reaction process on a passive chip involves thermal diffusion of molecules and particles and involves naturally occurring forces such as the earth's gravity.

An “electromagentic chip” is a chip that includes at least one electromagnetic unit, such as a micro-electromagnetic unit. The electromagnetic unit can be on the surface of a chip, or can be provided integrally or at least partially integrally, within said chip. For example, an electromagnetic unit can be provided on the surface of a chip or can be imbedded within a chip. Optionally, an electromagnetic unit can be partially imbedded within a chip. Preferred electromagnetic chips are those disclosed in U.S. patent application Ser. No. 09/399,299 (attorney docket number ART00104.P.1), filed Sep. 17, 1999, entitled, “Individually Addressable MicroElectromagnetic Unit Array Chips” and U.S. patent application Ser. No. 09/685,410 (attorney docket number ART-00104.P.1.1), filed Oct. 10, 2000, entitled, “Individually Addressable Micro-Electromagnetic Unit Array Chips in Horizontal Configurations”, both herein incorporated by reference in their entireties.

“Particle switch chip” refers to the chip disclosed in U.S. application Ser. No. 09/678,263 (attorney docket number ARTLNCO.002A), entitled “Apparatus for Switching and Manipulating Particles and Methods of Use Thereof” filed on Oct. 3, 2000, incorporated by reference in its entirety, comprising at least three sets of electrodes that are independent of one another, that can translocate particles using traveling wave dielectrophoresis or traveling wave electrophoresis, and that can be used to move particles along different pathways connected at a common branch point when the sets of electrodes are connected to out-of-phase signals.

A “multiple force chip” or “multiforce chip” is a chip that generates physical force fields and that has at least two different types of built-in structures each of which is, in combination with an external power source, capable of generating one type of physical field. A full description of the multiple force chip is provided in U.S. application Ser. No. 09/679,024 having attorney docket number 471842000400, entitled “Apparatuses Containing Multiple Active Force Generating Elements and Uses Thereof” filed Oct. 4, 2000, herein incorporated by reference in its entirety.

“Mixing” as used herein means the use of physical forces to cause particle movement in a sample, solution, or mixture (such as a mixture of sample and sample solution, or a mixture or moieties and binding partners), or to cause movement of sample, solution or mixture that is contained in a chamber such that components of the sample, solution, or mixture become interspersed. Preferred methods of mixing for use in the present invention include use of acoustic forces and thermal convection.

“Disruption” as used herein means changing the structural state of a sample component. Examples of disruption are cell lysis, denaturation of proteins, and dissociation of subunits of complexes, such as, for example, ribosomes. Disruptions can be effected through the use of physical forces, such as for example, high voltage electric fields or acoustic forces, or by use of reagents such as denaturing agents, chelating agents, surfactants, or enzymes.

“Piezoelectic transducers” are structures capable of generating an acoustic field in response to an electrical signal. Preferred piezoelectric transducers are piezoelectric ceramic disks or piezoelectric thin films covered on both surfaces with a metal film.

“Electromagnetic units” are structures that, when connected to a source of electric current, can produce a magnetic field and exert a magnetic force on magnetic or paramagnetic particles. Electromagnetic units preferably include a core that is preferably magnetic or magnetizable, and a means, such as a conducting coil, for conducting an electric current about said magnetic core.

“Fluid flow” refers to the mass flow of fluid by means such as by electrophoresis or mechanical force, such as pressure or thermal convection forces.

“Automated” means not requiring manual procedures, such as pipeting or other manual transfer of samples or reagents, inversion or vortexing of tubes, placing samples in a centrifuge, incubator, etc. by a practitioner, and the like. An automated system may, however, require manual application of the sample to the system (i.e., by pipeting or injecting), or manual recovery of sample components that have been fully processed by the system (i.e., by pipeting from a chamber, or collecting in a tube that a conduit leads into). An automated system may or may not require a practitioner to control power-driven systems for fluid flow, to control power-driven systems for generating physical forces for the performance of processing and analysis tasks, to control power-driven systems for generating physical forces for the translocation of sample components, and the like, during the operation of the integrated chip system. An automated system, such as an automated integrated biochip system of the present invention, is preferably but optionally programmable.

As used herein, “physical field,” e.g., used itself or used as “physical field in a region of space” or “physical field is generated in a region of space” means that the region of space has following characteristics. When a moiety of appropriate properties is introduced into the region of space (i.e. into the physical field), forces are produced on the moiety as a result of the interaction between the moiety and the field. A moiety can be manipulated within a field via the physical forces exerted on the moiety by the field. Exemplary fields include electric, magnetic, acoustic, optical and velocity fields. In the present invention, physical field always exists in a medium in a region of space, and the moiety to be manipulated is suspended in, or is dissolved in, or more generally, is placed in the medium. Typically, the medium is a fluid such as aqueous or non-aqueous liquids, or a gas. Depending on the field configuration, an electric field may produce electrophoretic forces on charged moieties, or may produce conventional dielectrophoretic forces and/or traveling wave dielectrophoretic forces on charged and/or neutral moieties. Magnetic fields may produce magnetic forces on magnetic moieties (including paramagnetic moieties), or traveling-wave magnetophoretic forces on magnetic moieties. Acoustic field may produce acoustic radiation forces on moieties. Optical field may produce optical radiation forces on moieties. Velocity field in the medium in a region of space refers to a velocity distribution of the medium that moves in the region of the space. Various mechanisms may be responsible for causing the medium to move and the medium at different positions may exhibit different velocities, thus generating a velocity field. A velocity field may exert mechanical forces on moieties in the medium.

As used herein, “physical force” refers to any force that moves the moieties or their binding partners without chemically or biologically reacting with the moieties and the binding partners, or with minimal chemical or biological reactions with the binding partners and the moieties so that the biological/chemical functions/properties of the binding partners and the moieties are not substantially altered as a result of such reactions. Throughout the application, the term of “forces” or “physical forces” always means the “forces” or “physical forces” exerted on a moiety or moieties. The “forces” or “physical forces” are always generated through “fields” or “physical fields”. The forces exerted on moieties by the fields depend on the properties of the moieties. Thus, for a given field or physical field to exert physical forces on a moiety, it is necessary for the moiety to have certain properties. While certain types of fields may be able to exert forces on different types of moieties having different properties, other types of fields may be able to exert forces on only limited type of moieties. For example, magnetic field can exert forces or magnetic forces only on magnetic particles or moieties having certain magnetic properties, but not on other particles, e.g., polystyrene beads. On the other hand, a non-uniform electric field can exert physical forces on many types of moieties such as polystyrene beads, cells, and also magnetic particles.

As used here in, “electric forces” (or “electrical forces”) are the forces exerted on moieties by an electric (or electrical) field.

“Electric field pattern” refers to the field distribution, which is function of the frequency of the field, the magnitude of the field, the geometry of the electrode structures, and the frequency and/or magnitude modulation of the field.

“Dielectric properties” of a moiety are properties that determine, at least in part, the response of a moiety to a dielectric field. The dielectric properties of a moiety include the effective electric conductivity of a moiety and the effective electric permittivity of a moiety. For a particle of homogeneous composition, for example, a polystyrene bead, the effective conductivity and effective permittivity are independent of the frequency of the electric field. For moieties of nonhomogeneous composition, for a example, a cell, the effective conductivity and effective permittivity are values that take into account the effective conductivities and effective permittivities of both the surface (membrane) and internal portion of the cell, and can vary with the frequency of the electric field. In addition, the dielectric force experience by a moiety in an electric field is dependent on its size; therefore, the overall size of moiety is herein considered to be a dielectric property of a moiety. Properties of a moiety that contribute to its dielectric properties include the net charge on a moiety; the composition of a moiety (including the distribution of chemical groups or moieties on, within, or throughout a moiety); size of a moiety; surface configuration of a moiety; surface charge of a moiety; and the conformation of a moiety.

A “dielectrophoretic force” is the force that acts on a polarizable particle in a nonuniform AC electrical field. As used herein “dielectrophoresis” is the movement of moieties in response to dielectric forces.

“Dielectrophoresis”, sometimes called “conventional dielectrophoresis, is the movement of polarized particles in nonuniform electrical fields. There are generally two types of dielectrophoresis, positive dielectorphoresis and negative dielectrophoresis. In positive dielectrophoresis, particles are moved by dielectrophoresis toward the strong field regions. In negative dielectrophoresis, particles are moved by dielectrophoresis toward weak field regions. Whether moieties exhibit positive or negative dielectrophoresis depends on whether particles are more or less polarizable than the surrounding medium.

“Traveling-wave dielectrophoretic (DEP) force” refers to the force that is generated on particles or molecules due to a traveling-wave electric field. An ideal traveling-wave field is characterized by the distribution of the phase values of AC electric field components, being a linear function of the position of the particle. A traveling wave electric field can be established by applying appropriate AC signals to the microelectrodes appropriately arranged on a chip. For generating a traveling-wave-electric field, it is necessary to apply at least three types of electrical signals each having a different phase value. An example to produce a traveling wave electric field is to use four phase-quardrature signals (0, 90, 180 and 270 degrees) to energize four linear, parallel electrodes patterned on the chip surfaces. Such four electrodes may be used to form a basic, repeating unit. Depending on the applications, there may be more than two such units that are located next to each other. This will produce a traveling electric field in the spaces above or near the electrodes. As long as electrode elements are arranged following certain spatially sequential orders, applying phase-sequenced signals will result in establishing traveling electrical fields in the region close to the electrodes.

As used herein, “traveling wave dielectrophoresis” is the movement of moieties in response to a traveling wave electric field.

As used herein, “magnetic forces” are the forces exerted on moieties by a magnetic field.

“Traveling wave electromagnetic force” refers to the force that is generated on particles or molecules due to a traveling magnetic field or a traveling magnetic wave.

“Traveling wave magnetophoresis” refers to the movement of a magnetic particle or magnetizable particle under the influence of a traveling magnetic field or a traveling magnetic wave generated by an array of electromagnetic units. The individual electromagnetic units are arranged according to specific spatial relationships among the units. For example, individual electromagnetic units may be of rectangular geometry and of equivalent lengths, and microfabricated on chips so that the units are aligned and parallel to each other, as depicted, for example, in FIG. 24B of U.S. patent application Ser. No. 09/685,410 and having attorney docket number ART-00104.P.1.1, filed Oct. 10, 2000, entitled, “Individually Addressable MicroElectromagnetic Unit Array Chips in Horizontal Configurations”, which is incorporated by reference in its entirety. Traveling wave magnetophoresis can be synchronized or continuous. In synchronized magnetophoresis, a DC current is used to magnetize individual electromagnetic units within an array such that the electromagnetic units can be addressed sequentially. The sequentially addressed electromagnetic units are energized in an order, such as a predetermined order, such that a magnetic particle or magnetizable particle transfers from one location to another. In continuous magnetophoresis, an AC current is used such that the electromagnetic units are addressed using currents that are out of phase, such as, but not limited to, about 90 degrees out of phase. Alternative phase shifts can also be utilized. The phase shifts cause a traveling magnetic wave or traveling magnetic field to form.

As used herein, “acoustic forces (or acoustic radiation forces)” are the forces exerted on moieties by an acoustic field.

As used herein, “optical (or optical radiation) forces” are the forces exerted on moieties by an optical field.

A “sample” is any fluid from which components are to be separated or analyzed. A sample can be from any source, such as an organism, group of organisms from the same or different species, from the environment, such as from a body of water or from the soil, or from a food source or an industrial source. A sample can be an unprocessed or a processed sample. A sample can be a gas, a liquid, or a semi-solid, and can be a solution or a suspension. A sample can be an extract, for example a liquid extract of a soil or food sample, an extract of a throat or genital swab, or an extract of a fecal sample.

A “blood sample” as used herein can refer to a processed or unprocessed blood sample, i.e., it can be a centrifuged, filtered, extracted, or otherwise treated blood sample, including a blood sample to which one or more reagents such as, but not limited to, anticoagulants or stabilizers have been added. A blood sample can be of any volume, and can be from any subject such as an animal or human. A preferred subject is a human.

“Subject” refers to any organism, such as an animal or a human. An animal can include any animal, such as a feral animal, a companion animal such as a dog or cat, an agricultural animal such as a pig or a cow, or a pleasure animal such as a horse.

A “white blood cell” is a leukocyte, or a cell of the hematopoietic lineage that is not a reticulocyte or platelet and that can be found in the blood of an animal. Leukocytes can include lymphocytes, such as B lymphocytes or T lymphocytes. Leukocytes can also include phagocytic cells, such as monocytes, macrophages, and granulocytes, including basophils, eosinophils and neutrophils. Leukocytes can also comprise mast cells.

A “red blood cell” is an erythrocyte.

“Neoplastic cells” refers to abnormal cells that grow by cellular proliferation more rapidly than normal and can continue to grow after the stimuli that induced the new growth has been withdrawn. Neoplastic cells tend to show partial or complete lack of structural organization and functional coordination with the normal tissue, and may be benign or malignant.

A “malignant cell” is a cell having the property of locally invasive and destructive growth and metastasis.

A “stem cell” is an undifferentiated cell that can give rise, through one or more cell division cycles, to at least one differentiated cell type.

A “progenitor cell” is a committed but undifferentiated cell that can give rise, through one or more cell division cycles, to at least one differentiated cell type. Typically, a stem cell gives rise to a progenitor cell through one or more cell divisions in response to a particular stimulus or set of stimuli, and a progenitor gives rise to one or more differentiated cell types in response to a particular stimulus or set of stimuli.

An “etiological agent” refers to any etiological agent, such as a bacteria, virus, parasite or prion that can infect a subject. An etiological agent can cause symptoms or a disease state in the subject it infects. A human etiological agent is an etiological agent that can infect a human subject. Such human etiological agents may be specific for humans, such as a specific human etiological agent, or may infect a variety of species, such as a promiscuous human etiological agent.

A “component” of a sample or “sample component” is any constituent of a sample, and can be an ion, molecule, compound, molecular complex, organelle, virus, cell, aggregate, or particle of any type, including colloids, aggregates, particulates, crystals, minerals, etc. A component of a sample can be a constituent entity of a sample that has been exposed or altered by processes performed before application of the sample to a system of the present invention, or by the methods of the present invention, such as methods performed by a system of the present invention. A component of a sample can be soluble or insoluble in the sample media or a provided sample buffer or sample solution. A component of a sample can be in gaseous, liquid, or solid form. A component of a sample may be a moiety or may not be a moiety.

A “moiety” or “moiety of interest” is any entity whose manipulation in a system of the present invention is desirable. A moiety can be a solid, including a suspended solid, or can be in soluble form. A moiety can be a molecule. Molecules that can be manipulated include, but are not limited to, inorganic molecules, including ions and inorganic compounds, or can be organic molecules, including amino acids, peptides, proteins, glycoproteins, lipoproteins, glycolipoproteins, lipids, fats, sterols, sugars, carbohydrates, nucleic acid molecules, small organic molecules, or complex organic molecules. A moiety can also be a molecular complex, can be an organelle, can be one or more cells, including prokaryotic and eukaryotic cells, or can be one or more etiological agents, including viruses, parasites, or prions, or portions thereof. A moiety can also be a crystal, mineral, colloid, fragment, mycelle, droplet, bubble, or the like, and can comprise one or more inorganic materials such as polymeric materials, metals, minerals, glass, ceramics, and the like. Moieties can also be aggregates of molecules, complexes, cells, organelles, viruses, etiological agents, crystals, colloids, or fragments. Cells can be any cells, including prokaryotic and eukaryotic cells. Eukaryotic cells can be of any type. Of particular interest are cells such as, but not limited to, white blood cells, malignant cells, stem cells, progenitor cells, fetal cells, and cells infected with an etiological agent, and bacterial cells. Moieties can also be artificial particles such polystyrene microbeads, microbeads of other polymer compositions, magnetic micorbeads, carbon microbeads.

As used herein, “intracellular moiety” refers to any moiety that resides or is otherwise located within a cell, i.e., located in the cytoplasm or matrix of cellular organelle, attached to any intracellular membrane, resides or is otherwise located within periplasm, if there is one, or resides or is otherwise located on cell surface, i.e., attached on the outer surface of cytoplasm membrane or cell wall, if there is one.

As used herein, “manipulation” refers to moving or processing of the moieties, which results in one-, two- or three-dimensional movement of the moiety, in a chip format, whether within a single chip or between or among multiple chips. Moieties that are manipulated by the methods of the present invention can optionally be coupled to binding partners, such as microparticles. Non-limiting examples of the manipulations include transportation, capture, focusing, enrichment, concentration, aggregation, trapping, repulsion, levitation, separation, isolation or linear or other directed motion of the moieties. For effective manipulation of moieties coupled to binding partners, the binding partner and the physical force used in the method must be compatible. For example, binding partners with magnetic properties must be used with magnetic force. Similarly, binding partners with certain dielectric properties, e.g., plastic particles, polystyrene microbeads, must be used with dielectrophoretic force.

As used herein, “the moiety to be manipulated is substantially coupled onto surface of the binding partner” means that a majority of the moiety to be manipulated is coupled onto surface of the binding partner and can be manipulated by a suitable physical force via manipulation of the binding partner. Ordinarily, at least 1% of the moiety to be manipulated is coupled onto surface of the binding partner. Preferably, at least 5%, 10%, 20%, 30%, 40%, 50%, 60%, 70%, 80% or 90% of the moiety to be manipulated is coupled onto surface of the binding partner.

As used herein, “the moiety to be manipulated is completely coupled onto surface of the binding partner” means that at least 90% of the moiety to be manipulated is coupled onto surface of the binding partner. Preferably, at least 91%, 92%, 93%, 94%, 95%, 96%, 97%, 98%, 99% or 100% of the moiety to be manipulated is coupled onto surface of the binding partner. A “solution that selectively modifies red blood cells” is a solution that alters non-nucleated red blood cells such that they do not interfere with the dielectrophoretic separation of other cells or components of a blood sample, without substantially altering the integrity of white blood cells, or interfering with the ability of white blood cells to be dielectrically separated from other components of a blood sample.

“Binding partner” refers to any substances that both bind to the moieties with desired affinity or specificity and are manipulatable with the desired physical force(s). Non-limiting examples of the binding partners include cells, cellular organelles, viruses, microparticles or an aggregate or complex thereof, or an aggregate or complex of molecules.

A “microparticle” or “particle” is a structure of any shape and of any composition, that is manipulatable by desired physical force(s). The microparticles used in the methods could have a dimension from about 0.01 micron to about ten centimeters. Preferably, the microparticles used in the methods have a dimension from about 0.1 micron to about several thousand microns. Such particles or microparticles can be comprised of any suitable material, such as glass or ceramics, and/or one or more polymers, such as, for example, nylon, polytetrafluoroethylene (TEFLON™), polystyrene, polyacrylamide, sepaharose, agarose, cellulose, cellulose derivatives, or dextran, and/or can comprise metals. Examples of microparticles include, but are not limited to, plastic particles, ceramic particles, carbon particles, polystyrene microbeads, glass beads, magnetic beads, hollow glass spheres, metal particles, particles of complex compositions, microfabricated or micromachined particles, etc.

“Coupled” means bound. For example, a moiety can be coupled to a microparticle by specific or nonspecific binding. As disclosed herein, the binding can be covalent or noncovalent, reversible or irreversible.

A “specific binding member” is one of two different molecules having an area on the surface or in a cavity which specifically binds to and is thereby defined as complementary with a particular spatial and polar organization of the other molecule. A specific binding member can be a member of an immunological pair such as antigen-antibody, can be biotin-avidin or biotin streptavidin, ligand-receptor, nucleic acid duplexes, IgG-protein A, DNA-DNA, DNA-RNA, RNA-RNA, and the like.

A “nucleic acid molecule” is a polynucleotide. A nucleic acid molecule can be DNA, RNA, or a combination of both. A nucleic acid molecule can also include sugars other than ribose and deoxyribose incorporated into the backbone, and thus can be other than DNA or RNA. A nucleic acid can comprise nucleobases that are naturally occurring or that do not occur in nature, such as xanthine, derivatives of nucleobases, such as 2-aminoadenine, and the like. A nucleic acid molecule of the present invention can have linkages other than phosphodiester linkages. A nucleic acid molecule of the present invention can be a peptide nucleic acid molecule, in which nucleobases are linked to a peptide backbone. A nucleic acid molecule can be of any length, and can be single-stranded, double-stranded, or triple-stranded, or any combination thereof.

“Homogeneous manipulation” refers to the manipulation of particles in a mixture using physical forces, wherein all particles of the mixture have the same response to the applied force.

“Selective manipulation” refers to the manipulation of particles using physical forces, in which different particles in a mixture have different responses to the applied force.

“Separation” is a process in which one or more components of a sample is spatially separated from one or more other components of a sample. A separation can be performed such that one or more moieties of interest is translocated to one or more areas of a separation apparatus and at least some of the remaining components are translocated away from the area or areas where the one or more moieties of interest are translocated to and/or retained in, or in which one or more moieties is retained in one or more areas and at least some or the remaining components are removed from the area or areas. Alternatively, one or more components of a sample can be translocated to and/or retained in one or more areas and one or more moieties can be removed from the area or areas, and optionally collected. It is also possible to cause one or more moieties to be translocated to one or more areas and one or more moieties of interest or one or more components of a sample to be translocated to one or more other areas. Separations can be achieved through the use of physical, chemical, electrical, or magnetic forces. Examples of forces that can be used in separations are gravity, mass flow, dielectrophoretic forces, and electromagnetic forces.

“Capture” is a type of separation in which one or more moieties is retained in one or more areas of a chip. A capture can be performed using a specific binding member that binds a moiety of interest with high affinity.

An “assay” is a test performed on a sample or a component of a sample. An assay can test for the presence of a component, the amount or concentration of a component, the composition of a component, the activity of a component, etc. Assays that can be performed in conjunction with the compositions and methods of the present invention include biochemical assays, binding assays, cellular assays, and genetic assays.

A “reaction” is a chemical or biochemical process that changes the chemical or biochemical composition of one or more molecules or compounds or that changes the interaction of one or more molecules with one or more other molecules or compounds. Reactions of the present invention can be catalyzed by enzymes, and can include degradation reactions, synthetic reactions, modifying reactions, or binding reactions.

A “binding assay” is an assay that tests for the presence or concentration of an entity by detecting binding of the entity to a specific binding member, or that tests the ability of an entity to bind another entity, or tests the binding affinity of one entity for another entity. An entity can be an organic or inorganic molecule, a molecular complex that comprises, organic, inorganic, or a combination of organic and inorganic compounds, an organelle, a virus, or a cell. Binding assays can use detectable labels or signal generating systems that give rise to detectable signals in the presence of the bound entity. Standard binding assays include those that rely on nucleic acid hybridization to detect specific nucleic acid sequences, those that rely on antibody binding to entities, and those that rely on ligands binding to receptors.

A “biochemical assay” is an assay that tests for the presence, concentration, or activity of one or more components of a sample.

A “cellular assay” is an assay that tests for a cellular process, such as, but not limited to, a metabolic activity, a catabolic activity, an ion channel activity, an intracellular signaling activity, a receptor-linked signaling activity, a transcriptional activity, a translational activity, or a secretory activity.

A “genetic assay” is an assay that tests for the presence or sequence of a genetic element, where a genetic element can be any segment of a DNA or RNA molecule, including, but not limited to, a gene, a repetitive element, a transposable element, a regulatory element, a telomere, a centromere, or DNA or RNA of unknown function. As nonlimiting examples, genetic assays can use nucleic acid hybridization techniques, can comprise nucleic acid sequencing reactions, or can use one or more polymerases, as, for example a genetic assay based on PCR. A genetic assay can use one or more detectable labels, such as, but not limited to, fluorochromes, radioisotopes, or signal generating systems.

A “detection assay” is an assay that can detect a substance, such as an ion, molecule, or compound by producing a detectable signal in the presence of the substance. Detection assays can use specific binding members, such as antibodies or nucleic acid molecules, and detectable labels that can directly or indirectly bind the specific binding member or the substance or a reaction product of the substance. Detection assays can also use signal producing systems, including enzymes or catalysts that directly or indirectly produce a detectable signal in the presence of the substance or a product of the substance.

A “detectable label” is a compound or molecule that can be detected, or that can generate a readout, such as fluorescence, radioactivity, color, chemiluminescence or other readouts known in the art or later developed. The readouts can be based on fluorescence, such as by fluorescent labels, such as but not limited to, Cy-3, Cy-5, phycoerythrin, phycocyanin, allophycocyanin, FITC, rhodamine, or lanthanides; and by flourescent proteins such as, but not limited to, green fluorescent protein (GFP). The readout can be based on enzymatic activity, such as, but not limited to, the activity of beta-galactosidase, beta-lactamase, horseradish peroxidase, alkaline phosphatase, or luciferase. The readout can be based on radioisotopes (such as ³³P, ³H, ¹⁴C, ³⁵S, ¹²⁵I, ³²P or ¹³¹I). A label optionally can be a base with modified mass, such as, for example, pyrimidines modified at the C5 position or purines modified at the N7 position. Mass modifying groups can be, for examples, halogen, ether or polyether, alkyl, ester or polyester, or of the general type XR, wherein X is a linking group and R is a mass-modifying group. One of skill in the art will recognize that there are numerous possibilities for mass-modifications useful in modifying nucleic acid molecules and oligonucleotides, including those described in Oligonucleotides and Analogues: A Practical Approach, Eckstein, ed. (1991) and in PCT/US94/00193.

A “signal producing system” may have one or more components, at least one component usually being a labeled binding member. The signal producing system includes all of the reagents required to produce or enhance a measurable signal including signal producing means capable of interacting with a label to produce a signal. The signal producing system provides a signal detectable by external means, often by measurement of a change in the wavelength of light absorption or emission. A signal producing system can include a chromophoric substrate and enzyme, where chromophoric substrates are enzymatically converted to dyes which absorb light in the ultraviolet or visible region, phosphors or fluorescers. However, a signal producing system can also provide a detectable signal that can be based on radioactivity or other detectable signals.

The signal producing system can include at least one catalyst, usually at least one enzyme, and can include at least one substrate, and may include two or more catalysts and a plurality of substrates, and may include a combination of enzymes, where the substrate of one enzyme is the product of the other enzyme. The operation of the signal producing system is to produce a product which provides a detectable signal at the predetermined site, related to the presence of label at the predetermined site.

In order to have a detectable signal, it may be desirable to provide means for amplifying the signal produced by the presence of the label at the predetermined site. Therefore, it will usually be preferable for the label to be a catalyst or luminescent compound or radioisotope, most preferably a catalyst. Preferably, catalysts are enzymes and coenzymes which can produce a multiplicity of signal generating molecules from a single label. An enzyme or coenzyme can be employed which provides the desired amplification by producing a product, which absorbs light, for example, a dye, or emits light upon irradiation, for example, a fluorescer. Alternatively, the catalytic reaction can lead to direct light emission, for example, chemiluminescence. A large number of enzymes and coenzymes for providing such products are indicated in U.S. Pat. No. 4,275,149 and U.S. Pat. No. 4,318,980, which disclosures are incorporated herein by reference. A wide variety of non-enzymatic catalysts which may be employed are found in U.S. Pat. No. 4,160,645, issued Jul. 10, 1979, the appropriate portions of which are incorporated herein by reference.

The product of the enzyme reaction will usually be a dye or fluorescer. A large number of illustrative fluorescers are indicated in U.S. Pat. No. 4,275,149, which disclosure is incorporated herein by reference.

Other technical terms used herein have their ordinary meaning in the art that they are used, as exemplified by a variety of technical dictionaries.

I. A System of Integrated Chips for the Processing and Analysis of a Sample

The present invention includes an integrated biochip system for the processing and analysis of a sample. By “integrated biochip system” is meant a system that: 1) comprises at least one chip, 2) is capable of performing at least two sequential tasks on a sample, wherein at least one task is a processing task. Preferably, at least one task performed by a system of integrated chips of the present invention requires the application of physical force by a source that is in part external to a chip and in part intrinsic to a chip, and preferably but optionally, at least one sample component is manipulated through the use of specific binding partners, such as microparticles, in a task performed on at least one chip of a system of the present invention.

The present invention includes at least one chip, where a chip has a surface on which at least one separation, translocation, capturing procedure, assay, or acoustic mixing or physical disruption process can be performed. A chip can comprise silicon, glass, rubber, photoresist, or one or more metals, ceramics, polymers, copolymers, or plastics. A chip can comprise one or more flexible materials. A chip can be from about 1 mm² to about 0.25 m². Preferably, the size of the chips useable in the present methods is from about 4 mm² to about 25 cm². The shape of the chips useable in the present methods can be regular shapes such as square, rectangular, circular, or oval, or can be irregularly shaped. The active surface of a chip need not be flat, but can be curved, angled, etc. Chips useable in the methods of the present invention can have one or more wells or one or more channels that can be etched or bored into a chip or built into or onto the surface of a chip.

A chip can be part of a chamber, can engage a chamber, or can be at least partially enclosed by a chamber, but this is not a requirement of the present invention. A chamber of the present invention is a structure that can contain a fluid sample. A chamber can be of any size or dimensions, and preferably can contain a fluid sample of between 0.001 microliter and 50 milliliters, more preferably between about 0.1 microliters and about 25 milliliters, and most preferably between about 1 microliter and about two milliliters. Preferably, a chamber comprises at least a portion of at least one chip. A chamber can comprise more than one chip, or several chambers may comprise, contact, or engage the same chip. A chamber can comprise any suitable material, for example, silicon, glass, metal, ceramics, polymers, plastics, etc. and can be of a rigid or flexible material. Preferred materials for a chamber include materials that do not interfere with the manipulation of moieties in a sample, for example, insulating materials that do not bind charged or polarized molecules, such as certain plastics and polymers, for example, acrylic, or glass.

A chamber that comprises at least a portion of a chip useable in the methods of the present invention can comprise one or more ports, or openings in the walls of a chamber. A port can be of any appropriate shape or size for the transport or dispensing of a sample, sample components, buffers, solutions, or reagents through the port. A port can be permanently open, or can comprise a flap or valve that allows the port to be reversibly closed. A port can optionally be an opening in a wall that is a common wall between two chambers. Alternatively, a port can provide an opening in a wall of a chamber for the dispensing of sample into the chamber by, for example, dispensing or injection.

A port can engage a conduit. A conduit can be any tube that allows for the entry of a fluid sample, solution, or reagent into the chamber, or allows for the translocation of sample component or microparticles from one chamber to another chamber. Preferred conduits for use in the present invention include tubing, for example, rubber or polymeric tubing, e.g., tygon or Teflonm (polytetrafluoroethylene) tubing. Conduits that engage one or more ports of a chamber can be used to introduce a sample, solution, reagent, or preparation by any means, including a pump (for example, a peristaltic pump or infusion pump), pressure source syringe, or gravity feed.

Preferred chips in a system of the present invention include active chips. Preferably, at least one chip in an integrated biochip system of the present invention is an active chip. Active chips are chips that comprise micro-scale structures that can generate a physical force when energy is supplied to them from, for example, a power supply. Thus, the applied physical forces used in the methods of the present invention require an energy source (sometimes called a “signal source”) and a structure capable of converting the energy to a type of force useful in the present invention. Active chips are therefore described as chips that supply at least in part, a source of a physical force used in the methods of the present invention. Micro-scale structures that can convert the applied energy to a type of force useful in the present invention can be, as nonlimiting examples, electrodes for generating electrophoretic and dielectrophoretic forces, electromagnetic units for generating electromagnetic or magnetophoretic or magnetic forces, and piezoelectric transducers for generating acoustic forces. Depending on the type of microscale structure they comprise, they can be referred to as, for example, electrophoresis or dielectrophoresis chips (comprising electrodes), electromagnetic chips (comprising electromagnetic units) or acoustic chips (comprising piezoelectric transducers). Chips can also comprise optical elements, micro-capillaries or tips, heating elements (e.g., metal wires), Peltier elements, micro-valves, or micro-pumps.

An active chip can be constructed by building physical force elements (e.g., electromagnetic units, piezoelectric transducers, or electrodes) onto or into the chip surface, or by applying functional layers such as, for example, oligonucleotide arrays or protein arrays onto the surface of the chip to make, for example, a passive chip. Other materials that can be provided on passive or active chips of the present invention include specific binding members, including, but not limited to avidin, streptavidin, or biotin, antibodies, and nucleic acid molecules; enzymes, catalysts, or substrates (including, but not limited to enzymes, catalysts, and substrates used for detection); reagents, including insulating layers, or coatings or layers of substances provided to prevent nonspecific binding or interaction of one or more sample components to a chip surface; complexes; and even viruses and cells. These materials can optionally be provided in wells or channels of a chip of a system of the present invention. Materials that can be used as coatings or layers to prevent nonspecific or undesirable interactions of one or more sample components with a chip surface (including micro-scale structures on the chip) can form a “top layer” of the chip, and can be thin (less than 100 Angstrom) layers of polymers, compounds such as silicon dioxide, surfactants, or biomolecules, such as BSA.

Examples of active chips include, but are not limited to, the dielectrophoresis electrode array on a glass substrate (e.g., Dielectrophoretic Manipulation of Particles by Wang et al., in IEEE Transaction on Industry Applications, Vol. 33, No. 3, May/June, 1997, pages 660-669”), the individually addressable electrode array on a microfabricated bioelectronic chip (e.g., Preparation and Hybridization Analysis of DNA/RNA from E. coli on Microfabricated Bioelectronic Chips by Cheng et al., Nature Biotechnology, Vol. 16, 1998, pages 541-546), the capillary electrophoresis chip (e.g., Combination of Sample-Preconcentration and Capillary Electrophoresis On-Chip by Lichtenberg, et al., in Micro Total Analysis Systems 2000 edited by A. van den Berg et al., pages 307-310), the acoustic force chips disclosed in U.S. Pat. No. 6,029,518, the electromagnetic chips disclosed in U.S. patent application Ser. No. 09/399,299 (attorney docket number ART-00104.P.1), filed Sep. 17, 1999, herein incorporated by reference, and U.S. application Ser. No. 09/685,410 (having attorney docket number ART-00104.P. 1.1), filed Oct. 10, 2000, entitled “Individually Addressable Micro-Electromagnetic Unit Array Chips in Horizontal Configurations”, also incorporated by reference.

For dielectrophoresis chips, including chips that are used for conventional and traveling wave dielectrophoresis, electrodes on a chip can be of any shape, such as rectangular, castellated, triangular, circular, and the like. Electrodes can be arranged in various patterns, for example, spiral, parallel, interdigitated, polynomial, etc. Electrode arrays can be fabricated on a chip by methods known in the art, for example, electroplating, sputtering, photolithography or etching. Examples of a chip comprising electrodes include, but are not limited to, the dielectrophoresis electrode array on a glass substrate (e.g., Dielectrophoretic Manipulation of Particles by Wang et al., in IEEE Transaction on Industry Applications, Vol. 33, No. 3, May/June, 1997, pages 660-669), individually addressable electrode array on a microfabricated bioelectronic chip (e.g., Preparation and Hybridization Analysis of DNA/RNA from E. coli on Microfabricated Bioelectronic Chips by Cheng et al., Nature Biotechnology, Vol. 16, 1998, pages 541-546), and the capillary electrophoresis chip (e.g., Combination of Sample-Preconcentration and Capillary Electrophoresis On-Chip by Lichtenberg, et al, in Micro Total Analysis Systems 2000 edited by A. van den Berg et al., pages 307-310).

Other preferred chips that find usefulness in the present invention are described in U.S. application Ser. No. 09/678,263 (attorney docket number ARTLNCO.002A), entitled “Apparatus for Switching and Manipulating Particles and Methods of Use Thereof” filed on Oct. 3, 2000 and U.S. application Ser. No. 09/679,024 (having attorney docket number 471842000400), entitled “Apparatuses Containing Multiple Active Force Generating Elements and Uses Thereof” filed Oct. 4, 2000, also herein incorporated by reference.

Single Chip Systems

In one aspect of the present invention, an integrated biochip system comprises a single chip. In this aspect, a single-chip integrated biochip system comprises an active chip that can perform at least two sequential tasks. Preferably, an active chip of a single-chip system comprises different functional elements to perform at least two sequential tasks.

A chip that performs more than one function can have combinations of one or more different functional elements such specific binding members, substrates, reagents, or different types of micro-scale structures, including micro-scale structures that provide, at least in part, one or more sources of physical forces used in processes or tasks carried out on the chip.

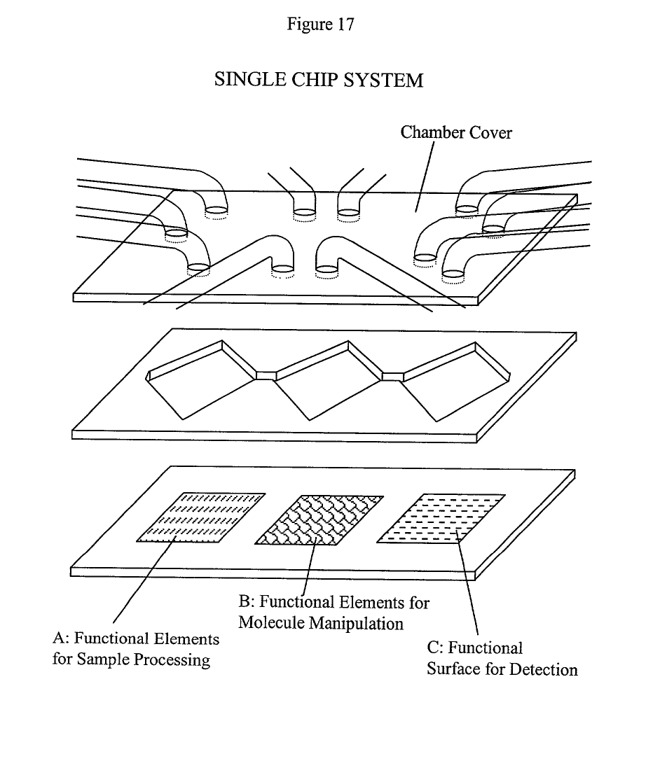

In embodiments where a system of the present invention comprises a chip that has different functional elements, the regions of the chip having different functional elements can be in close proximity, such that sample components are freely and readily diffusible among the different functional elements (see, for example, FIG. 17), and preferably but optionally, the different functional elements are at least partially interspersed with one another. Alternatively, in a multiple force chip, different functional elements, in particular different physical force-generating elements, can be provided in different structurally linked substrates that are vertically oriented with respect to one another. For examples of multiple force chips see U.S. application Ser. No. 09/679,024 (having attorney docket number 471842000400), entitled “Apparatuses Containing Multiple Active Force Generating Elements and Uses Thereof” filed Oct. 4, 2000, herein incorporated by reference.

It is also possible to have different functional elements on a chip of a system of the present invention that are not in immediate proximity. Preferably, such chips are multiple force chips that comprise functional elements that can generate physical forces that can be used to translocate sample components from one area of a chip to another area of a chip. Preferred physical force-generating elements of a chip for translocating sample components are electrodes and electromagnetic units. In preferred embodiments of the present invention, functional elements such as electrodes and electromagnetic units that are used in translocating a sample component from one area of a chip to another area of a chip are arranged such that they can generate traveling wave dielectrophoretic forces or traveling wave electromagnetic forces.

The order of sequential tasks performed on the same chip can be regulated by the selective activation of functional elements; by controlled translocation of sample components and binding partners, optionally but preferably including microparticles coupled to sample components; by the regulated addition of reagents, including, but not limited to, detergents, enzymes, and specific binding members; or combinations thereof.

Preferred chips and preferred active layers of chips of the present invention for translocating sample components from one functional area of a chip to another include those described in U.S. application Ser. No. 09/678,263 (having attorney docket number ARTLNCO.002A), entitled “Apparatus for Switching and Manipulating Particles and Methods of Use Thereof” filed on Oct. 3, 2000, herein incorporated by reference. Such particle switch chips and particle switch active layers of chips can be used for translocating sample components from one area of a chip to another area of a chip, where different areas of a chip can have different functional elements for performing different tasks. Particle switch chips and particle switch active layers of chips can also be used for translocating sample components from one chip of a system to another chip of a multiple chip system, where different chips of the system can have different functional elements for performing different tasks.

It is also possible to have one or more sources of a force used to translocate sample components or microparticles on or intrinsic to a chamber, such as a chamber that comprises a chip. For example, electrodes used as a source of an electric field used to translocate particles can be incorporated into a chamber wall, or extend from a chamber wall (including the top wall) in any direction. It is also possible to have one or more source elements that are external to a chip, or chamber of the present invention, but this is not preferred.

Multiple Chip Systems

In one aspect of the present invention, an integrated biochip system comprises multiple chips. In this aspect, a multiple chip integrated biochip system comprises at least one active chip and can perform at least two sequential tasks.

Where an integrated biochip system of the present invention comprises more than one chip, preferably at least one task in the processing of a sample can be performed on at least one chip of the present invention and at least one other task can be performed on at least one other chip of the present invention.

In these aspects, preferably at least two chips are, for at least a portion of the time that the system is operating, in fluid communication with one another. Fluid communication in this sense means that fluid can move from the surface of one chip to the surface of another chip, and in particular that sample components and microparticles, in soluble or suspended form in a fluid (that is, a liquid or a gas), can be translocated from the surface of one chip to the surface of another chip, by means other than collecting and dispensing a fluid from one chip to another chip such as by pipeting or withdrawing and injecting.

Chips that are in fluid communication with one another are preferably positionally and functionally ordered such that a “second” chip can receive from a “first” chip a sample, sample component, or sample product that is the product of a separation, translocation, capture, assay, mixing or disruption process performed on the “first” chip, and the “second” chip can perform a function that is a further step in the processing or analysis of the sample. (As used herein, “first” and “second” do not refer to their absolute order in the integrated system, but rather to their relative order, where a process performed on the second chip occurs immediately after a process performed on the first chip.) Thus, the first and second chips in the example are preferably positionally ordered such that a sample, sample component, or sample product (including, for example, a sample component coupled to microparticles) can be translocated from the first chip to the second chip. Preferably, in this example, the first and second chips are adjacent or in close proximity.

Preferably, the transport of sample components from one chip to another chip, or from one chamber to another chamber, does not require manual transfer, but is accomplished through fluid flow (using force generated by a pump, for example) or by using applied physical forces.

In a multiple chip system, forces used to translocate sample components or microparticles from one chip of the system to another chip of the system can have one or more sources that are built onto or into a chip. Thus, active chips of the multiple chip system can be used for transporting sample components by, for example, traveling-wave dielectrophoresis or traveling-wave magnetophoresis for one chip to another chip. The particle switch chip described in U.S. application Ser. No. 09/678,263 (having attorney docket number ARTLNCO.002A), entitled “Apparatus for Switching and Manipulating Particles and Methods of Use Thereof” filed on Oct. 3, 2000, herein incorporated by reference, can be used in this regard. Particle switch chips can also be used for translocating sample components from one area of a chip to another area of a chip in a multiple chip or single chip system, where different areas of a chip can have different functional elements for performing different tasks.

The multiple force chips described for the single-chip system and described in U.S. application Ser. No. 09/679,024 (having attorney docket number 471842000400), entitled “Apparatuses Containing Multiple Active Force Generating Elements and Uses Thereof” filed Oct. 4, 2000, herein incorporated by reference, can also find use in multiple chip systems of the present invention. For example, a multiple force chip can be used to separate components of a sample using dielectrophoretic and magnetic forces, and then the separated components can be directed to one or more other chips of the system for one or more analysis tasks.

A multiple chip system of the present invention can also optionally comprise one or more passive chips whose function does not require an applied physical force. Passive chips that are a part of a system of the present invention can be used for a variety of assays and detections, such as but not limited to binding assays, biochemical assays, cellular assays, genetic assays, sandwich hybridizations, etc.

Sequential Tasks in the Processing and Analysis of a Sample

An integrated biochip system of the present invention is capable of performing at least two sequential tasks in the processing and analysis of a sample. Sequential tasks are tasks that are performed in a particular order to achieve the desired final result. When two tasks are performed sequentially, a second task uses one or more direct or indirect products of the first task, where “product” can mean a sample component that was separated, at least partially purified, or concentrated in a first step, or a sample component that was the result of a denaturing or lysing step, was subjected to a biochemical reaction or assay, became bound to a reagent, etc., in a previous task. By “first” and “second” is meant the relative order and not the absolute order, of tasks performed in the integrated system.

At least one function that can be performed by a chip of the system of the present invention is a processing task, in which a processing task is any procedure that prepares a sample for analysis and can include as nonlimiting examples, a separation, translocation, focusing, capture, isolation, enrichment, concentration, enrichment, partial or substantial purification, structural alteration or physical disruption; and can include as part of the task chemical reactions, including enzymatic reactions and binding reactions, such as binding of sample components to microparticles.

Optionally, at least one other function performed by a chip of a system of the present invention can be an analysis task. An analysis task is any function that leads to a result of a processing and analysis procedure. Nonlimiting examples of analysis procedures are assays, such as biochemical, cellular, genetic, and detection assays. Detection assays can also include binding reactions and enzymatic reactions. In certain preferred embodiments in which a system comprises a single chip, at least one processing task and at least one analysis task can be performed on the single chip. In other preferred embodiments where an integrated biochip system of the present invention comprises more than one chip, preferably at least one processing task can be performed on at least one chip of the present invention and at least one analysis task can be performed on at least one other chip of the present invention, but this is not a requirement of the present invention.

Where an integrated biochip system of the present invention comprises more than one chip, preferably at least two chips are, for at least a portion of the time that the system is operating, in fluid communication with one another. Fluid communication in this sense means that fluid can move from the surface of one chip to the surface of another chip, and in particular that sample components and microparticles, in soluble or suspended form in a fluid (that is, a liquid or a gas), can be translocated from the surface of one chip to the surface of another chip, by means other that collecting and dispensing a fluid from one chip to another chip such as by pipetting or withdrawing and injecting.

Chips that are in fluid communication with one another are preferably positionally and functionally ordered such that a “second” chip can receive from a “first” chip a sample, sample component, or sample product that is the product of a separation, translocation, capture, assay, mixing or disruption process performed on the “first” chip, and the “second” chip can perform a function that is a further step in the processing or analysis of the sample. (As used herein, “first” and “second” do not refer to their absolute order in the integrated system, but rather to their relative order, where a process performed on the second chip occurs immediately after a process performed on the first chip.) Thus, the first and second chips in the example are preferably positionally ordered such that a sample, sample component, or sample product (including, for example, a sample component coupled to microparticles) can be translocated from the first chip to the second chip. Preferably, in this example, the first and second chips are adjacent or in close proximity.

The inventors contemplate that in preferred embodiments of the present invention, an integrated system of the present invention can perform at least two sequential tasks in the processing and analysis of a sample while the sample remains continuously within the integrated system. That is, a sample applied to the integrated biochip system can remain continuously within said integrated system from the beginning of the first of the sequential tasks until the end of the last of the sequential tasks performed by the integrated system.

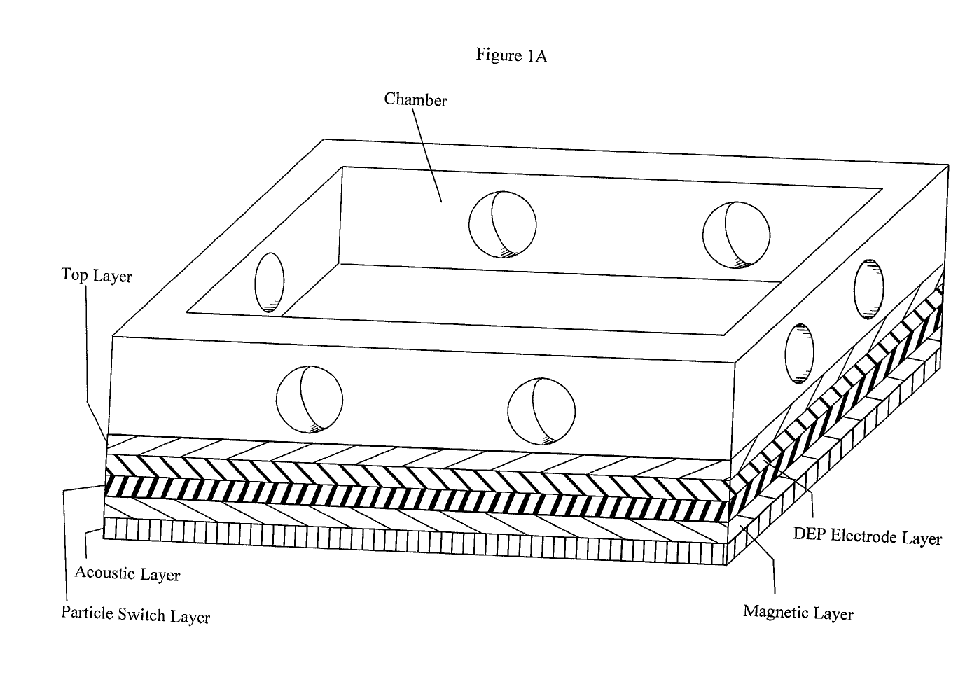

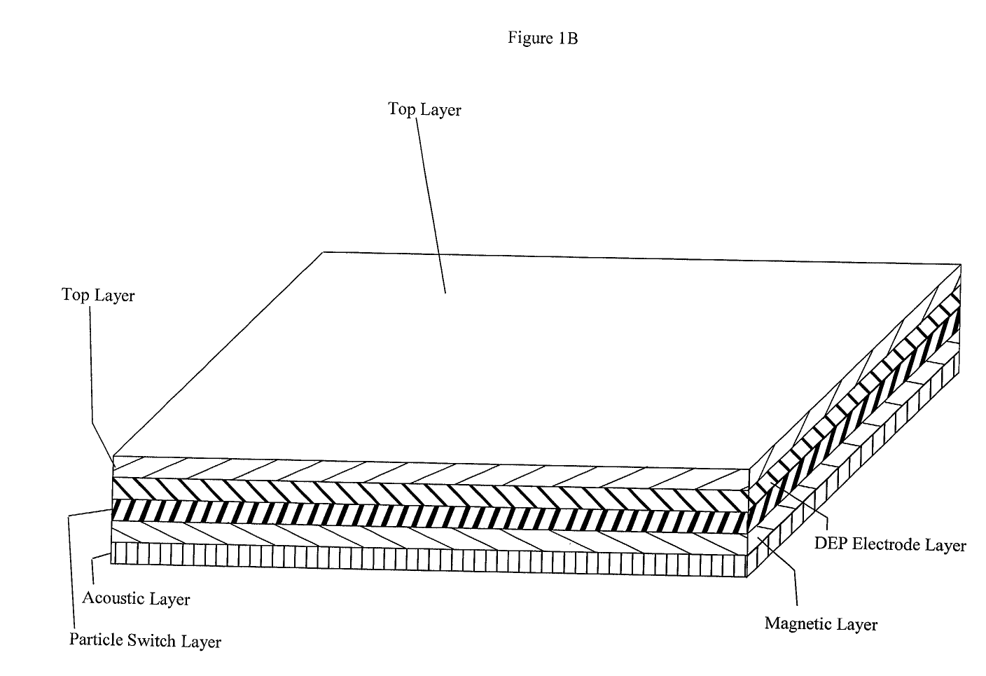

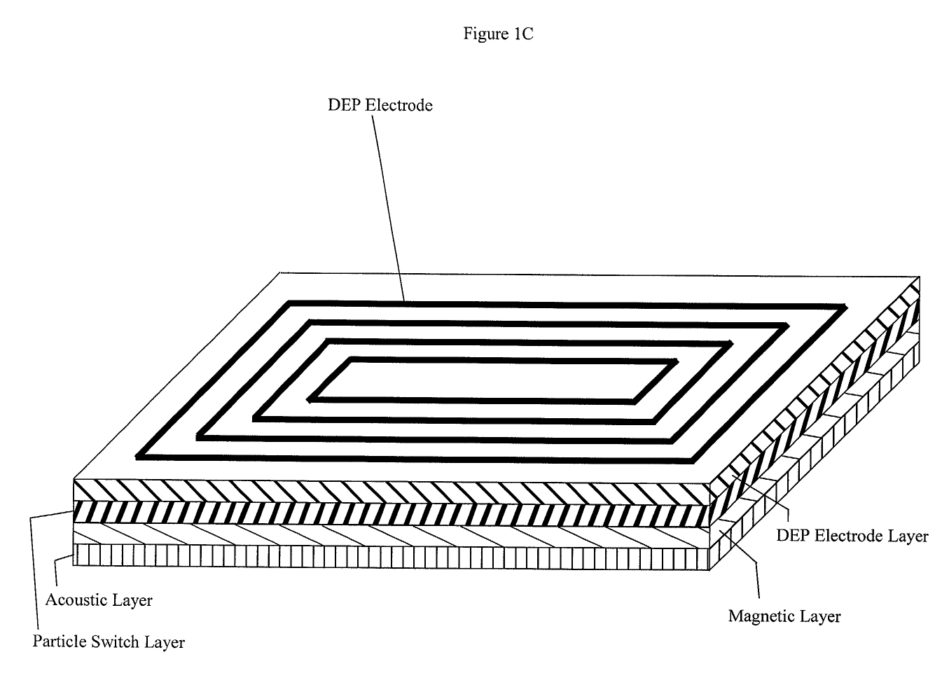

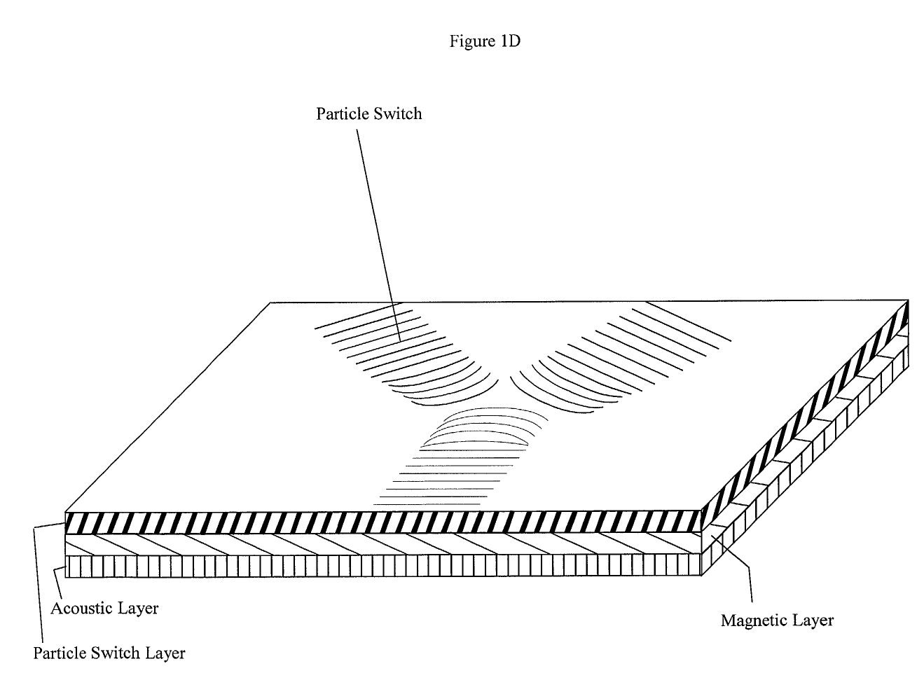

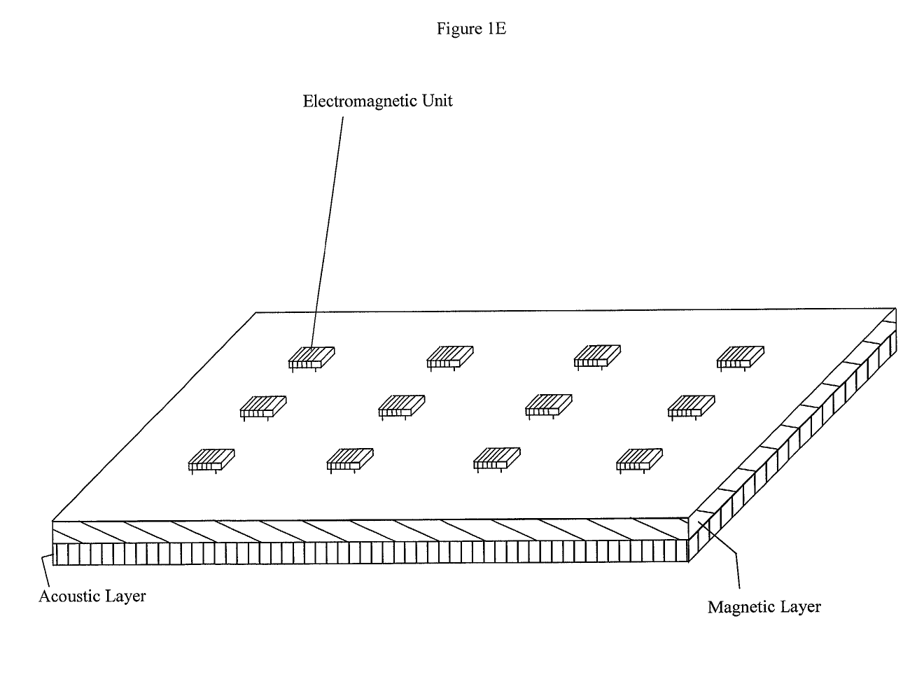

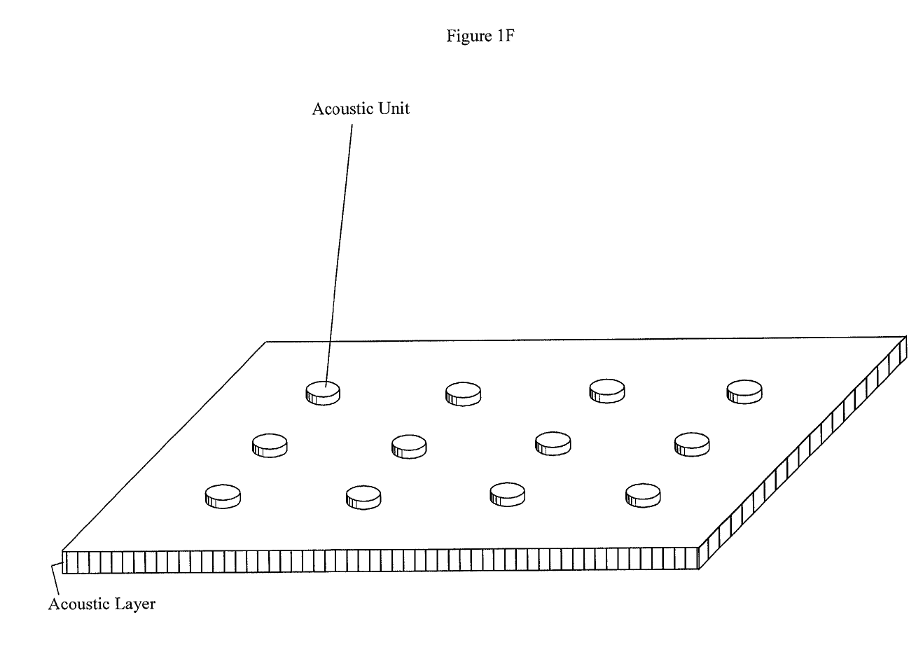

Preferably, the sample and sample components are moved within the system without manual transfer from one location to another within the system. Sample and sample components, as well as, optionally, solutions, buffers and reagents, can be moved within the integrated system using, for example, fluid flow generated by power-driven pumps (such as syringe pumps or peristaltic pumps). In preferred embodiments of the present example (some of which are illustrated in FIGS. 1-13), sample components are translocated from one area of a chip to another area of a chip, or from one chip or chamber to another chip or chamber, using applied physical forces.

In especially preferred embodiments, an integrated biochip system of the present invention is automated, such that the tasks are performed by the integrated system sequentially without manual intervention, such as, for example, transfer of sample or sample components from one chamber to another chamber. An automated system may, however, require manual application of the sample to the system (i.e., by pipeting or injecting), or manual recovery of sample components that have been fully processed by the system (i.e., by pipeting from a chamber, or collecting processed components in a tube that a conduit leads into). An automated system of the present invention may or may not require a practitioner to control power-driven systems for fluid flow, to control power-driven systems for generating physical forces for the performance of processing and analysis tasks, to control power-driven systems for generating physical forces for the translocation of sample components, and the like, during the operation of the integrated chip system. An automated integrated biochip system of the present invention, is preferably but optionally programmable.

II. Methods of Using a System of Integrated Chips for the Processing and Analysis of a Sample

A system of the present invention can be used to process and optionally analyze a sample. Processing a sample can involve: separating components of the sample, translocating components of a sample, capturing components of a sample, isolating components of a sample, focusing components of a sample, at least partially purifying components of a sample, concentrating components of a sample, enriching components of a sample, disrupting components of the sample, disrupting components of the sample, with or without added solutions, reagents, or preparations. Analyzing a sample can involve: detecting components of a sample, quantitating components of a sample, or measuring the activity of components of a sample (where activities can be, for example, regulatory, catalytic or binding activities, or activities whose mechanisms are known or unknown, such as cytotoxic activities, mitogenic activities, transcription-stimulating activities, etc.).

The method includes: application of a sample to a system of integrated chips of the present invention; and performing at least two sequential tasks in the integrated system, in which at least one of the sequential tasks is a processing task. A processing task can include: separating components of the sample, translocating components of a sample, capturing components of a sample, isolating components of a sample, focusing components of a sample, at least partially purifying components of a sample, concentrating components of a sample, enriching components of a sample, disrupting components of the sample, disrupting components of the sample, with or without added solutions, reagents, or preparations. Specific nonlimiting examples of processing tasks are: separating white blood cells from a blood sample or a buffy coat preparation of a blood sample, separating fetal cells from a maternal blood sample or a maternal amniotic fluid sample, separating malignant cells from a blood sample, separating a stem cell from a bone marrow sample, lysing white blood cells (that have been separated from a blood sample), concentrating bacterial cells from a urine sample, and separating mRNA molecules from a lysate of target cells.

The method can also include the translocation of sample components from one area of a chip to another area of a chip, wherein at least two different tasks are performed in the different areas of the chip, or translocation of sample components from chip to another chip, wherein at least two different tasks are performed on the different chips.

Application of Sample

A sample can be any fluid sample, such as an environmental sample, including air samples, water samples, food samples, and biological samples, including extracts of biological samples. A sample can optionally be at least partially processed. For example, a sample can be a centrifuged sample, or a sample to which a detergent has been added. A sample may have been heated or chilled before being used in the methods of the present invention. A sample can also have reagents added to it, such as, but not limited to stabilizers, including chelators, reducing agents, surfactants, anti-coagulants, glycerol, DMSO, and the like. A sample can be a sample that has been stored, including samples that have been stored at low temperature, including samples that have been frozen. Biological samples can be blood, serum, saliva, urine, semen, occular fluid, pleural fluid, cerebrospinal fluid, amniotic fluid, ascites fluid, extracts of nasal swabs, throat swabs, or genital swabs or extracts of fecal material. Biological samples can also be samples of organs, tissues, or cell cultures, including both primary cultures and cell lines. A preferred sample is a blood sample.

A blood sample can be any blood sample, recently taken from a subject, taken from storage, or removed from a source external to a subject, such as clothing, upholstery, tools, etc. A blood sample can therefore be an extract obtained, for example, by soaking an article containing blood in a buffer or solution. A blood sample can be unprocessed, processed, or partially processed, for example, a blood sample that has been centrifuged to remove serum, dialyzed, subjected to flow cytometry, had reagents added to it, etc. A blood sample can be of any volume. For example, a blood sample can be less than 0.05 microliters, or more than 5 milliliters, depending on the application.

A sample can be applied to an integrated chip system by any appropriate means, for example, by dispensing the sample onto a chip or into a chamber of a system by pipeting or injection. The application of sample can optionally be through a conduit that engages a port of a chamber that comprises a chip of a system of the present invention and can optionally use a pump, such as an injection pump or peristaltic pump, or gravity feed.

One or more reagents, compounds, buffers, or solutions can be added to a sample before adding the sample to an integrated chip system of the present invention. Mixing of compounds or solutions with a sample can optionally occur in one or more conduits leading to an integrated chip system, or in one or more reservoirs connected to conduits. Sample solutions that may be useful in particular aspects of the present invention include solutions that can modify the dielectric properties of at least one component of a sample, and solutions that preferentially lyse red blood cells. Such solutions are disclosed in U.S. patent application Ser. No. 09/686,737 (attorney docket number ART-00102.P.1), filed Oct. 10, 2000, entitled “Compositions and Methods for Separation of Moieties on Chips”, herein incorporated by reference. One or more solutions, buffers, reagents, compounds, or preparations, including preparations of microparticles, can also be added to a chamber or chip of a system of the present invention at any point during the processing and analysis of a sample on a chip. Such solutions, buffers, reagents, compounds, and preparations can be added to a chamber or chip by any means, such as but not limited to dispensing, fluid flow, or translocation using physical forces, including, for example, dielectrophoretic and electromagnetic forces for the movement of particles.

Solutions that can find use in the present invention and their methods of use include those disclosed in U.S. patent application Ser. No. 09/686,737 (attorney docket number ART-00102.P.1), entitled “Compositions and Methods for Separation of Moieties on Chips”, incorporated by reference in its entirety.

Two or More Sequential Tasks

Preferably, at least one processing task, including, but not limited to a separation, translocation, capture, isolation, purification, enrichment, focusing, structural alteration, or disruption procedure that takes place on a chip of the system of the present invention is through the application of physical forces. Application of physical forces to effect a processing task is preferably by means that are in part intrinsic to chips of the system of the present invention and in part external to chips of the present invention. The exact mechanism of the application of forces depends on the forces employed. For example, acoustic, optical, electromagnetic, dielectrophoretic, and electrophoretic forces can be generated by applying electric signals using a power supply connected to piezoelectric transducers, optical units, Peltier elements, metal wires, microcapillaries, micro-tips, micro-valves, micro-pumps, electromagnetic units or electrodes that are built onto or into a chip. The physical forces that can be used in the invention are described in the following applications: U.S. patent application Ser. No. 09/636,104 filed Aug. 10, 2000, entitled “Methods for Manipulating Moieties in Microfluidic Systems”; U.S. application Ser. No. 09/678,263 attorney docket number ARTLNCO.002A), entitled “Apparatus for Switching and Manipulating Particles and Methods of Use Thereof” filed on Oct. 3, 2000; U.S. application Ser. No. 09/679,024 (attorney docket number 471842000400), entitled “Apparatuses Containing Multiple Active Force Generating Elements and Uses Thereof” filed Oct. 4, 2000, U.S. patent application Ser. No. 09/399,299 (attorney docket number ART-00104.P.1), filed Sep. 17, 1999, entitled, “Individually Addressable Micro-Electromagnetic Unit Array Chips”; and U.S. application Ser. No. 09/685.410 (attorney docket number ART-00104.P.1.1), filed Oct. 10, 2000, entitled “Individually Addressable Micro-Electromagnetic Unit Array Chips in Horizontal Configurations”, all of which are incorporated by reference in their entireties.

A chip capable of producing acoustic forces and conventional dielectrophoretic forces may be used to exert these two types of forces simultaneously on moieties such as cells, or microparticles on the same chip surface. Alternatively, two different types of physical force can perform sequential tasks, and the tasks can take place on the same or different chips. The physical forces can be exerted on a plurality of moieties sequentially or simultaneously. For example, a chip of a system of the present invention capable of producing acoustic forces and conventional dielectrophoretic forces may be used to exert these two types of forces simultaneously on two types of moieties such as cells and microbeads. Thus, both types of moieties experience acoustic forces and conventional dielectrophoretic forces. In another example, a system capable of producing magnetic forces and traveling wave dielectrophoretic forces may be used to exert these two types of forces simultaneously, and on two types of moieties such as magnetic beads and certain types of biological cells, respectively. These functions can occur on the same chip of the system or in parallel on separate chips of the system. Thus, magnetic forces are exerted only on magnetic microbeads and traveling wave dielectrophoretic forces may be exerted only on biological cells. In still another example, a system can produce magnetic forces and traveling wave dielectrophoretic forces sequentially on different chips. First, the magnetic force generating elements are turned on so that magnetic microbeads bound to a particular sample moiety experience magnetic forces for a specified length of time and are captured on one chip. The non-captured sample components are transferred to a second chip, where traveling wave dielectrophoretic force generating elements are turned on so that biological cells that are sample components experience traveling-wave dielectrophoretic forces.

Of particular relevance to the methods of the present invention is the ability to control the application of physical forces using one or more external energy or signal sources that preferably are connected to micro-structures on a chip of a system of the present invention that generate the physical force on the chip. For example, one or more electrical signal sources can produce one or more electric signals in a particular sequence to apply current to a set of electromagnetic units, to apply an electric field generated by an electrode array, etc. These different functional units can be on the same or different chips. Alternatively, more than one type of functional element can be turned on at the same time, such as, for example, piezoelectric transducers for producing acoustic forces and electrodes for producing conventional dielectrophoretic forces, where the two types of functional elements are interspersed or overlapped on the same chip and can provide, for example, simultaneous mixing and separation. It is also possible to sequentially apply a power signal to subsets of functional elements on the same chip as for example, in traveling wave magnetophoresis, or to apply electrical signals of different phases to different subsets of electrodes, as for example, in traveling wave dielectrophoresis. Preferably, the application of physical fields through one or more power or signal sources is controlled by a power supply control system or signal generator control system that has an automatable and programmable switch mechanism. Preferably, a power supply control system or signal generating control system also allows the operator to regulate and modulate parameters of the output power or the generated signals . Where electric fields are used, these parameters can include the signal frequency, signal phase, signal amplitude, and signal modulation mode.

At least one of the procedures in the present system can be a processing task or an analysis task that is performed on a sample by manipulating sample components in a chip format. Moieties to be manipulated can be cells, cellular organelles, viruses, molecules or an aggregate or complex thereof. Moieties to be manipulated can be pure substances or can exist in a mixture of substances wherein the target moiety is only one of the substances in the mixture. For example, cancer cells in the blood from leukemia patients and metastatic cells in the blood patients with solid tumors can be the moieties to be manipulated. Similarly, various blood cells such as red and white blood cells in the blood can be the moieties to be manipulated.

Non-limiting examples of manipulatable cells include animal, plant, fungi, bacteria, recombinant or cultured cells. For animal cells, cells derived from a particular tissue or organ can be manipulated. Preferably, cells derived from an internal animal organ such as brain, lung, liver, spleen, bone marrow, thymus, heart, lymph, blood, bone, cartilage, pancreas, kidney, gall bladder, stomach, intestine, testis, ovary, uterus, rectum, nervous system, gland, internal blood vessels, etc. can be manipulated. Further, cells derived from any plants, fungi such as yeasts, bacteria such as eubacteria or archaebacteria can be manipulated. Recombinant cells derived from any eucaryotic or prokaryotic sources such as animal, plant, fungus or bacterium cells can also be manipulated. Body fluid such as blood, urine, saliva, bone marrow, sperm or other ascitic fluids, and subfractions thereof, e.g., serum or plasma, can also be manipulated.

Manipulatable cellular organelles include nucleus, mitochondria, chloroplasts, ribosomes, ERs, Golgi apparatuses, lysosomes, proteasomes, secretory vesicles, vacuoles or microsomes. Manipulatable viruses, whether intact viruses or any viral structures, e.g., viral particles, in the virus life cycle can be derived from viruses such as Class I viruses, Class II viruses, Class III viruses, Class IV viruses, Class V viruses or Class VI viruses.

Manipulatable intracellular moieties include any moiety that resides or is otherwise located within a cell, i.e., located in the cytoplasm or matrix of cellular organelle; attached to any intracellular membrane; resides or is otherwise located within periplasma, if there is one; or resides or is otherwise located on cell surface, i.e., attached on the outer surface of cytoplasm membrane or cell wall, if there is one. Any desired intracellular moiety can be isolated from the target cell(s). For example, cellular organelles, molecules or an aggregate or complex thereof can be isolated. Non-limiting examples of such cellular organelles include nucleus, mitochondria, chloroplasts, ribosomes, ERs, Golgi apparatuses, lysosomes, proteasomes, secretory vesicles, vacuoles or microsomes, membrane receptors, antigens, enzymes and proteins in cytoplasm.

Manipulatable molecules can be inorganic molecules such as ions, organic molecules or a complex thereof. Non-limiting examples of manipulatable ions include sodium, potassium, magnesium, calcium, chlorine, iron, copper, zinc, manganese, cobalt, iodine, molybdenum, vanadium, nickel, chromium, fluorine, silicon, tin, boron or arsenic ions. Non-limiting examples of manipulatable organic molecules include amino acids, peptides, proteins, nucleosides, nucleotides, oligonucleotides, nucleic acids, vitamins, monosaccharides, oligosaccharides, carbohydrates, lipids or a complex thereof.

For any moieties that cannot be directly manipulated with the desired physical forces, binding partners that themselves can be directly manipulated with the desired physical forces can be coupled to the moieties and the manipulation of such moieties can be effected through the manipulation of coupled binding partner-moiety complexes. Any binding partners that both bind to the moieties with desired affinity or specificity and are manipulatable with the compatible physical force(s) can be used in the present methods. The binding partners can be cells such as animal, plant, fungus or bacterium cells, cellular organelles such as nucleus, mitochondria, chloroplasts, ribosomes, ERs, Golgi apparatuses, lysosomes, proteasomes, secretory vesicles, vacuoles or microsomes; viruses, microparticles, or an aggregate or complex thereof. Cells, cellular organelles and viruses can also be used as binding partners.

Preferred binding partners are microparticles. The microparticles used in the methods have a dimension from about 0.01 micron to about ten centimeters. Preferably, the microparticles used in the present method have a dimension from about 0.01 micron to about several thousand microns. Also preferably, the microparticles used are plastic particles, polystyrene microbeads, glass beads, magnetic beads or hollow glass spheres, particles of complex compositions, microfabricated free-standing microstructures.

In preferred embodiments of the present invention, at least one sample component to be manipulated in a processing or analysis task can be coupled to the surface of the binding partner, such as a microparticle, with any methods known in the art. For example, the moiety can be coupled to the surface of the binding partner directly or via a linker, preferably, a cleavable linker. The moiety can also be coupled to the surface of the binding partner via a covalent or a non-covalent linkage. Additionally, the moiety can be coupled to the surface of the binding partner via a specific or a non-specific binding. Preferably, the linkage between the moiety and the surface of the binding partner is a cleavable linkage, e.g., a linkage that is cleavable by a chemical, physical or an enzymatic treatment. Also preferably, the methods for coupling and/or decoupling the moieties to their binding partners disclosed in the co-pending U.S. Application entitled “Methods for Manipulating Moieties in Microfluidic Systems” (U.S. application Ser. No. 09/636,104; attorney docket number 47184-2000100), filed on Aug. 10, 2000 and incorporated by reference in its entirety, can be used. Preferably, the moiety to be manipulated is substantially coupled onto surface of the binding partner.

Preferably, the methods for manipulating the moieties through the use of binding partners disclosed in the co-pending U.S. application Ser. No. 09/636,104 entitled “Methods for Manipulating Moieties in Microfluidic Systems” (attorney docket number 47184-2000100), filed on Aug. 10, 2000 can be used for manipulating moieties that cannot be directly manipulated with the desired physical forces.

The moiety can be manipulated in a liquid, or gaseous state/medium, or a combination thereof. Preferably, the moiety is manipulated in a liquid medium. The liquid medium can be a suspension, a solution or a combination thereof.

The present method can be used to manipulate a single moiety at a time, and can also be used to manipulate a plurality of moieties simultaneously. In some cases, the moiety to be manipulated can be contained in a mixture and the moiety is selectively manipulated. Selective manipulation refers to the manipulation process that the moiety that is being manipulated is selectively processed, and/or is separated from the mixture, and/or is caused to experience different manipulation forces or manipulation procedures from other moieties or other particles or other molecules in the mixture. In other cases, the moiety to be manipulated constitutes a mixture and the entire mixture is manipulated. The moieties to be manipulated include the ones that can be manipulated directly by various physical forces and the ones that cannot be manipulated directly by various physical forces and have to be manipulated through the manipulation of the binding partner-moiety complex. In specific embodiments, moieties to be manipulated are cells, cellular organelles, viruses, molecules or an aggregate or complex thereof.

The present methods can use any type of manipulations. Non-limiting examples of the manipulations include transportation, focusing, capture, enrichment, concentration, aggregation, trapping, repulsion, levitation, separation, fractionation, isolation or linear or other directed motion of the moieties.

Preferably, in the method of the present invention the first task performed on a chip is a separation, translocation, capture, mixing, or disruption procedure that functions in the processing of a sample, but that is not a requirement of the present invention. Thus, in nonlimiting examples of the processing procedures that can be used on a sample comprising cells, cells of interest can be separated from other cells, for example, by conventional dielectrophoresis, or can be translocated from cellular debris of lysed cells of other types, for example, by traveling wave dielectrophoresis, or can be captured, for example, by binding to electromagnetic units (where a preparation of magnetic microparticles has been added to the sample), or can be mixed, for example, with specific binding members, using, for example, acoustic elements, or can be disrupted, for example, by electronic lysis. In certain preferred embodiments of the present invention, at least two sequential analysis tasks can be performed on different types of sample components, for example, a first separation task can be performed on cells, and a second separation task can be performed on proteins, or a first separation task can be performed on proteins, and a second separation task can be performed on RNA molecules.

Analysis Task

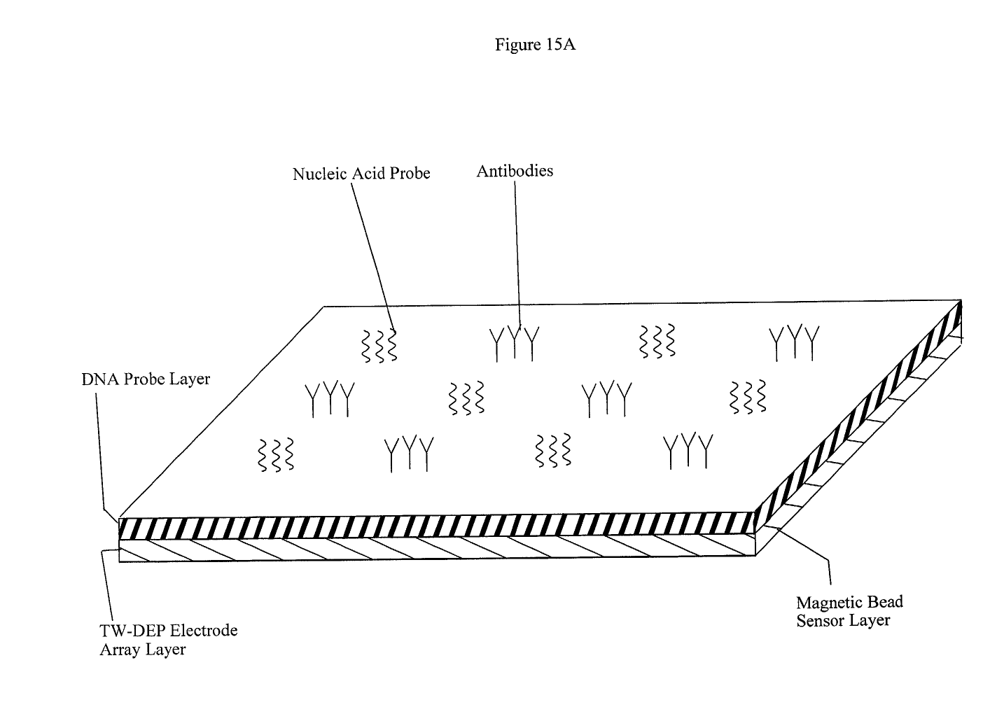

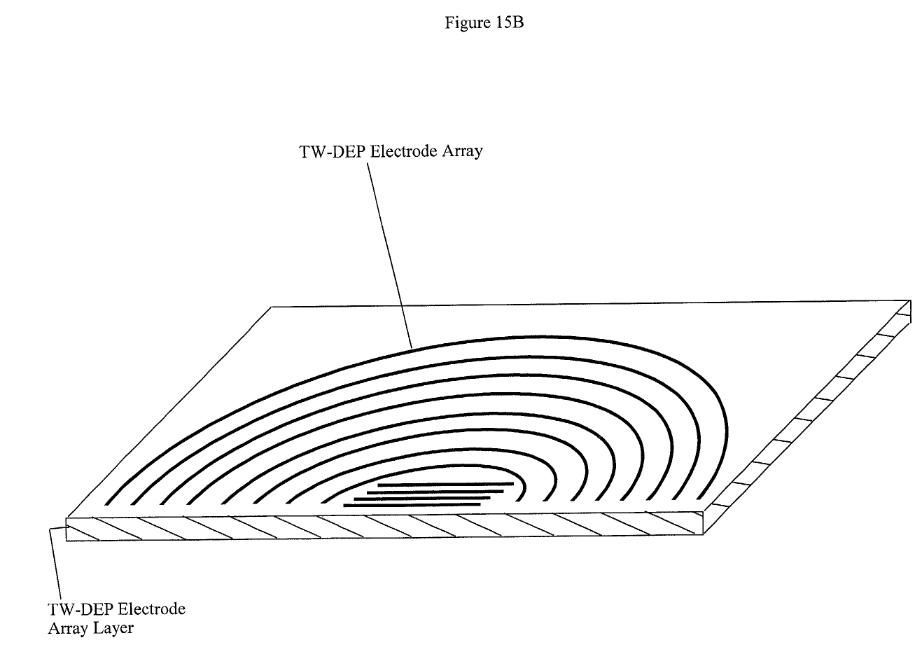

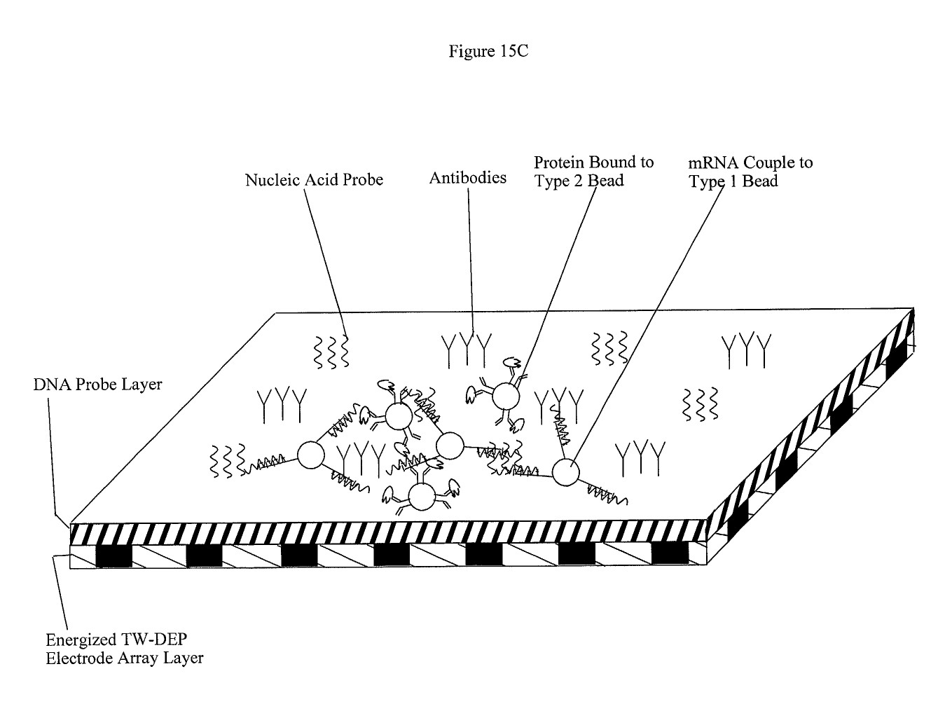

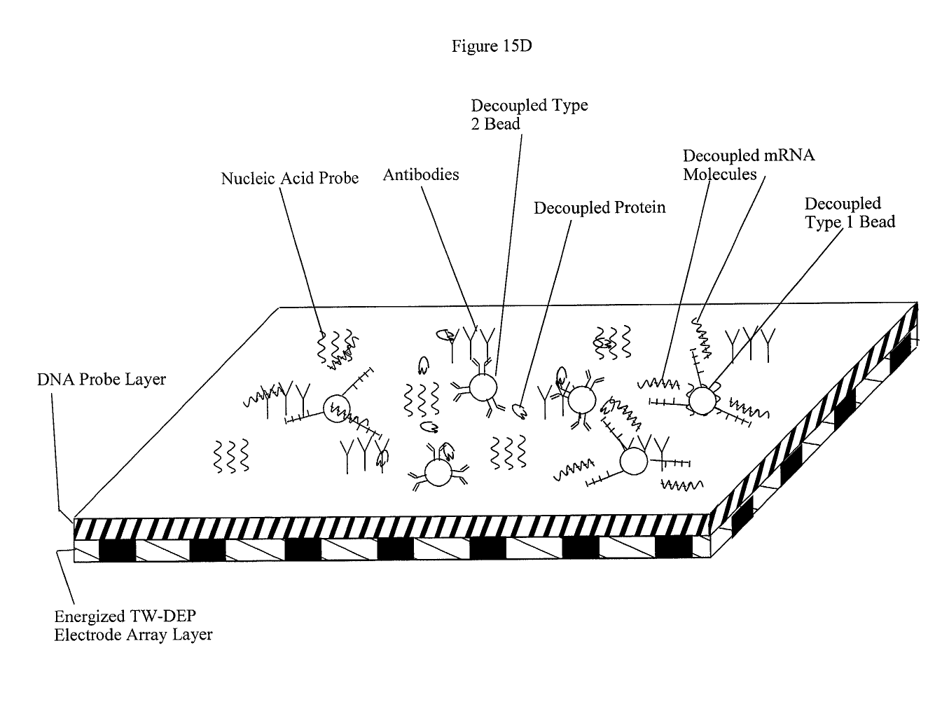

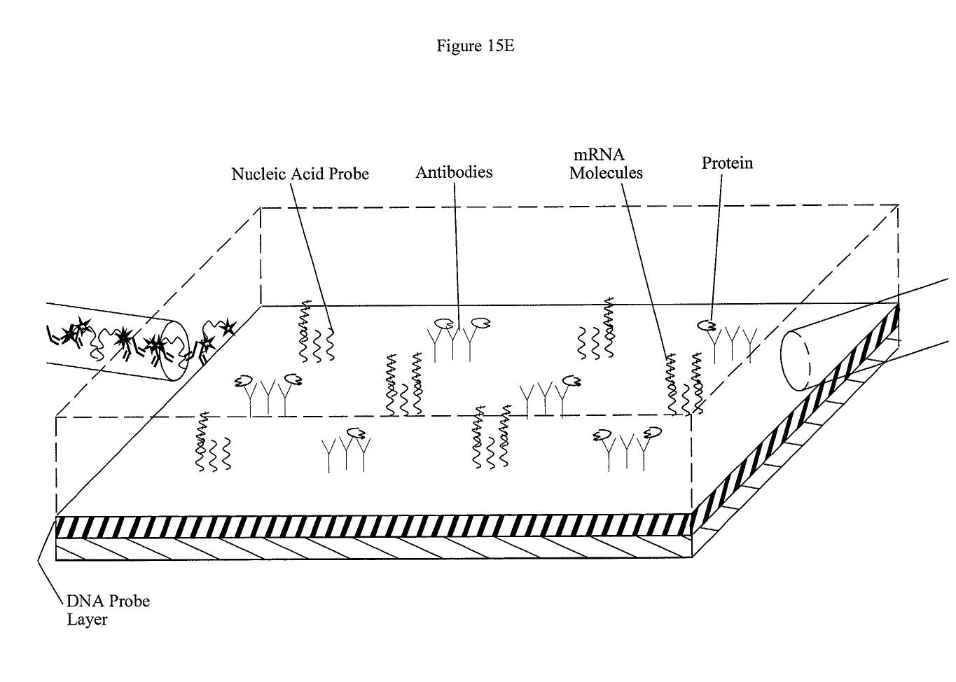

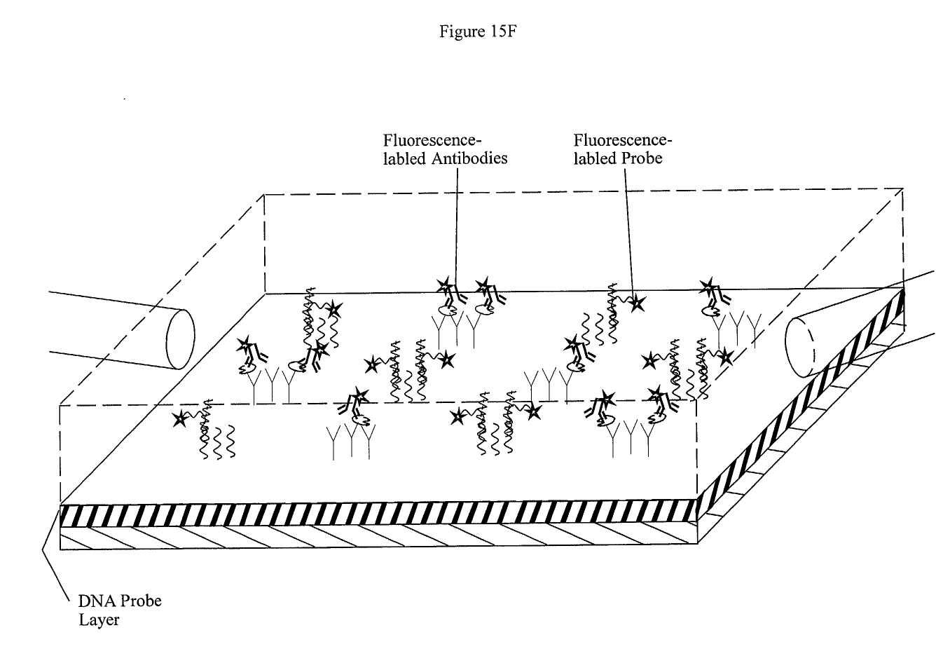

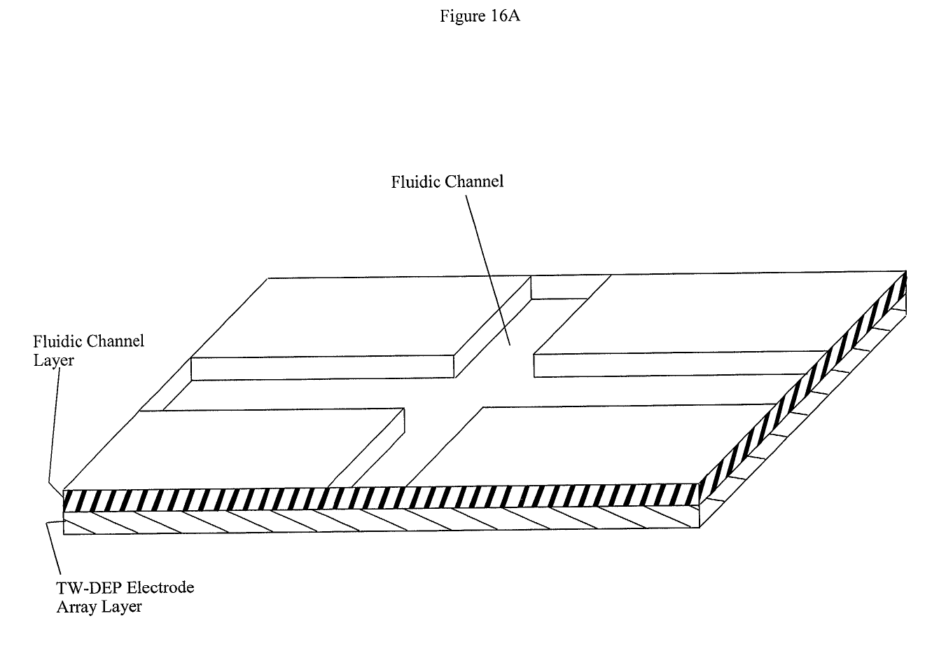

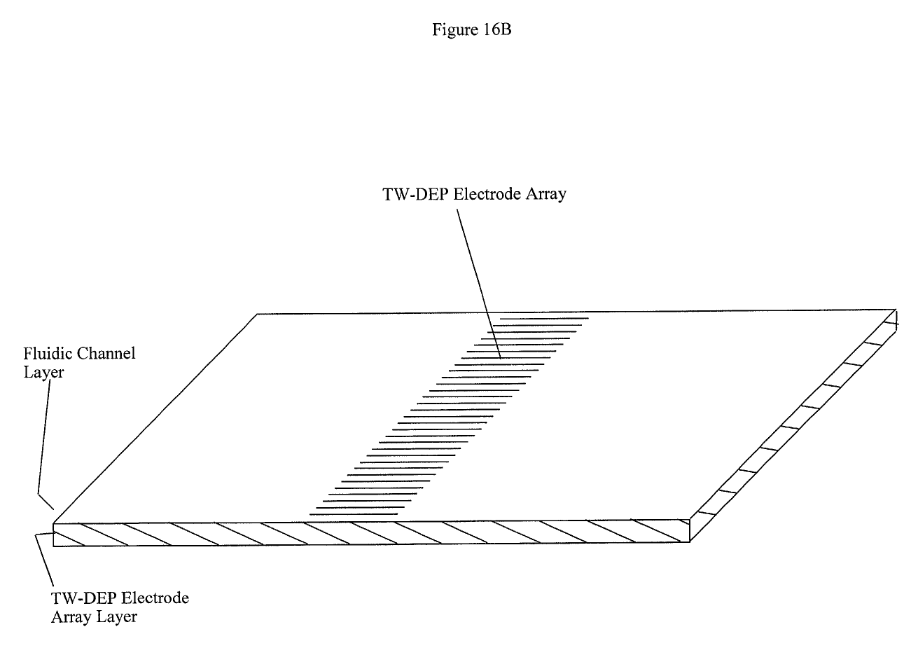

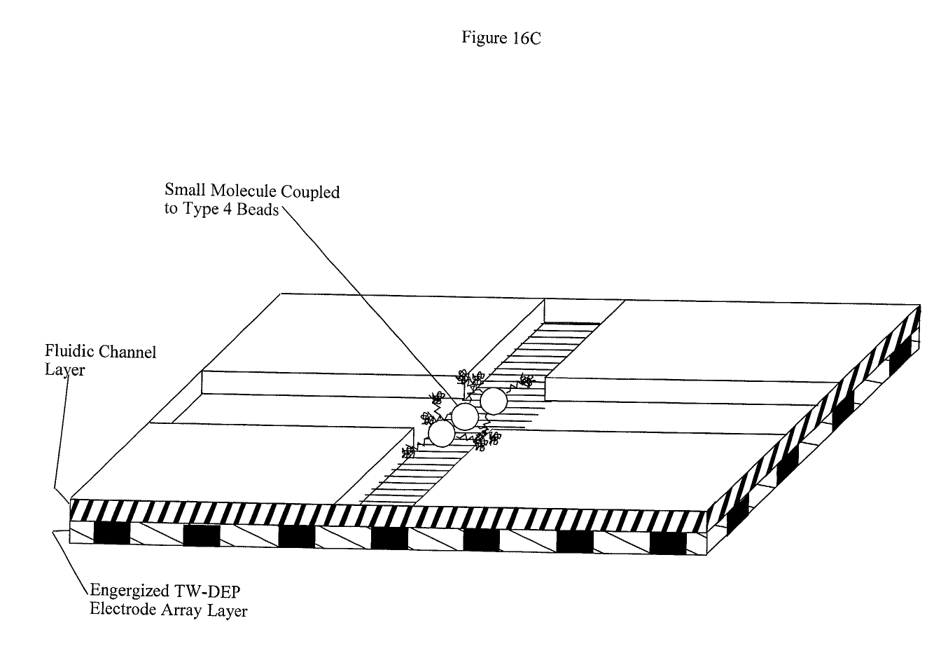

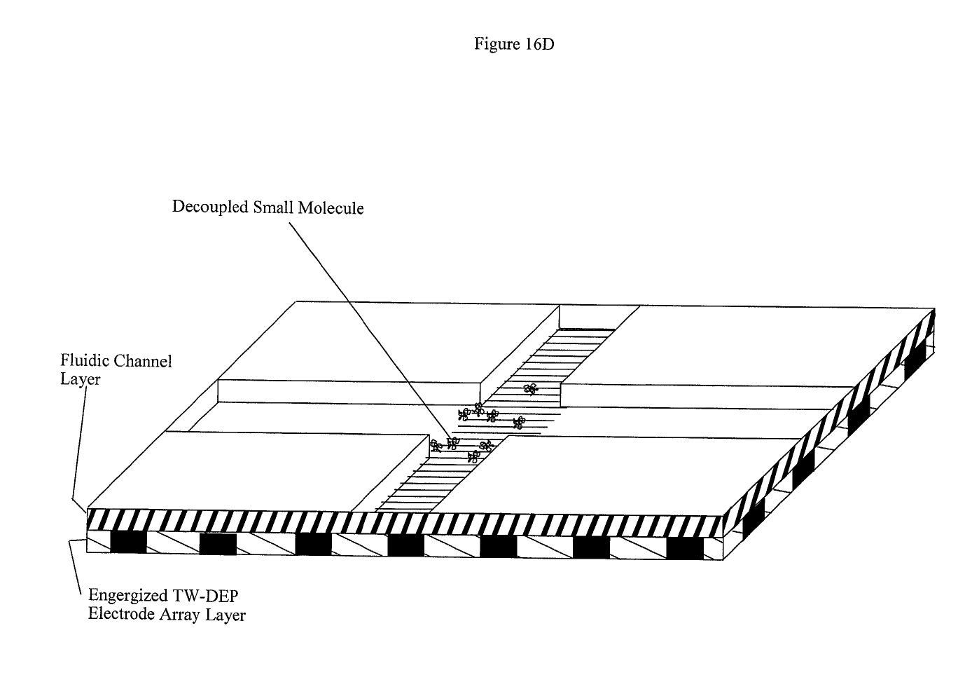

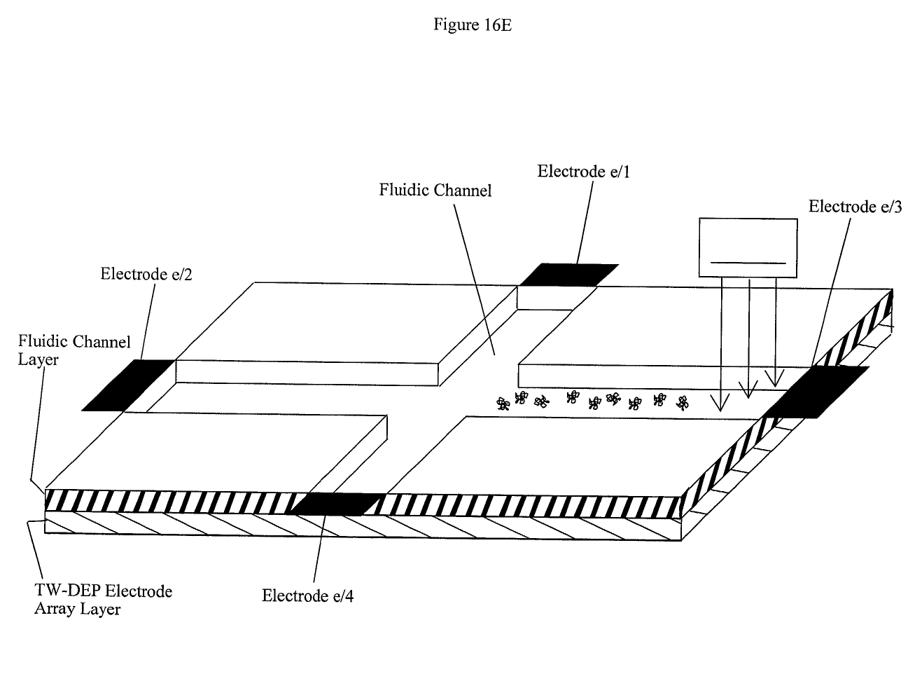

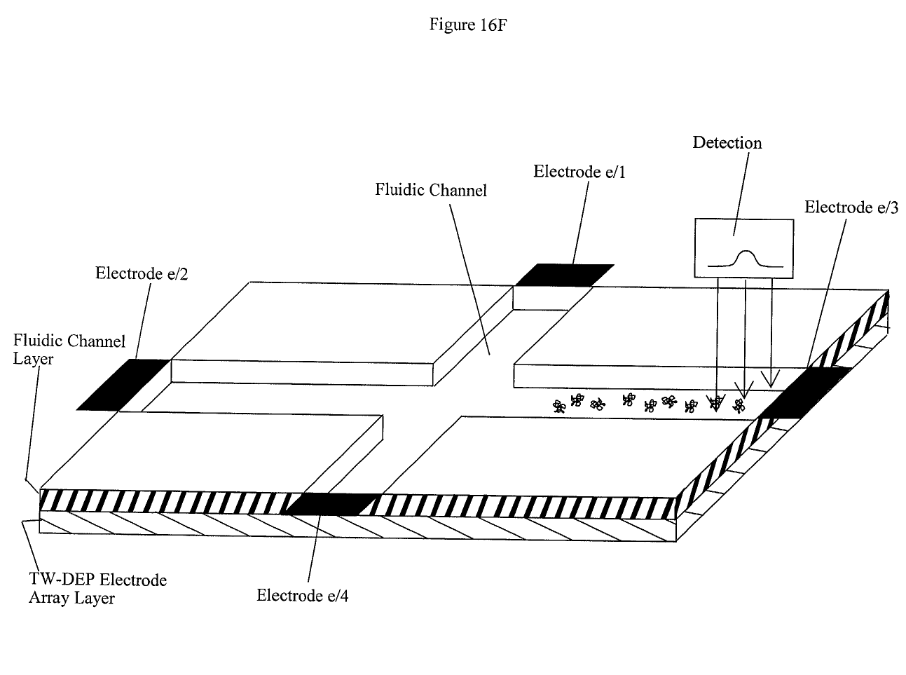

Preferably but optionally, in a system of the present invention, at least one analysis task of a sample of the present invention occurs after at least one processing task. Analysis tasks performed on chips of a system of the present invention can use mixing or binding steps, and preferably include detection assays, biochemical assays, cellular assays, binding assays or genetic assays. One or more analysis tasks can be performed sequentially of in parallel using the methods of the present invention. For example, a detection assay for protein and a detection assay for RNA molecules can be performed simultaneously, and in some aspects on the same chip (see, for example, FIG. 15E).

An analysis task can optionally include an assay, including, without limitation biochemical, cellular, genetic, and detection assays, and can include a mixing procedure or a reaction, such as a binding, chemical, or enzymatic reaction.

In some embodiments of the present invention, a method of using a system of integrated chips includes the use of detection assay on at least one chip of the system. Preferred detection methods include binding of a sample component to a specific binding member, such as for example, an antibody or nucleic acid molecule that is attached to the surface of a chip. In some preferred aspects of these detection methods the sample component to be detected has been manipulated by physical forces when coupled to a microparticle, and prior to the detection step, the sample component to be detected is decoupled from the binding partner. Reversible linkers for coupling moieties to microparticles are disclosed in U.S. patent application Ser. No. 09/636,104 (attorney docket number 47184-2000100) filed Aug. 10, 2000, entitled “Methods for Manipulating Moieties in Microfluidic Systems”, incorporated by reference. The sample component bound to specific binding partners attached to the surface of a chip can be detected in several ways. The component can be labeled prior to binding the specific binding member with a detectable label. Alternatively, a sandwich hybridization can be performed, in which a third molecule (typically an antibody or oligonucleotide) that is detectably labeled is bound to the bound sample component. Other methods of detection can be envisioned, such as enzymatic reactions that add detectable labels to bound sample components (e.g., “fill-in” polymerase reactions on bound nucleic acid molecules). See, for example U.S. patent application Ser. No. 09/648,081 (attorney docket number ART-00101.P.1) entitled “Methods and Compositions for Identifying Nucleic Acid Molecules Using Nucleolytic Activities and Hybridization”, filed on Aug. 25, 2000, herein incorporated by reference. Preferably, detectable labels used in these detection methods are fluorescent, or spectrophotometrically detectable. In such cases a chamber that encloses a detection chip has a transparent cover, such as a glass cover, to permit detection.

Other mechanisms of detection are also contemplated. For example, moieties bound to magnetic beads can bind specific binding members attached to the surface of a chip that are in proximity to magnetic heads on the chip that are connected to detectors that produce signals generated by the presence of magnetic particles. In another example, the moieties bound to microparticles can bind specific binding members that are linked to weight sensing systems, such as cantilevers. The weight of a particle can be sensed by the cantilever and a signal can be transmitted to a display or recording device.

It is also possible to detect fluorescence emitted by labeled moieties translocated through an aperture, such as the port of a chip. Moieties can be directed through a port by, for example, fluid flow.

Translocation of Sample Components from at least one Chip of the System to at least one Other Chip of the System

Sample components, including sample components coupled to specific binding partners such as microparticles, can be translocated from one chip of the system to another chip of the system by any means, including fluid flow (including mass flow through the application of mechanical force, such as by a syringe pump or peristaltic pump, or convection forces), but preferably translocation of sample components (including sample components bound to microparticles) from at least one of the chips of a system of the present invention to at least one other chip of the system is by application of physical forces such as, but not limited to, electrophoretic forces, dielectrophoretic forces (including conventional and traveling wave dielectrophoretic forces) or electromagnetic forces. Especially preferred methods for translocation of a sample component from one area of a chip to another area of a chip, or from one chip to another chip of a system are traveling wave dielectrophoresis and traveling wave magnetophoresis. In preferred embodiments, sample components coupled to microparticles of the present invention are translocated from one are of a chip to another area of a chip, or from one chip to another chip of the present invention using traveling wave dielectrophoresis or traveling wave magnetophoresis.

Of particular relevance to the methods of the present invention is the ability to control the application of physical forces using one or more external energy or signal sources that preferably are connected to micro-structures on a chip or chamber of the system of the present invention that generate the physical forces responsible for translocating sample components from one area of a chip to another area of a chip or from chip to chip. Thus the direction of sample components from one area of a chip to another area of a chip or from one chip to another to allow for the step-wise sequence of functions performed by the system, can be controlled by controlling the power source that directs the sample components from chip to chip, or from one area of a chip to another area of a chip. It is also necessary in some applications, to sequentially apply a power signal to subsets of functional elements on the same chip as in traveling wave magnetophoresis, or to apply electrical signals of different phases to different subsets of electrodes, as for example, in traveling wave dielectrophoresis. Preferably, the application of physical fields through one or more power or signal sources is controlled by a power generator control system or a signal generator control system that has an automatable and programmable switch mechanism. Preferably, a power generating control system or signal generator control system also allows the operator to regulate and modulate parameters of the power outputs and generated signals , such as, for example in the case of electrical forces, the signal frequency, signal amplitude, signal phase, and signal modulation mode.

Translocation of sample components and microparticles from one chip to another chip of a system of the present invention can occur through a port in a chamber that comprises one of the chips, optionally through a conduit, but this is not a requirement of the present invention. Translocation of sample components and microparticles from one area of a chip to another area of a chip or from one chip to another chip of a system of the present invention can occur through fluid flow, including mass flow and electrophoresis, but preferably, the translocation of sample components and microparticles that occurs through physical forces occurs by conventional or traveling wave dielectrophoresis or electromagnetic forces, including traveling wave magnetophoresis. In the preferred modes of translocation of sample components and microparticles from one area of a chip to another area of a chip or from one chip to another chip of the system, preferably at least one of the sources of the force used to effect the translocation is integral to at least one chip of the system or at least one chamber of the system. Sample components, including sample components coupled to microparticles, are translocated sequentially from one chip to another chip of a system of the present invention, so that processes in the processing and analysis of a sample are performed in an order that allows for a desired final result. For example, components of a sample that are cells of a specific type can be separated on a first chip, and then translocated to a second chip where they are lysed to expose other sample components that are intracellular moieties, and where the sample components are mixed with a preparation of specific binding partners such as microparticles. Sample components coupled to microparticles can then be translocated, for example using traveling wave dielectrophoresis, to a third chip where, for example, a detection assay can be performed.

Sample components, including sample components coupled to microparticles, can also be translocated from one chip to more than one other chip of a system of the present invention, so that subsequent processes in the processing and analysis of a sample can be performed in parallel. The sample components can be translocated simultaneously or sequentially to more than one chip. Preferably, different sample components are translocated to different chips, but this is not necessarily the case. For example, a protein sample component can be transferred to one chip, a nucleic acid sample component can be transferred to a second chip, and a steroid hormone can be translocated to a third chip. In the alternative, RNA and protein sample components can be directed to the same detection chip, for example. In preferred embodiments, the transfer of different components to different chips or to different areas of a chip can be achieved through the coupling of different components to microparticles with different properties, for example different dielectric properties. In this way, microparticles will respond differently to physical forces applied to the chip and will be directed in different directions, for example, directing different sample component through different ports to enter different chambers, or by directing the microparticles to different areas of the same chip.

A preferred chip for the differential translocation of sample components to different chips is the particle switch chip, disclosed in U.S. patent application Ser. No. 09/678,263 (attorney docket number ARTLNCO.002A), entitled “Apparatus for Switching and Manipulating Particles and Methods of Use Thereof” filed on Oct. 3, 2000, herein incorporated by reference. The particle switch chip translocates microparticles using traveling wave electrophoresis or conventional or traveling wave dielectrophoresis. Microparticles that respond to different field frequencies can be directed to different locations, and can be made to migrate along different paths, using different electrical signals applied to the particle switches.

Operation of an Integrated Biochip System

In the methods of the present invention, at least two tasks are performed sequentially. This means that at least one task is performed on a sample component that is a product or result of an earlier task performed on a sample. Preferably, tasks performed by the system occur in an order that allows progressive purification or enrichment, or in some cases alteration, of a sample component that can then be analyzed. In this respect, use of an integrated biochip system to process and analyze a sample leads from “sample to answer”.

Although it is preferred that at least two of the tasks performed on a system of the present invention be performed sequentially, it is not a requirement of the present invention that all tasks be performed in a sequential order. For example, it can be preferred in some embodiments, for example to have certain analysis steps performed in parallel, where one analysis step is for detecting one type of sample component (for example, RNA), and another analysis task is for detecting another type of sample component (for example, protein).

The operation of a system can be exemplified by reference to the figures, which are provided for illustration, and not by way of limitation:

FIG. 1 shows a chamber that comprises a multiforce chip used in the system of the present invention. Different geometries of the DEP electrodes may be used, for example, spiral electrode arrays, as described in “Dielectrophoretic manipulation of cells using spiral electrodes by Wang et al., Biophys. J., Vol. 72, pages: 1887-1899 (1997)” may be used instead of the rectangular array shown in Fig. 1B. All of the functional elements (acoustic, DEP electrode, electromagnetic elements, particle switch elements) shown in FIG. 1B-1E require electrical connection to external signal sources. For clarity, none of the electric connections were shown. The details of these connections can be found in U.S. patent application Ser. No. 09/399,299 (attorney docket number ART-00104.P.1), filed Sep. 17, 1999; U.S. application Ser. No. 09/685,410 (having attorney docket number ART-00104.P.1.1), filed Oct. 10, 2000, entitled “Individually Addressable Micro-Electromagnetic Unit Array Chips in Horizontal Configurations”; U.S. application Ser. No. 09/678,263 (attorney docket number ARTLNCO.002A), entitled “Apparatus for Switching and Manipulating Particles and Methods of Use Thereof” filed on Oct. 3, 2000; and U.S. application Ser. No. 09/679,024 (having attorney docket number 471842000400), entitled “Apparatuses Containing Multiple Active Force Generating Elements and Uses Thereof” filed Oct. 4, 2000, all herein incorporated by reference.

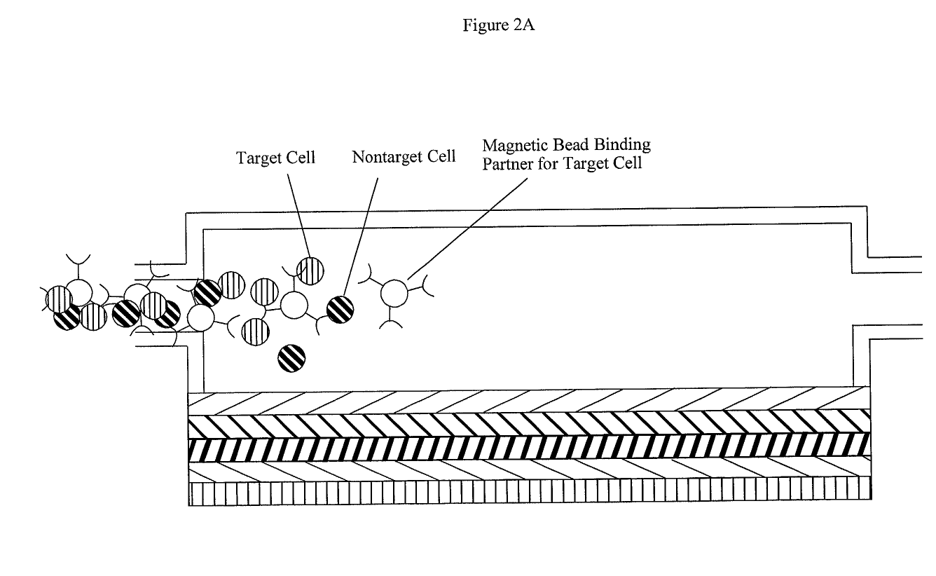

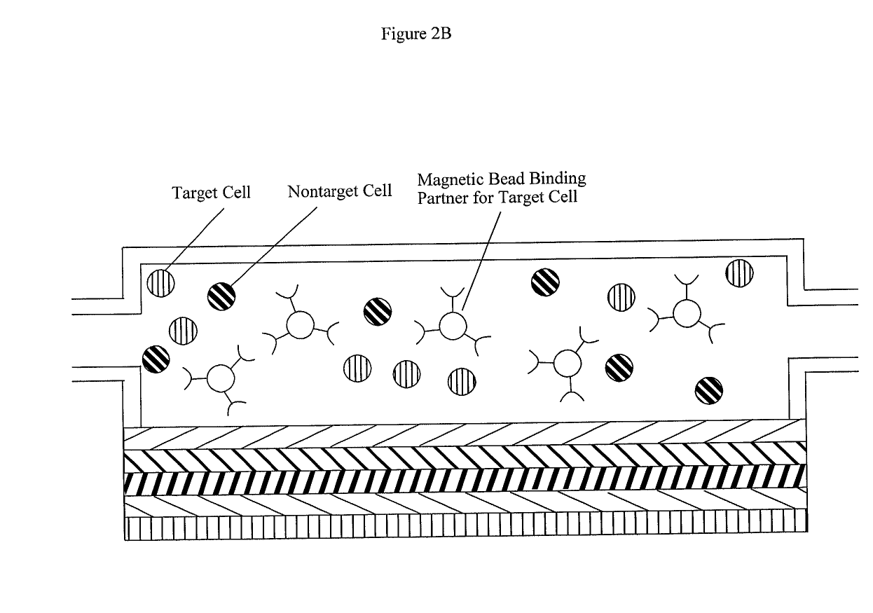

A sample, such as a blood sample, to which a preparation of microparticles coupled to specific binding members has been added, is introduced into the chip by pumping the sample through a port of a chamber (FIGS. 2A and B).

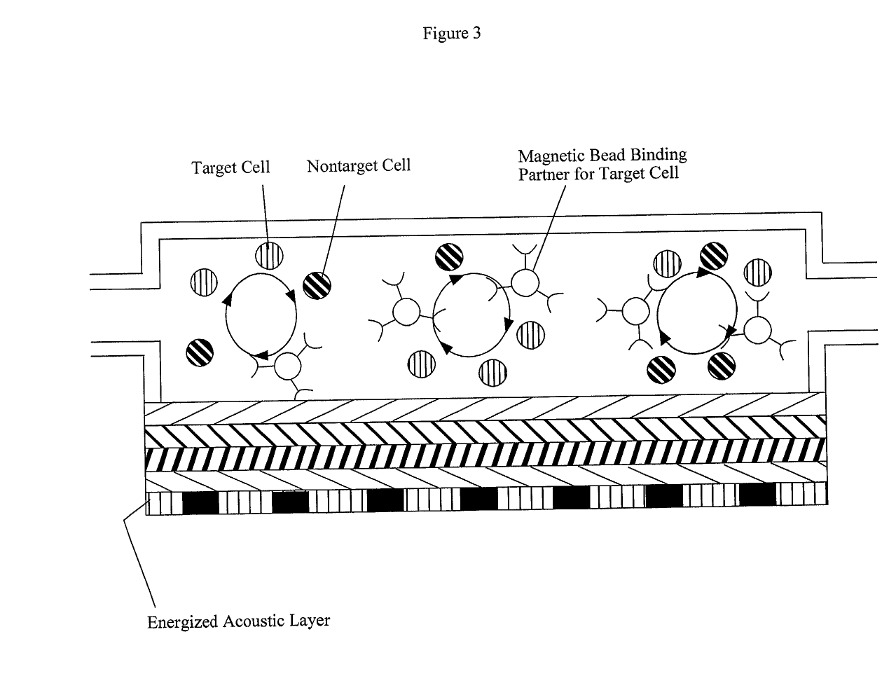

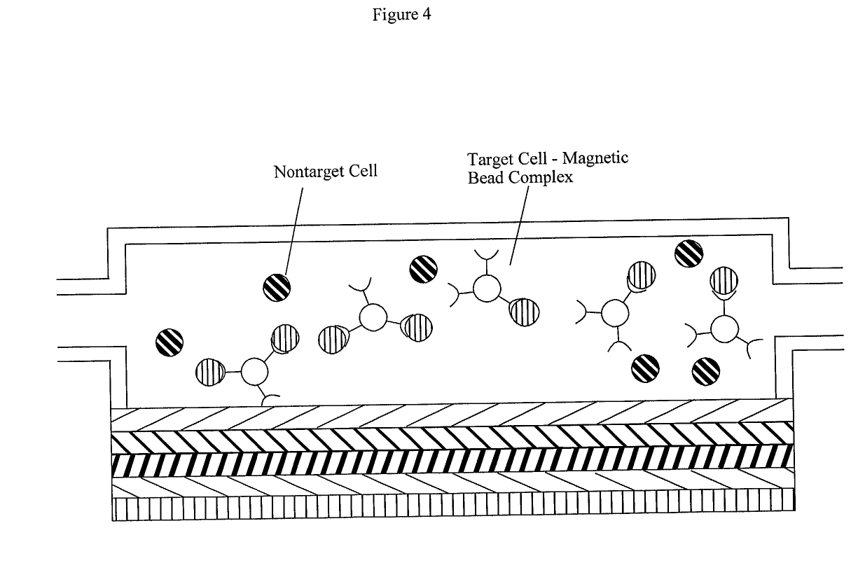

The chip comprises acoustic elements, and mixing of the sample is performed using acoustic forces (FIG. 3). The acoustic forces are produced by energizing the acoustic elements within the acoustic layer using AC electric signals. Under the applied AC electrical signals, the acoustic elements exhibit mechanical vibration due to the piezoelectric effects. Such mechanical vibration at the same frequency as that of the applied electric signals is coupled into the chamber and produces an acoustic wave or acoustic field within the chamber. The resulted acoustic field or wave exerts forces on the cells and beads in the chamber and also exerts forces on the suspending medium in the chamber to result in an acoustic-field-induced mixing. Where paramagnetic microparticles comprising specific binding members are used in the system of the present invention, acoustic forces can increase the efficiency of microparticle binding to specific components of the sample (FIG. 4).

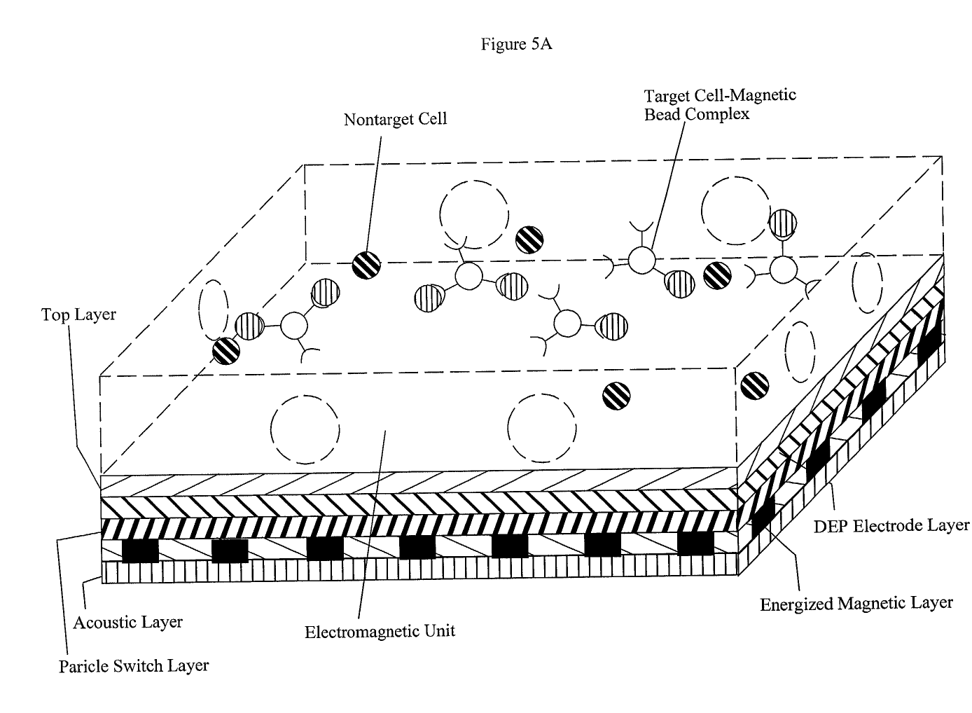

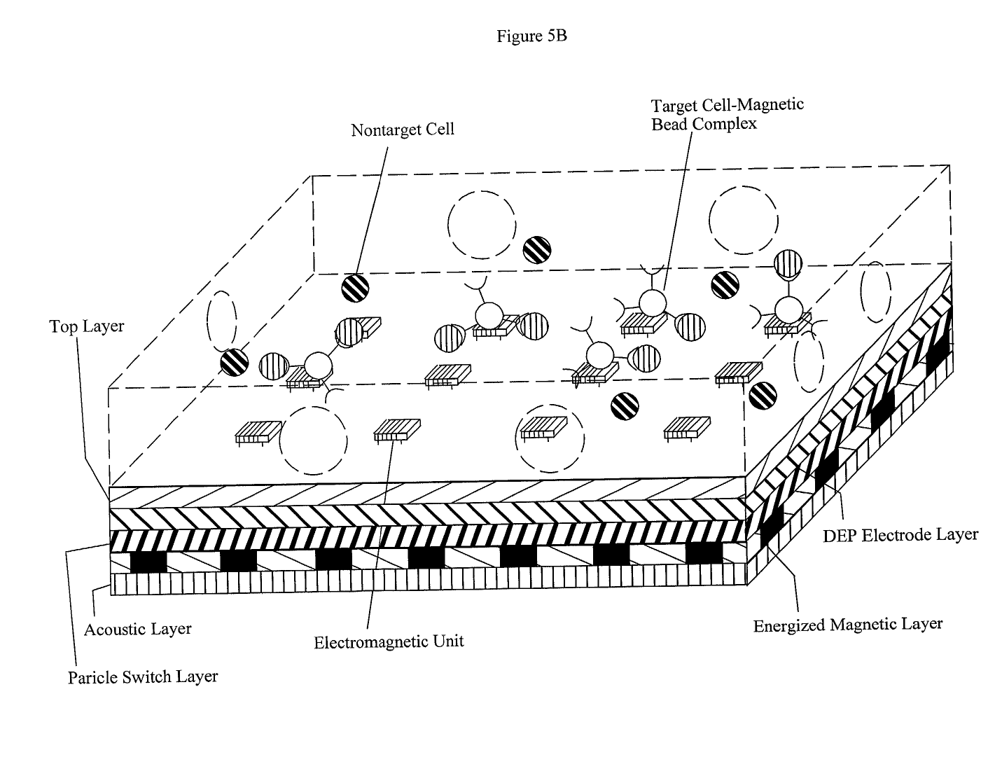

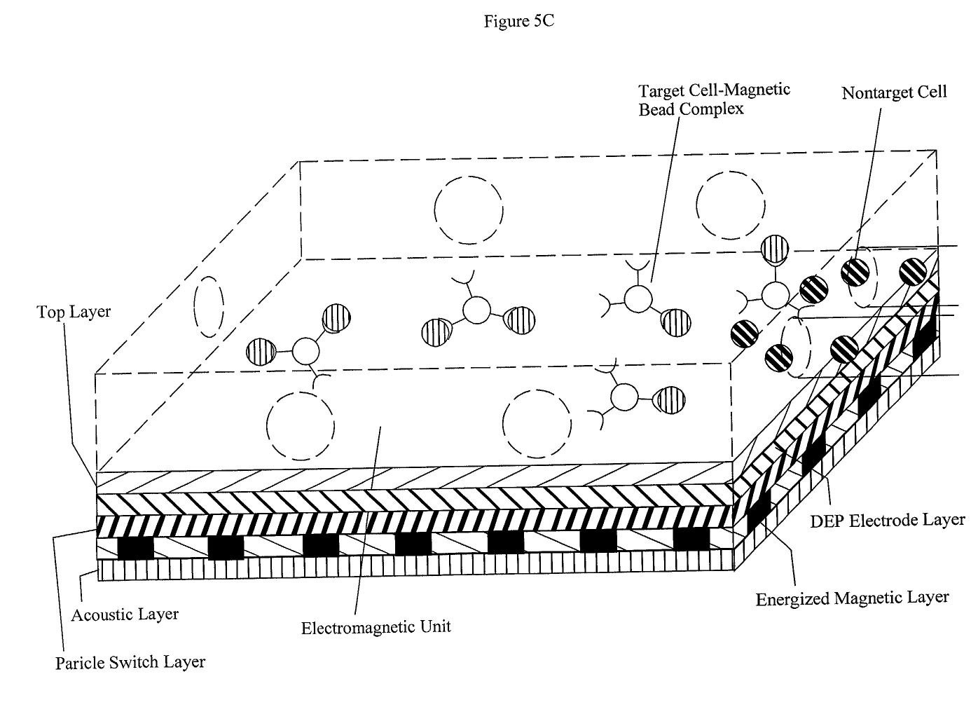

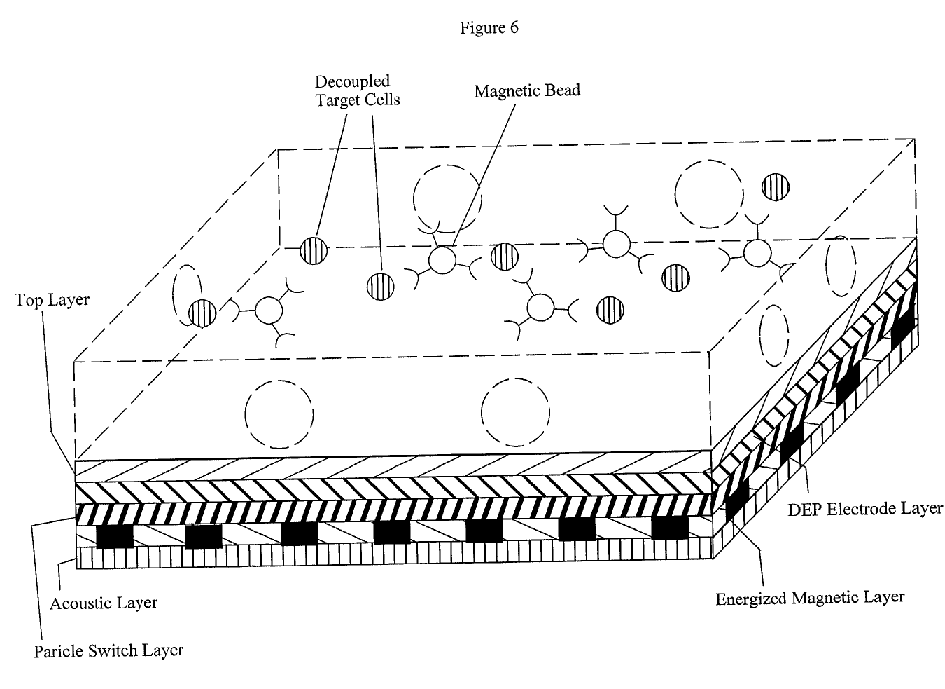

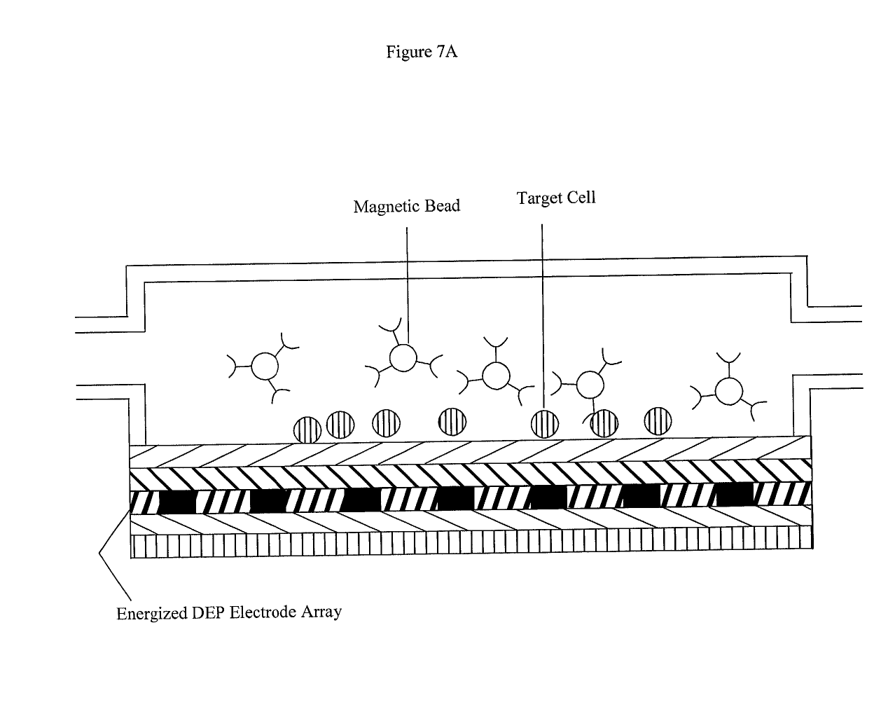

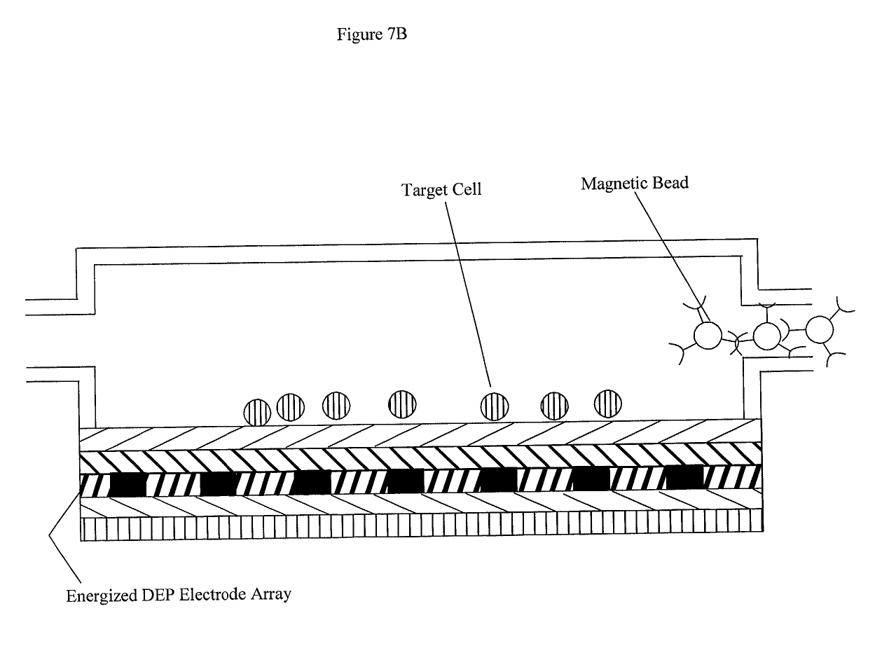

Following binding to specific components of a sample, the paramagnetic microparticles can be used in separation methodologies. Here, the microparticles can be paramagnetic particles comprising antibodies specific for a specific cell type, and a multi-force chip used in the system of the present invention can comprise electromagnetic units. The energized electromagnetic elements are used to collect and trap the magnetic bead-cell complexes, while other cell types and sample components are washed out of the chamber (FIGS. 5A and 5B, and 5C), for example, by mass flow of fluid pumped through the chamber. The microparticles can then be dissociated from the moieties of interest (FIG. 6), for example by chemical cleavage of linkers, and in a further process, the moieties of interest can be dielectrophoretically separated from the microparticles (FIGS. 7A and 7B). The magnetic microparticles, having different dielectric properties from those of the target cells, can be flushed from the chamber, for example, by fluid flow. Dielectrophoretic retention can be achieved by application of an electric signal to an electrode array to produce a nonuniform electric field. The electric field pattern, the composition of the suspending medium, and the composition of the magnetic microparticles is such that moieties of interest are retained at electrode surfaces, and magnetic microparticles are not retained at electrode surfaces.

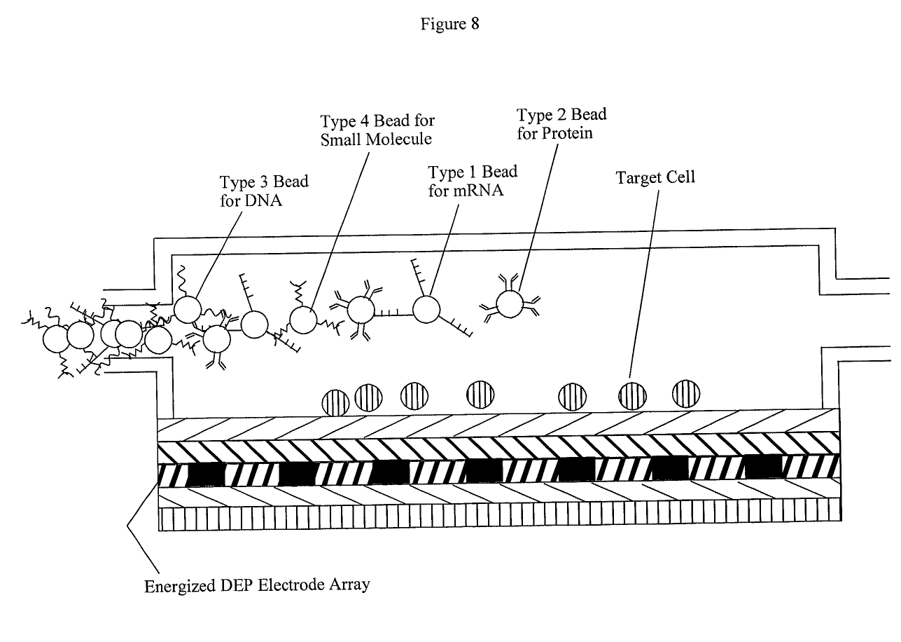

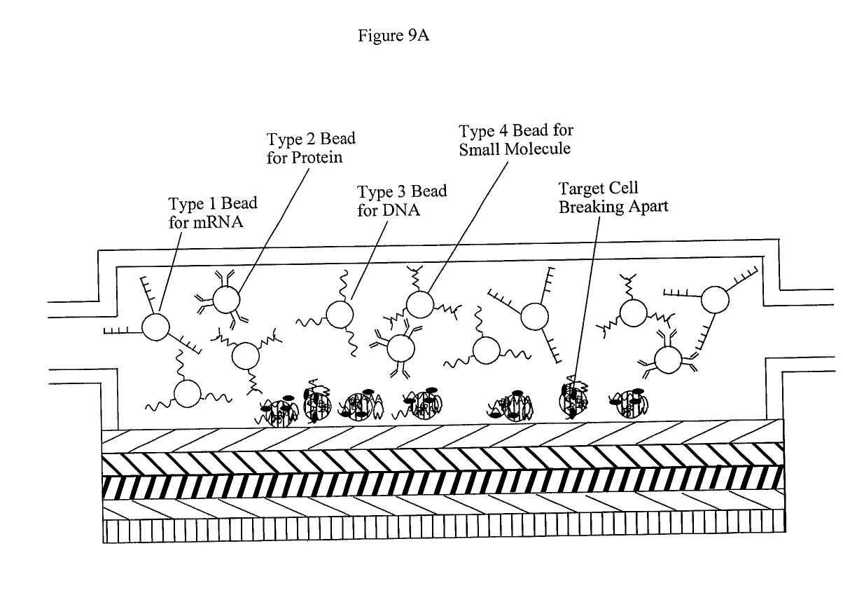

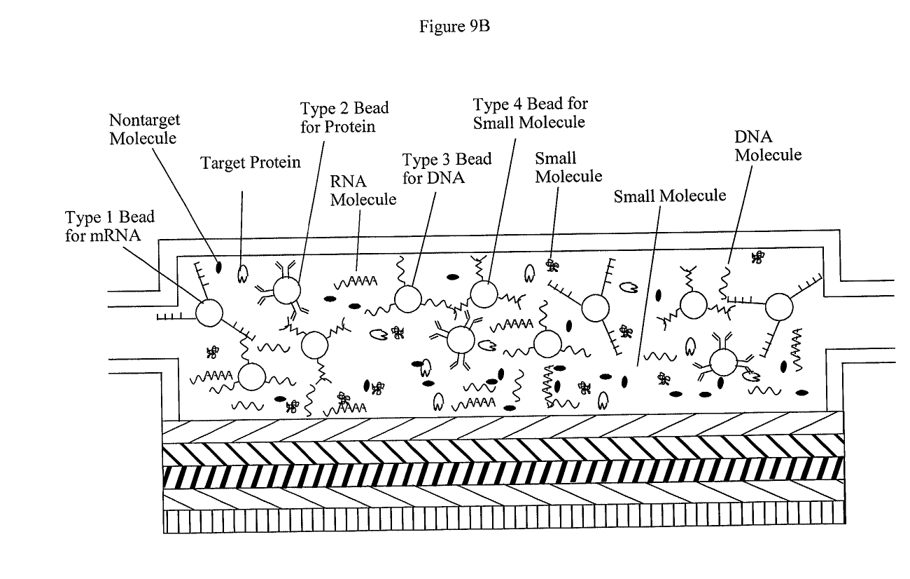

Other solutions, suspensions, preparations, or reagents can be added to the chamber that contains dielectrophoretically retained moieties of interest. For example, a suspension of different types of microparticle is introduced to the chamber in FIG. 8. Each type of microparticle has a different specific binding member attached thereon, in which the different specific binding members can bind different components of the moiety of interest. For example, one type of particle can be coupled to antibodies to a particular type of protein, another type of particle can be coupled to antibodies to a small molecule such as a steroid molecule, another type of microparticle can be coupled to an oligo dT nucleic acid that can bind the poly A tail of mRNAs, and another type of microparticle can be coupled to a single-stranded DNA molecule that is complementary to a sequence that is known or suspected of being present in a moiety of interest, such as a cell of interest. The moiety of interest can be disrupted to expose or contact components of the moiety of interest to reagents or preparations, such as one or more preparations of microparticles. For example, a cell can be lysed to allow internal moieties of a cell to be released into the medium and contact preparations of microparticles coupled to specific binding members (FIGS. 9A and B). Lysis of cells can occur, for example, by adding a hypotonic solution or a solution comprising a detergent or other lysing agents to the chamber. Mechanical forces (such as agitation), or electric or acoustic forces can optionally be applied using functional elements on a chip to cause disruption of the cells.

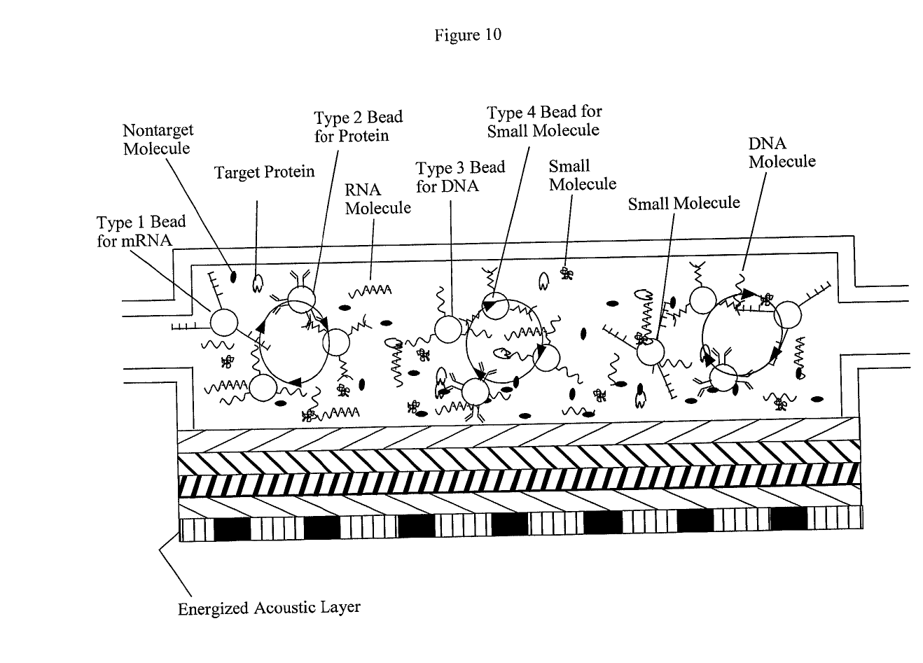

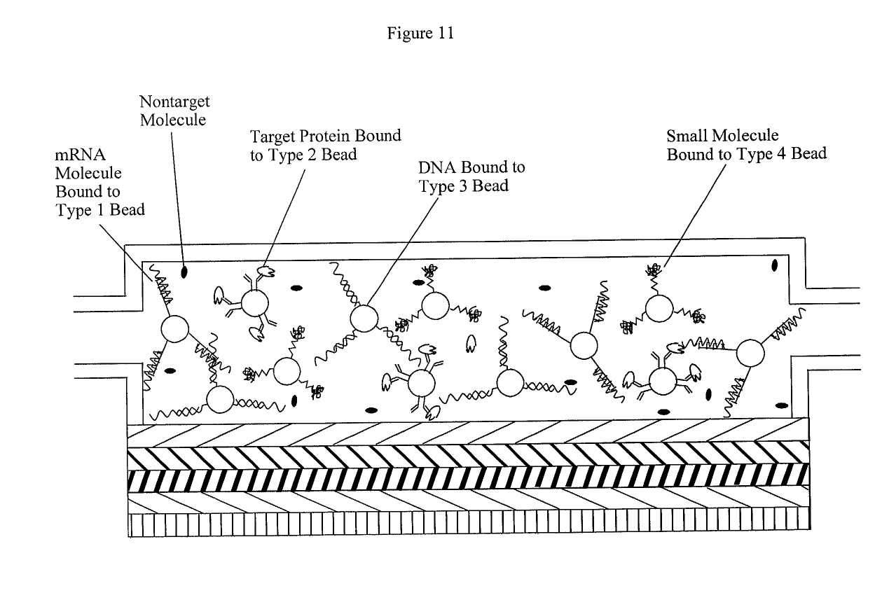

The application of acoustic forces can promote efficient mixing of the sample comprising components of the disrupted moieties (e.g., components of lysed cells) and the preparation of different types of microparticles (FIG. 10). This increases the efficiency of binding of the components to the microparticles (FIG. 11). Here, mRNA derived from lysed target cells binds to Type 1 beads, a target protein derived from lysed target cells binds Type 2 beads, DNA derived from lysed target cells binds to Type 3 beads, and a target small molecule derived from lysed target cells binds Type 4 beads.

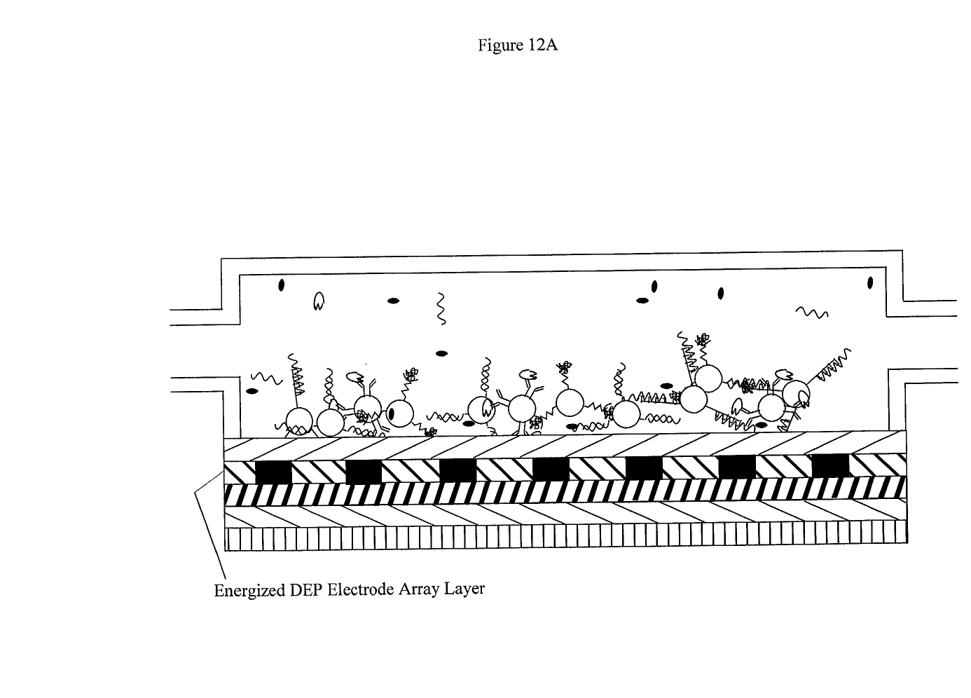

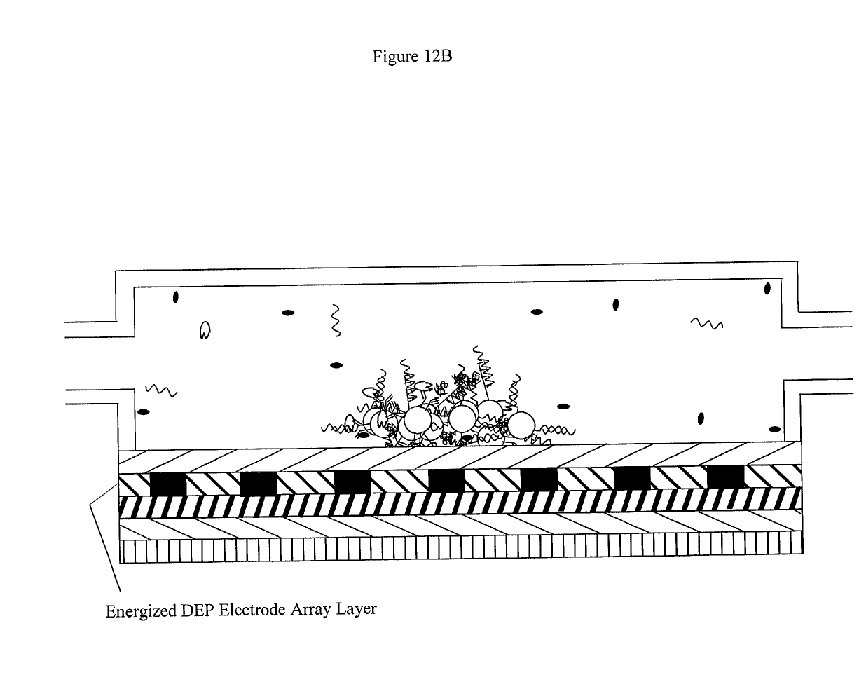

In this example, the different types of microparticles (beads) exhibit positive dielectrophoresis in response to an applied electric field pattern (shown in FIGS. 12A and B), but this need not be the case. The microparticles of different types bound to different moieties of interest can be dielectrophoretically focused to the central regions on a multi-force chip by applying an electric field across a plurality of electrodes that are on one layer of the multiple force chip (FIG. 12 B). In this case, phase-shifted signals can be applied to DEP electrodes in the chamber so that generated traveling-wave electric fields travel either towards the center or towards the periphery of the electrode array. To generate a traveling wave electric field, the electrodes are grouped such that each group receives the same phase of an AC signal, and electrodes of each group are interspersed with electrodes of each of the other groups (receiving different phase signals). At least three groups of electrodes are required with at least three different phase signals applied to generate a traveling wave electric field. In one example, every fifth of the rectangular electrodes (counted from the innermost one) are connected together to form 4 groups of electrodes: i.e., group 1: electrodes 1, 5, and 9; group 2: electrodes 2, 6, and 10; group 3: 3, 7, and 11; and group 4: electrodes 4, 8, and 12. The four groups of electrodes can be applied with AC signals of same frequency but phased at 0, 90, 180 and 270 degrees, or 0, −90, −180 and −270 degrees. Multi-layer fabrication is required for making such electrode configurations. Alternatively, the spiral electrodes, described, described in “Dielectrophoretic manipulation of cells using spiral electrodes by Wang et al., Biophys. J., Vol. 72, pages: 1887-1899 (1997)” may be used.

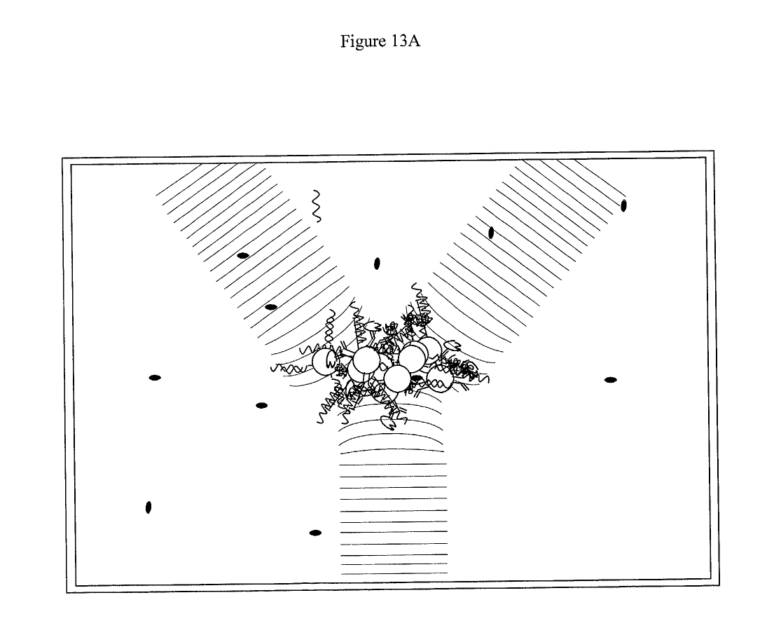

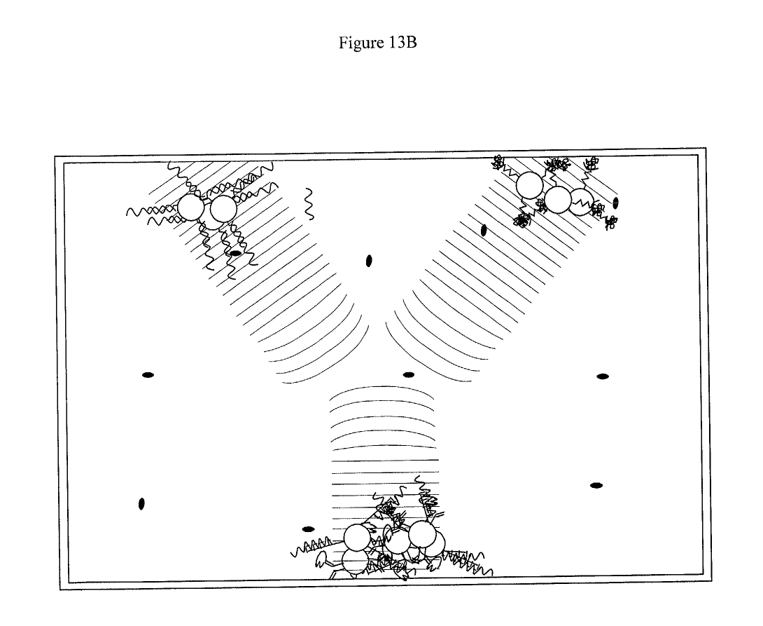

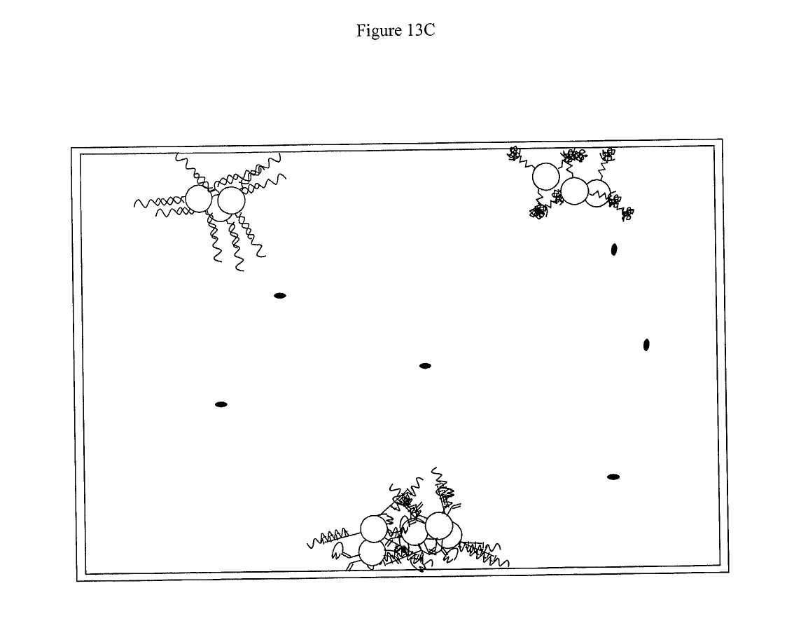

Microparticles that are retained in one or more areas of a chip can be separated on a particle switch chip, described in U.S. application Ser. No. 09/678,263 (attorney docket number ARTLNCO.002A), entitled “Apparatus for Switching and Manipulating Particles and Methods of Use Thereof” filed on Oct. 3, 2000, herein incorporated by reference. Microparticles, including microparticles coupled to moieties of interest, can be translocated on a particle switch chip using traveling wave dielectrophoresis (FIGS. 13 A, B, and C). At the branch point, application of a non-uniform and traveling-wave field directs one type of microparticle in one direction, and another type of microparticle in another direction. The movement of different types of microparticles to different directions in the particle switch may occur simultaneously under a given electrical signal application condition. Alternatively, certain signal combinations are applied first to move one type (“the first type”) of microparticles in one direction in the particle switch while other types of microparticles remain stationary or essentially stationary. After “the first type” of microparticles reaches the required position in the particle switch, different signal combinations are applied to move the other types of microparticles in other directions in the particle switch. The microparticles can be directed through different ports of a chamber comprising a particle switch chip to different chips for further separation, analysis, or detection, or can be directed to different areas of a chip for further separation, analysis, or detection.

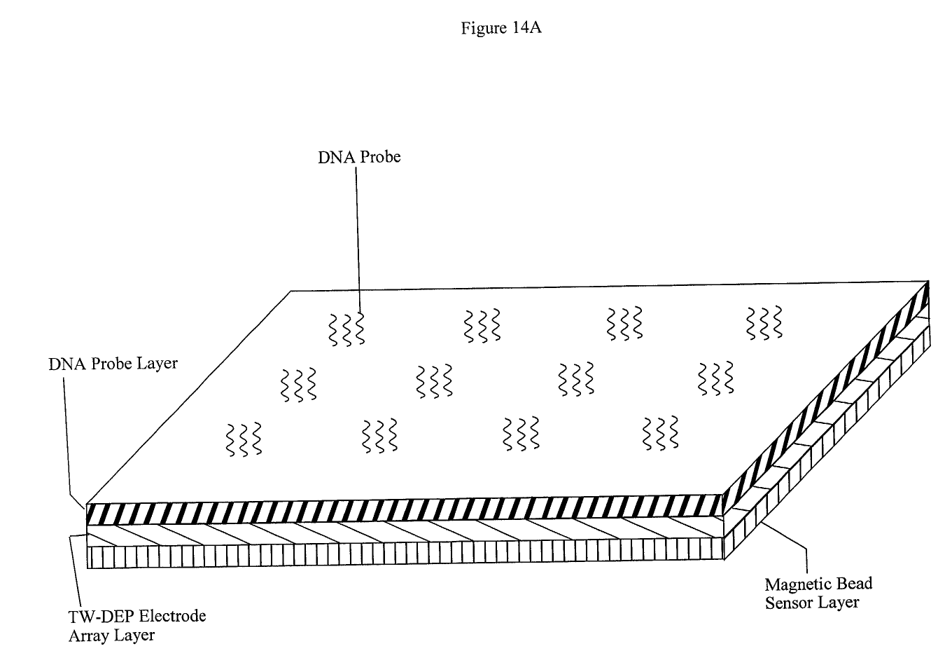

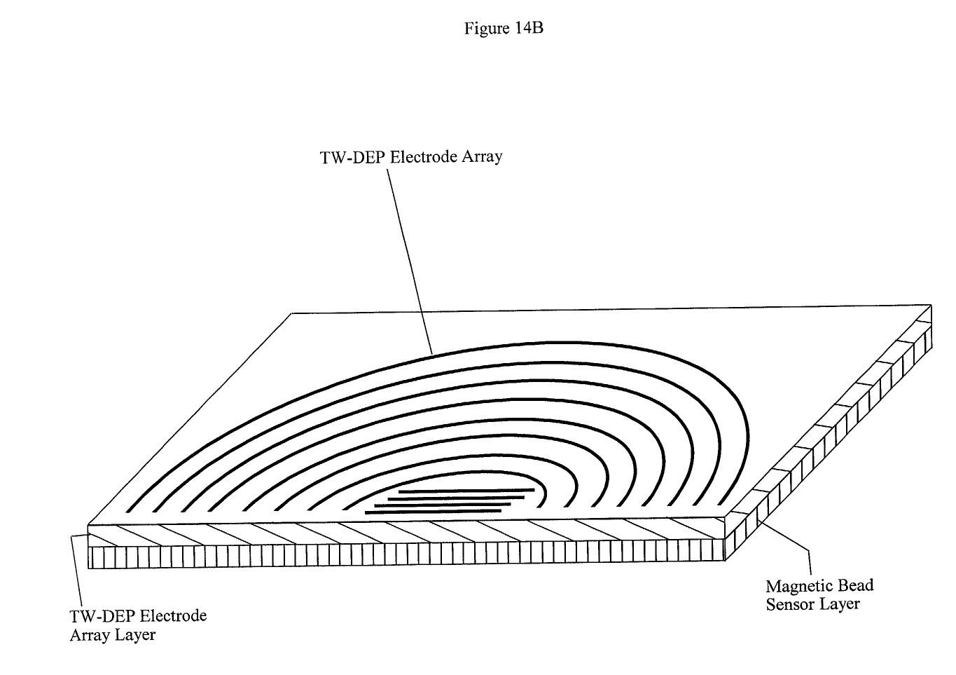

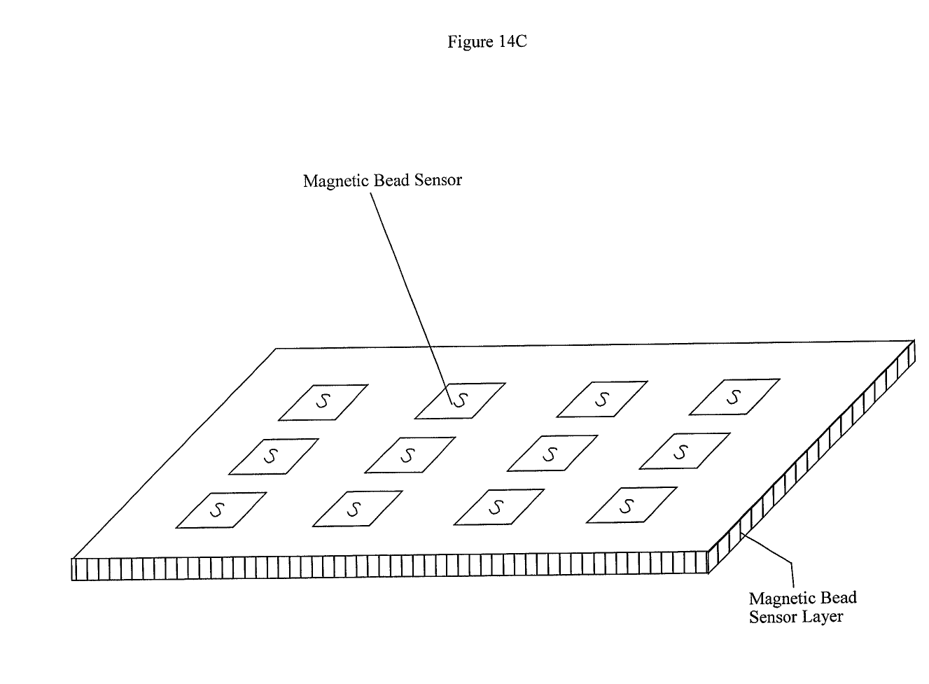

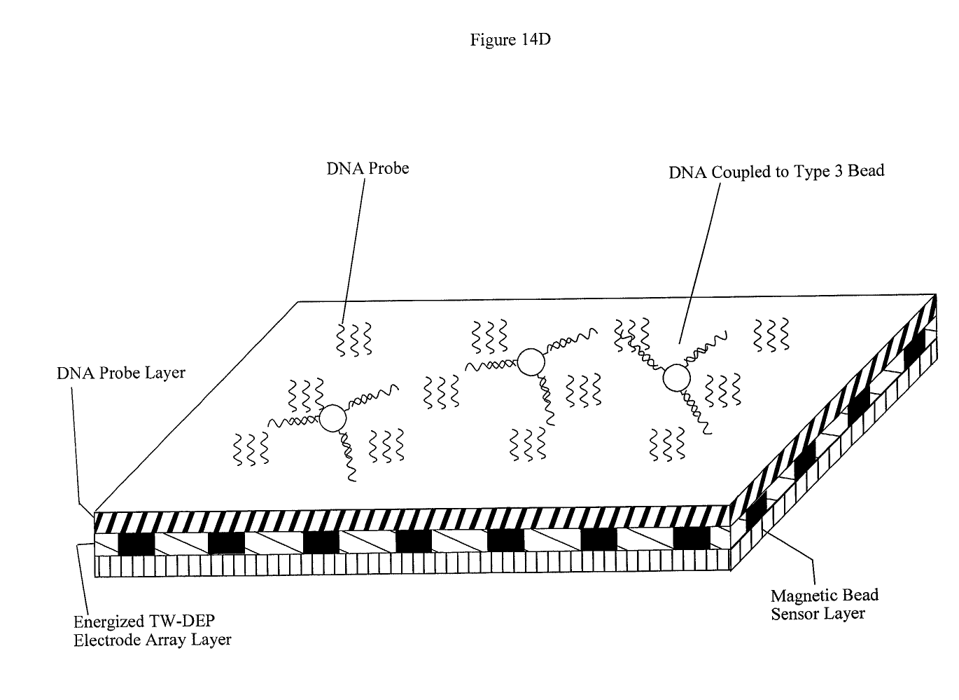

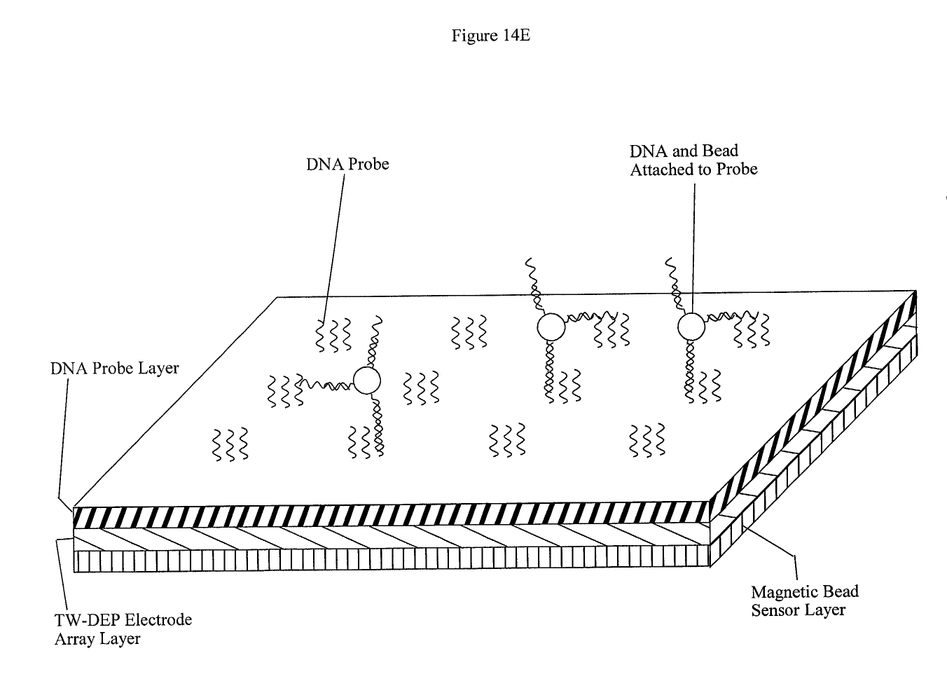

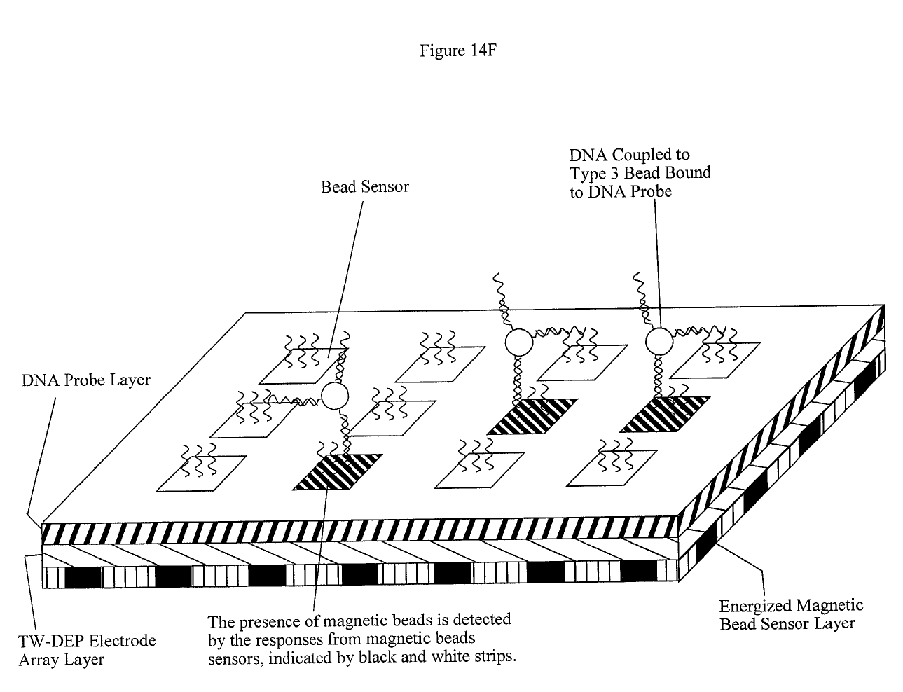

One method of detection uses electromagnetic signals generated by the binding of a magnetic particle to a region of a chip that comprises an oligonucleotide array. In this aspect, depicted in FIGS. 14 A, B, and C, a preparation of magnetic microparticles coupled to nucleic acid molecules is used. A given microparticle is coupled to a species of nucleic acid molecule known to be or suspected of being present in a sample being tested. A set of such microparticles is allowed to hybridize to nucleic acid molecules in a sample. Hybridization occurs such that the nucleic acid molecule from the sample that is hybridized to the nucleic acid coupled to the microparticle has a single-stranded overhang that is capable of binding to an oligonucleotide on the chip. Unbound nucleic acid molecules of the sample can be removed, for example, by washing the chamber following electromagnetic capture of the magnetic microparticles. The magnetic microparticles that are bound to nucleic acid molecules of the sample can bind oligonucleotides on the array, thereby binding a magnetic microparticle to a particular location on the array. The presence of magnetic microparticles at that position can be detected on the chip by certain magnetic field sensors or by cantilever-type pressure detectors, for example. For example, the sensor technology described in “A biosensor based on magnetoresistance technology”, in Biosens. Bioelectron. Vol: 13, pages 731-739, 1998, by Baselet et al, can be used to detect the presence of the magnetic particles.

Detection can also be by the binding of fluorescent molecules to nucleic acids or proteins (FIGS. 15A-D). In this case, microparticles bound to moieties of interest can be translocated by conventional or traveling wave dielectrophoresis onto or across a chip that comprises specific binding members such as, for example, single-stranded nucleic acid molecules and antibodies. The moieties of interest bound to microparticles (for example, proteins or interest or RNAs of interest) can be decoupled from the microparticles before or during dielectrophoretic translocation of the microparticles. The dissociated moieties of interest are then available to bind specific binding members attached to the chip. The chamber can optionally be flushed with a solution to remove any unbound moieties. A “sandwich” hybridization is then performed, with fluorescent molecules attached to molecules that are specific binding members specific for the moieties of interest. The fluorescent molecules will thus become attached to areas of the chip that correspond to particular moieties of interest, and can be detected by any standard fluorescence detection methods.

Detection can also be by means of generation of a fluorescence signal that occurs when moieties of interest flow through a channel or port. For example, small molecules such as, for example, steroids that have been separated from other moieties and sample components dielectrophoretically using microparticles can be translocated and focused in a channel of a chip (16 A, B). The microparticles can be decoupled from the moiety of interest and the moiety of interest can be labeled, for example with a fluorescent label, and directed through the channel, for example, by fluid flow (16 C, D, and E) and detected using optical light sources.

In the examples depicted in FIGS. 14A-14F, and 15A-F, traveling-wave dielectrophoresis (TW-DEP) electrodes are energized to move and disperse microparticles with bound molecules of interest into the chamber. In this case, traveling-wave dielectrophoretic forces are used. Phase-shifted signals can be applied to the TW-DEP electrodes so that traveling-wave electric fields are produced to exert traveling-wave dielectrophoretic forces to move and disperse the microparticles. To generate a traveling wave electric field, the electrodes are grouped such that each group receives the same phase of an AC signal, and electrodes of each group are interspersed with electrodes of each of the other groups (receiving different phase signals). At least three groups of electrodes are required with at least three different phase signals applied to generate a traveling wave electric field. In one example, every fourth of the semicircular electrodes (counted from the innermost one in FIGS. 14B and 15B) are connected together to form 3 groups of electrodes: i.e., group 1: electrodes 1, 4, and 7; group 2: electrodes 2, 5, and 8; group 3: 3, 6, and 9. The three parallel line electrodes may also be connected into the above mentioned three groups of electrodes. The three groups of electrodes can be applied with AC signals of same frequency but phased at 0, 120 and 240 degrees, or 0, −120, −240 degrees. Multi-layer fabrication is required for making such electrode configurations.

FIG. 17 depicts a single chip integrated biochip system, in which the chip is part of a chamber, and the cover of the chamber has inlet ports for the application of a sample and the addition of reagents, and outlet ports for the outflow of waste. Three separate areas of the chip are used for sample processing (areas A and B) and analysis (C), and each area of the chip has different functional areas or layers.

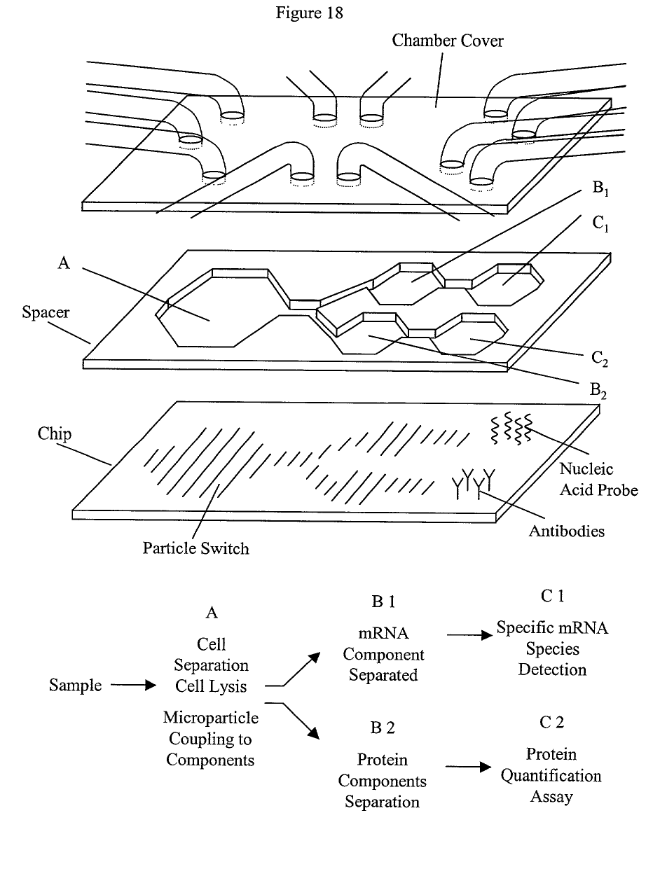

FIG. 18 depicts a single chip integrated biochip system, in which the multiple force chip is part of multiple chambers, and the cover of the chambers has inlet ports for the application of a sample and the addition of reagents, and outlet ports for the outflow of waste. The chip comprises a particle switch that can direct sample components to different areas of the chip for further processing and analysis tasks.

In an exemplary use of the single chip system in FIG. 18, a fluid sample comprising target and non-target cells is introduced to chamber A. The target cells are separated from the non-target cells in chamber A, and after removal of the nontarget cells by fluid flow, the target cells are lysed to release their intracellular components. Two types of microparticles are then introduced into chamber A: one type of microparticles that binds to mRNA molecules and another type of microparticles that bind to target protein molecules. The cell separation and cell disruption of target cells to obtain intracellular moieties performed in chamber A is similar to the methods illustrated in FIGS. 1-13.

Using the particle switch on the chip, microparticles with bound mRNA molecules are directed to chamber B 1 and microparticles with bound target protein molecules are directed to chamber B2 (FIG. 18). Thus, mRNA molecules and protein molecules are separated from other intracellular components into two separate chambers. mRNA molecules and protein molecules on the microparticles are then labeled with fluorescent molecules introduced into chambers B1 and B2 through the inlet and outlet ports connected to chamber B1 and B2. The fluorescent molecules are coupled to specific binding members that can bind to the mRNA molecules and protein molecules on the microparticles. The labeled mRNA molecules and protein molecules are then decoupled or dissociated from microparticle surfaces, and are then transported via fluid flow to chambers C1 and C2, respectively.

The top surface of chamber C1 has immobilized nucleic acid probes that can bind to target mRNA molecules, and hybridization can occur between the bound probes and target mRNA molecules under controlled stringency conditions. Similarly, the top surface of chamber C2 has immobilized antibody probes, and binding of target proteins to the bound antibodies can occur under controlled stringency conditions. The stringency control is provided by the components of the hybridization or binding buffers and wash buffers introduced into chambers C1 and C2 via the inlet and outlet ports connected to chambers C1 and C2, respectively. The intensity of the fluorescent signal emanating from the chip after washing off unbound label provides quantitative information on the mRNA molecules and protein molecules from the target cells in the original sample.

### EXAMPLE

Use of an Integrated System for Separation of White Blood Cells from a Blood Sample and RNA Isolation

Multiple Force Chip

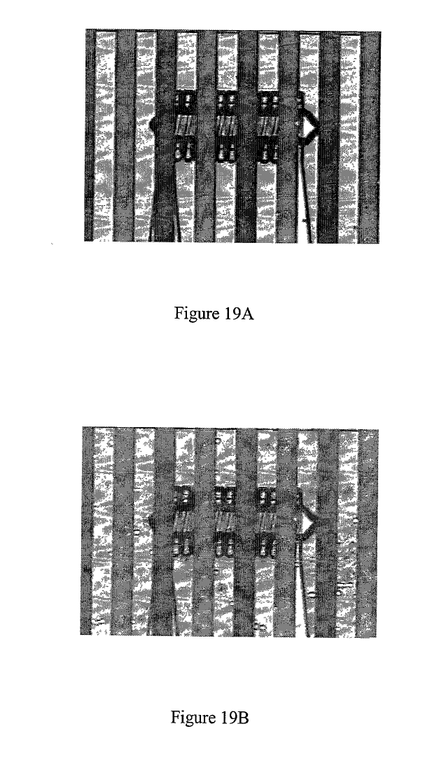

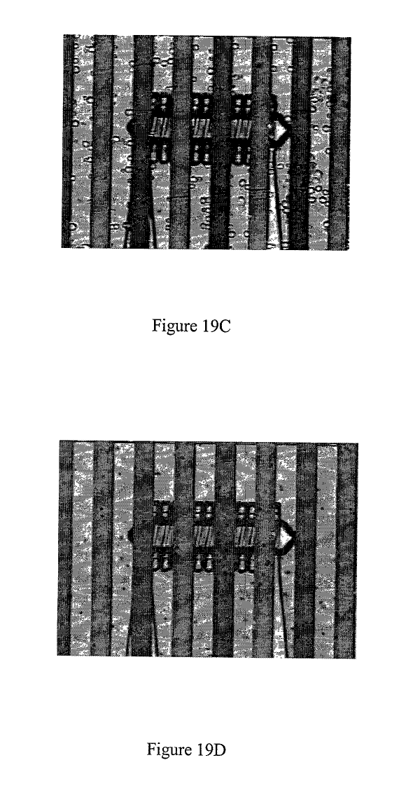

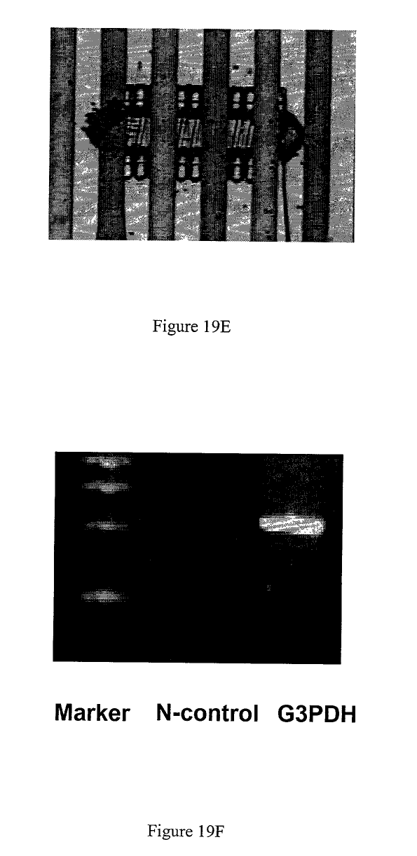

A multiple force chip of dimensions 1 cm by 1 cm was constructed on a silicon substrate. The chip had two active layers, as shown in FIG. 19A: an upper layer of interdigitated microelectrodes, and a lower layer of having a microfabricated electromagnetic coil. The microelectrodes are made of chromium (100 Angstrom thick) as a seed layer and 0.2 micron thick gold film as the top layer and have a 50 micron width and 50 micron gap. The electromagnetic units contained a magnetic core having dimensions 50 micron (width) by 200 micron (length) by 5-10 micron (thickness). (Detailed descriptions of fabrication procedures for making these electromagnetic units on a chip is disclosed in U.S. patent application Ser. No. 09/685,410 filed Oct. 10, 2000, entitled, “Individually Addressable Micro-Electromagnetic Unit Array Chips in Horizontal Configurations”, incorporated by reference in its entirety.) Dielectric insulation between the microelectrodes and the electromagnetic elements was achieved using deposited, thin, dielectric films (e.g. SiO₂, 5 to 20 micron thick).

A chamber was constructed around the multiple force chip. In this case, a molded plastic rectangular enclosure (having four sides but no top or bottom) was glued onto the chip to make the chamber walls. The chamber walls had a thickness of about 600 microns. A piece of thin glass was then glued to the top edges of the plastic enclosure to make a top for the chamber. Holes were molded on two opposite plastic walls of the chamber, and Teflon tubing of diameter 1/16 inch was glued to the plastic chamber walls at the holes, and used as the “inlet tubing” and the “outlet tubing”. Samples were introduced into the chamber via one piece of tubing (the “inlet tubing”) connected to one end of the chamber and removed from the chamber via the other piece of tubing (the “outlet tubing”) connected to the other end of the chamber.

Dielectrophoretic Separation of White Blood Cells from a Blood Sample

Peripheral blood samples of about 10 microliters volume were diluted in a hypotonic sucrose solution (˜2% sucrose in weight-to-weight ratio) with a ratio of 1:19 of blood to hypotonic sucrose solution. A diluted blood sample of 200 microliters was then introduced to the chamber via a syringe pump with the syringe connecting to the inlet tubing. The chamber was pre-filled with an isotonic sucrose buffer (8.5% sucrose plus 0.3% dextrose) prior to the introduction of the blood samples. During the sample introduction, AC electrical signals of up to 5 V peak-to-peak at frequencies between 1-6 MHz were applied to the electrodes using a power supply. Under these electric field conditions, white blood cells in the flow-introduced samples experienced positive dielectrophoretic forces and were collected by the microelectrodes at the electrode edges despite continuous fluid flow through the chamber (FIG. 19B).

The flow rate through the chamber was adjusted to optimize white blood cell separation. High fluid flow rates through the chamber resulted in losses of white blood cells, and different flow rates resulted in different percentages of white blood cells being collected at the electrode edges. The flow rates used were between 0.5 mL/hour and 2 mL/hour. The introduction of blood sample into the chamber and the collection of white blood cells at the electrode edges continued for several minutes (e.g. 5 minutes), while excess buffer and sample components that did not collect at the electrodes were removed by fluid flow through the outlet tubing, so that a sufficient number of white blood cells was collected on the chip by dielectrophoresis (shown in FIG. 19C). FIG. 19C demonstrates the use of dielectrophoresis on a multiforce chip for a processing task, i.e., separating /collecting white blood cells from a diluted blood sample.

After collecting white blood cells at the electrode surfaces, a lysis/binding solution was introduced into the chamber via the inlet tubing with the electrical signals (e.g., 1-6 MHz at <5 V peak-to-peak) applied on the microelectrodes (FIG. 19D). The lysis/binding solution (100 mM Tris-HCl, pH 7.5; 500 mM LiCl, 10 mM EDTA; 1% LiDS and 5 mM dithiothreitol (DTT)), contained magnetic microbeads of 2.8 microns in diameter coated with Oligo (dT)₂₅ (supplied by Dynal). After a volume of the solution similar to the volume of the chamber (about 30 microliters) was introduced, the fluid flow was stopped. The sample, now a cell lysate, was allowed to incubate with the lysis/binding solution that contained magnetic beads for 5-10 minutes to allow released mRNAs from lysed white blood cells to hybridize to Oligo (dT)₂₅ on the surfaces of the magnetic beads.

Electromagnetic Capture for Isolation of mRNA

DC electrical current was applied to electromagnetic units on the lower layer of the multiple force chip so that each unit was energized with a current value of 100-200 mA. The applied DC current to the electromagnetic units produces a non-uniform magnetic field distribution around these electromagnetic units, and as a result, the magnetic beads collect at the strongest field region corresponding to the two poles at the ends of the major axis of the electromagnetic coil (FIG. 19E). After the magnetic beads were collected with applied DC current for 1-3 minutes, a flow of washing buffer A (10 mM Tris-HCl, pH 7.5; 0.17 M LiCl, 1 mM EDTA, 0.1% LiDS) was applied into the chamber to wash off unbound molecules such as DNA, proteins, and other biomolecules that exited via the outlet tubing.

After pumping washing buffer A through the chamber to remove molecules such as DNA, proteins and other molecules that were not bound to the magnetic beads, a flow of washing buffer B (10 mM Tris-HCl, pH 7.5; 0.17 M LiCl, 1 mM EDTA) was used to wash the bound beads. The volume of washing buffer A and B pumped through the chamber was 30 to 100 microliters at flow rates below 3 mL/hour. At these flow rates, magnetic beads remained on the two ends of the electromagnetic elements/coils. After the flow was stopped, the electric currents that were applied to electromagnetic elements were turned off so that the magnetic beads were no longer subjected to a strong attractive magnetic field to immobilize them on the poles of the electromagnetic units. A buffer was pumped into the chamber through the inlet tubing and magnetic beads were removed from the chamber via the outlet tubing and collected into a microfuge tube.

PCR Assay of Isolated mRNA

Collected magnetic beads were then subjected to an off-chip reverse-transcription reaction to generate cDNA molecules. The cDNAs were further amplified in a PCR reaction using a pair of primers hybridizing to housekeeping gene G3PDH. The PCR mixture contained 0.2 μM primer, 1.5 mM MgCl₂, 0.2 mM dNTP, 10 mM Tris-HCl (pH=8.3), 50 mM KCl and 0.001% gelatin, and the PCR was performed at temperature cycles of 94° C. (30 secs) followed by 60° C. (60 secs) followed by 72° C. (60 secs). A total of 30 cycles were used. The reactions were loaded on an agarose gel, and amplified G3PDH products were detected after electrophoresis and ethidium bromide staining of the gel (FIG. 19F).

The strongly stained band corresponding to the size of amplified G3PDH gene segment in the right lane of the gel demonstrated that the magnetic beads captured mRNA molecules corresponding to the G3PDH genes. The negative control loaded in the middle lane of the gel shows the PCR results when magnetic beads introduced into the chamber did not have coated oligo-(dT)25 molecules (FIG. 19F), or magnetic beads introduced into the chamber that was not pre-used for separating white blood cells from blood samples.

All headings are for the convenience of the reader and should not be used to limit the meaning of the text that follows the heading, unless so specified.

All publications, including patent documents and scientific articles, referred to in this application and the bibliography and attachments are incorporated by reference in their entirety for all purposes to the same extent as if each individual publication were individually incorporated by reference.

### BIBLIOGRAPHY

U.S. Provisional Application No. 60/239,299 (attorney docket number ART-00105.P.1) filed Oct. 10, 2000, entitled “An Integrated Biochip System for Sample Preparation and Analysis” naming Cheng, et al. as inventors.

U.S. patent application Ser. No. 09/399,299 (attorney docket number ART-00104.P.1), filed Sep. 17, 1999, entitled “Individually Addressable Micro-Electromagnetic Unit Array Chips”.

U.S. application Ser. No. 09/685,410 (having attorney docket number ART-00104.P. 1.1), filed Oct. 10, 2000, entitled “Individually Addressable Micro-Electromagnetic Unit Array Chips in Horizontal Configurations”.

U.S. application Ser. No. 09/678,263 (attorney docket number ARTLNCO.002A), filed on Oct. 3, 2000, entitled “Apparatus for Switching and Manipulating Particles and Methods of Use Thereof”.

U.S. application Ser. No. 09/679,024 (having attorney docket number 471842000400),” filed Oct. 4, 2000, entitled “Apparatuses Containing Multiple Active Force Generating Elements and Uses Thereof”.

U.S. patent application Ser. No. 09/686,737 (attorney docket number ART-00102.P.1), filed Oct. 10, 2000, entitled “Compositions and Methods for Separation of Moieties on Chips”.

U.S. patent application Ser. No. 09/636,104 (attorney docket number 47184-2000100), filed on Aug. 10, 2000, entitled “Methods for Manipulating Moieties in Microfluidic Systems”.

U.S. patent application Ser. No. 09/648,081 (attorney docket number ART-00101.P.1), filed on Aug. 25, 2000, entitled “Methods and Compositions for Identifying Nucleic Acid Molecules Using Nucleolytic Activities and Hybridization”.

U.S. Pat. No. 4,160,645

U.S. Pat. No. 4,275,149

U.S. Pat. No. 4,318,980

U.S. Pat. No. 6,029,518

Baselet et al. (1998) “A Biosensor Based on Magnetoresistance Technology”, Biosens. Bioelectron. Vol. 13, pages 731-739.

Cheng et al. (1998) “Preparation and Hybridization Analysis of DNA/RNA from E. coli on Microfabricated Bioelectronic Chips” Nature Biotechnology, Vol. 16, pages 541-546.

Edman, C. (1998) “Electric Field Directed Nucleic Acid Hybridization on Microchips”, Nucl. Acids Res., 25: pages 4907-4914.

Effenhauser, C. S. et al. (1994) “High-speed separation of antisense oligonucleotides on a micromachined capillary electrophoresis device”, Anal. Chem. Volume 66, pages 2949-2953.

Harrison, D. J. et al. (1993) “Micromachining a miniaturized capillary electrophoresis-based chemical analysis system on a chip”, Science, Volume 261, pages: 895-896.

Sosnowski, R., et al. (1997) “Rapid Determination of Single Base Mismatch Mutations in DNA Hybrids by Direct Electric Field Control”, Proc. Natl. Acad. Sci., Volume 94, pages 1119-1123.

Wang et al. (1997) “Dielectrophoretic Manipulation of Particles by in IEEE Transaction on Industry Applications”, Vol. 33, No. 3, pages 660-669.

We claim:

1. An integrated biochip system for sample preparation and analysis, comprising at least one chip, wherein said integrated biochip system can perform two or more sequential tasks, wherein at least one of said two or more sequential tasks is a processing task.

2. The integrated biochip system of claim 1, comprising at least one chamber.

3. The integrated biochip system of claim 1, wherein said at least one chip is an active chip.

4. The integrated biochip system of claim 3, wherein one or more sample components can be moved from at least one area of a chip to at least one other area of a chip is by a mechanism other than fluid flow, electrophoresis, or electroosmosis.

5. The integrated biochip system of claim 4, wherein sample components can be moved from at least one area of a chip to at least one other area of a chip by traveling wave dielectrophoresis or traveling wave magnetophoresis.

6. The integrated biochip system of claim 3, wherein a sample applied to said integrated biochip system can remain continuously within said integrated system from the beginning of the first of said two or more sequential tasks until the end of the last of said two or more sequential tasks performed by said integrated system.

7. The integrated biochip system of claim 6, wherein said integrated biochip system is automated.

8. The integrated biochip system of claim 3, wherein said at least one chip is a multiple force chip.

9. The integrated biochip system of claim 6, comprising two or more chips, wherein said integrated biochip system can perform two or more sequential tasks using at least two of said two or more chips, further wherein at least one of said two or more sequential tasks is a processing task.

10. The integrated biochip system of claim 9, comprising at least one chamber.

11. The integrated biochip system of claim 9, wherein at least two of said two or more chips are active chips.

12. The integrated biochip system of claim 11, wherein at least one of said active chips is a particle switch chip.

13. The integrated biochip system of claim 9, wherein one or more sample components can be moved from at least one area of a chip to at least one other area of a chip is by a mechanism other than fluid flow, electrophoresis, or electro-osmosis.

14. The integrated biochip system of claim 13, wherein sample components can be moved from at least one area of a chip to at least one other area of a chip by traveling wave dielectrophoresis or traveling wave magnetophoresis.

15. The integrated biochip system of claim 9, wherein at least one of said active chips is a multiple force chip.

16. The integrated biochip system of claim 9, wherein said at least two of said two or more chips can be, for at least a part of the time during the operation of the integrated biochip system, in fluid communication with one another.

17. The integrated biochip system of claim 16, wherein one or more sample components can be moved from at least one chip to at least one other chip is by a mechanism other than fluid flow, electrophoresis, or electro-osmosis.

18. The integrated biochip system of claim 17, wherein sample components can be moved from at least one chip to at least one other chip by traveling wave dielectrophoresis or traveling wave magnetophoresis.

19. A method of using an integrated biochip system of claim 5, comprising:
a) applying a sample to an integrated biochip system; and
b) performing two or more sequential tasks in said integrated biochip system, wherein at least one of said two or more sequential tasks is a processing task.

20. The method of claim 19, wherein said sample is a water sample, a blood sample, ascites fluid, pleural fluid, cerebrospinal fluid, or amniotic fluid.

21. The method of claim 19, wherein said at least one processing task is a separation, translocation, concentration, purification, isolation, enrichment, focusing, structural alteration, or disruption.

22. The method of claim 19, wherein at least one processing task is performed using the application of one or more physical forces that are in part generated by microscale structures integral to a chip.

23. The method of claim 22, wherein said applied physical forces are acoustic forces, dielectrophoretic forces, magnetic forces, traveling wave dielectrophoretic forces, or traveling wave magnetophoretic forces.

24. The method of claim 22, wherein said at least one processing task comprises the manipulation of moieties by applied physical forces.

25. The method of claim 24, wherein said applied physical forces are dielectrophoretic forces, magnetic forces, traveling wave dielectrophoretic forces, or traveling wave magnetophoretic forces.

26. The method of claim 25, wherein said manipulation of moieties by applied physical forces is by manipulation of binding partners.

27. The method of claim 26, wherein said binding partners are magnetic beads.

28. The method of claim 22, wherein at least one processing task is performed by the application of more than one type of physical force.

29. The method of claim 19, further comprising performing an analysis task.

30. A method of using an integrated biochip system of claim 9, comprising:
a) applying a sample into an integrated biochip system; and
b) performing two or more sequential tasks in said integrated biochip system, wherein at least one of said two or more tasks is a processing task.

31. The method of claim 30, wherein said sample is a water sample, a blood sample, ascites fluid, pleural fluid, cerebrospinal fluid, or amniotic fluid.

32. The method of claim 30, wherein said processing task is a separation, translocation, concentration, purification, isolation, enrichment, focusing, structural alteration, or disruption.

33. The method of claim 32, wherein at least two processing tasks are performed using the application of physical forces that are in part generated by micro-scale structures integral to a chip.

34. The method of claim 32, wherein said applied physical forces are acoustic forces, dielectrophoretic forces, magnetic forces, traveling wave dielectrophoretic forces, or traveling wave magnetophoretic forces.

35. The method of claim 34, wherein said at least one processing task is accomplished through the manipulation of moieties by applied physical forces.

36. The method of claim 35, wherein said applied physical forces are dielectrophoretic forces, magnetic forces, traveling wave dielectrophoretic forces, or traveling wave magnetophoretic forces.

37. The method of claim 36, wherein said manipulation of moieties by applied physical forces is by manipulation of binding partners.

38. The method of claim 37, wherein said binding partners are magnetic beads.

39. The method of claim 33, wherein at least one processing task is performed by the application of more than one type of physical force.

40. The method of claim 30, wherein sample components can be moved from at least one chip to at least one other chip by a mechanism other than fluid flow, electrophoresis, or electro-osmosis.

41. The method of claim 40, wherein sample components can be moved from at least one chip to at least one other chip is by traveling wave dielectrophoresis or traveling wave magnetophoresis.

42. The method of claim 30, further comprising performing an analysis task.
